(19) United States
(12) Patent Application Publication
(10) Pub. No.: US 2020/0014642 A1
(43) Pub. Date: Jan. 9, 2020

(54) Enhanced Customer Interaction Platform for Enterprises

(71) Applicant: OV Loop, Inc., Northborough, MA (US)

(72) Inventors: Dennis Sidi, Miami, FL (US); Kevin Kozak, Austin, TX (US); William Graylin, Winchester, MA (US); Douglas Yeager, Austin, TX (US)

(21) Appl. No.: 16/502,158

(22) Filed: Jul. 3, 2019

Related U.S. Application Data
(60) Provisional application No. 62/695,726, filed on Jul. 9, 2018.
(60) Provisional application No. 62/748,086, filed on Oct. 19, 2018.

(51) Int. Cl. H04L 12/58; H04M 3/42; G06Q 30/00; H04M 3/51; G06Q 30/06

(52) U.S. Cl. CPC H04L 51/046; H04M 3/42161; H04L 51/32; G06Q 30/0643; H04M 3/5191; G06Q 30/0633; G06Q 30/016

(57) ABSTRACT

Among other things, an inbound message from a customer device of a customer is received at a customer service system of an enterprise. The inbound message is part of a customer interaction and is in as first electronic interaction channel. In response to the inbound message, the customer service system automatically and electronically exposes to the customer an entry step invocable by the customer to continue the customer interaction using at least a second electronic interaction channel different from the first interaction channel. In response to an invocation by the customer of the entry step, the customer service system automatically makes available to the customer a system for sending and receiving messages in at least the second electronic interaction channel.

This application is entitled to the benefit of the filing date of U.S. provisional applications Ser. 62/695,726, filed on Jul. 9, 2018, and Ser. 62/748,086, filed on Oct. 19, 2018, both of which are incorporated here by reference in their entirety.

### BACKGROUND

This description relates to an enhanced customer interaction platform for enterprises.

Before the advent of the Internet and the opportunities it presented for interactions with customers, enterprises typically initiated interactions with their customers (sometimes a very large number of customers) by standardized messages sent to the customers using mass advertising, mass mailings, and telephone marketing. Normally, the channels for customers to send messages in response to such enterprise-initiated messages were limited and included, for example, an occasional telephone call or letter. Even more rare (almost unheard of) were situations in which an enterprise and a specific customer would interact by an extended back-and forth in a series of messages about a topic.

The Internet and new telephony technologies have reduced the cost and expanded the opportunities for an enterprise to initiate and conduct interactions with its customers and to enable its customers to initiate and conduct interactions with the enterprise. The new kinds of customer interactions initiated by an enterprise with its customers typically have replicated the previous approaches but now can be done more quickly, less expensively, and more intensively.

The channels of interaction used for the customer interactions initiated by an enterprise to start and maintain customer relationships—mass email distributions, serving of pages to Web sites and mobile apps, and telephone-interfacing customer service facilities, for example—often limit the richness, depth, and closeness of the customer relationships just as the pre-Internet channels did. In turn, the economic advantages that could flow from such relationships are not fully realized.

For example, emails promoting an enterprise or its services or other products are typically sent to a large number of customers using mostly identical formats and content. A customer receiving such an email through an app or a Web browser running on a mobile or other device may be able to invoke a link included in the email to reach a page of a Web site or a mobile app where more information or possible actions are offered. Yet often a recipient of such an email is not expected to and is provided no way to respond to the email or to the information provided on the linked page. In other words, the enterprise is constrained to delivering a one-size-fits-all message to all of the email targets and the opportunity for a continuing conversation or building of a customer relationship through continued interaction with the customer based on the original email is lost.

To provide its customers with services and support with respect to its products, an enterprise often maintains a customer service system staffed by customer service representatives. The entry step into a customer service system is often a mobile or land-line voice telephone call initiated by the customer to a telephone number provided by the enterprise for that purpose. Often, the call is answered by an interactive voice response (IVR) system that uses synthesized or recorded voice to get information from the caller, defines a tree to be navigated by the caller, assists the allocation of calls to CSRs, and handles interaction with the caller until a CSR is ready to accept the call and serve the customer.

IVR systems can undercut the enterprise's goal of making their customers happy and building strong customer relationships because the IVR systems are impersonal, time consuming, and frustrating to navigate using speech (which must be recognized by the IVR system) and key presses.

Depending on the configurations of the customer service system and the IVR system, a customer may eventually reach a live customer service representative (CSR) who may answer questions and provide information as part of the voice telephone call. The responses and information provided by the CSRs may be based partly on an automated analysis of the customer's selections made while navigating the IVR navigation tree and possibly on recognized speech of the customer.

In a typical customer service system, a CSR can view a queue of customers waiting to be served, can select one or more of the customers to serve, can view information provided by a customer in responding to the IVR navigation tree, and can perform other tasks to serve the customer.

In some customer service systems, a customer can initiate an interaction with an enterprise by an entry step of starting a chat session with a CSR typically through a Web page served by the enterprise. Such a chat session can be conducted similarly to a voice telephone call as described above, with the customer providing answers to canned questions and then having an opportunity to interact with a CSR using free-form text.

To summarize, electronic interactions by enterprises with their customers typically use chat, email, telephone calls, and Web sites to facilitate one-way (and sometimes two-way) advertising and messages from the enterprise to its customers and to facilitate two-way messages to provide customer services.

The customer interactions represented by such one-way and two-way messages can be implemented by a synchronous interaction channel (for example, live telephone calls) which is synchronous in the sense that the customer and the CSR are both available and participating in a real-time back-and-forth interaction. The customer interactions can also be implemented by asynchronous interaction channels, such as email messages sent back and forth at times determined by each party for which they do not both need to be available and participating at the same time, and quasi-synchronous interaction channels, such as chat sessions which can be conducted in real-time synchronously by two parties that are actively engaged in the session or conducted with shorter or longer delays asynchronously between messages as determined by each party independently. Synchronous interactions in live telephone calls can be frustrating, for example, when the customer is put on hold while trying to buy tickets or get flight information.

Other electronic interaction channels for messages between customers and enterprises include customers responding to online surveys, customers providing usability feedback about a product, enterprises enabling a customer chat session in connection with a marketing Web site or a customer service Web site, and enterprises enabling a customer to confirm a willingness to receive marketing communications from an enterprise. Often, in these examples, the enterprise does not intend to and does not engage in further messages in response to, for example, a reply by a customer to an online survey or a request for usability feedback.

Customer interactions sometimes involve financial transactions such as payments for products or refunds. Typically, such transactions are effected by the CSR taking credit card information or the customer entering the credit card information in a form on a website.

### SUMMARY

In general, in an aspect, an inbound message from a customer device of a customer is received at a customer service system of an enterprise. The inbound message is part of a customer interaction and is in a first electronic interaction channel. In response to the inbound message, the customer service system automatically and electronically exposes to the customer an entry step invocable by the customer to continue the customer interaction using at least a second electronic interaction channel different from the first interaction channel. In response to an invocation by the customer of the entry step, the customer service system automatically makes available to the customer a system for sending and receiving messages in at least the second electronic interaction channel.

Implementations may include one or a combination of two or more of the following features. The inbound message includes a request for service by a customer service representative of the enterprise. The customer device includes a mobile phone or other mobile device. The first electronic interaction channel includes a telephone call and the inbound message is expressed as part of the telephone call. The customer service system of the enterprise includes an interactive voice response system and the inbound message includes actions by the customer in the interactive voice response system. The exposing of the entry step to the customer includes delivering a recorded or synthesized spoken message to the customer device informing the customer of the entry step. The spoken message indicates to the user that the entry step will be exposed through the customer device. The exposing of the entry step to the customer includes delivering a text message to the customer device containing the entry step. The entry step includes a link to a URL. The entry step includes a QR code or other graphical code. The first electronic interaction channel includes a synchronous channel. The second electronic interaction channel includes a quasi-synchronous channel or an asynchronous channel. The making available to the customer of a system for sending and receiving messages includes invoking an application on a device of the customer or serving Web pages through a browser of a device of the customer. The application invoked on the device includes a chat application associated with the enterprise. The Web pages served through the browser include a chat application associated with the enterprise. The second electronic interaction channel includes a multichannel having at least a text interaction channel and a graphical interaction channel. The graphical interaction channel includes images or video. The multichannel includes a voice interaction channel. The second electronic interaction channel is served from a central server on behalf of the enterprise.

In general, in an aspect, a chat system is presented to a customer service representative of an enterprise through a user interface on a device of the customer service representative. The chat system enables the customer service representative and a customer of the enterprise to engage in a chat session as part of a customer interaction. The chat system includes multiple interaction channels enabling the customer service representative to send and receive messages to and from the customer. The multiple interaction channels include at least a text channel, a synchronous voice channel, and a synchronous video channel. In some implementations, the customer service representative can determine whether the synchronous voice channel and the synchronous video channel are to be used for sending and receiving messages with the customer during the chat session,

In general, in an aspect, a chat system is presented to a customer of an enterprise through a user interface on a device of the customer. The chat system enables the customer and a customer service representative of the enterprise to engage in a chat session as part of a customer interaction. The chat system includes multiple interaction channels enabling the customer to send and receive messages to and from the customer service representative. The multiple interaction channels include at least a text channel, a voice channel, and at least one other interaction channel available essentially simultaneously and from within the chat system.

Implementations may include one or a combination of two or more of the following features. The presenting of the chat system to the customer includes serving a chat system associated with the enterprise through a browser running on the device of the customer. The presenting of the chat system to the customer includes running a chat application associated with the enterprise on the device of the customer. The presenting of the chat system to the customer includes presenting user interface controls that can be invoked in any order by the customer during the use of the chat system. The other interaction channel includes at least one of an email channel, a Web page channel, an application channel, a social network channel, an image channel, a video channel, a form completion channel, or a financial transaction channel.

In general, in an aspect, a chat system is presented to a customer service representative of an enterprise through a user interface on a device of the customer service representative. The chat system enables the customer service representative and a customer of the enterprise to engage in a chat session as part of a customer interaction. The chat system includes multiple interaction channels enabling the customer service representative to send and receive messages to and from the customer. The multiple interaction channels including at least a text channel, a voice channel, and at least one other interaction channel available essentially simultaneously and from within the chat system.

Implementations may include one or a combination of two or more of the following features. The presenting of the chat system to the customer service representative includes serving a chat system of the enterprise through a browser running on the device of the customer service representative. The presenting of the chat system to the customer service representative includes running a chat application of the enterprise on the device of the customer service representative. The presenting of the chat system to the customer service representative includes presenting user interface controls that can be invoked in any order by the customer service representative during the use of the chat system. The other interaction channel includes at least one of an email channel, a Web page channel, an application channel, a social network channel, an image channel, a video channel, or a financial transaction channel. The presenting of the chat system to the customer service representative includes presenting the chat system as part of a user interface of a customer service system. Messages are sent automatically in at least one of the multiple interaction channels based on analysis of previous messages of the chat session.

In general, in an aspect, records are stored of electronic customer interactions between customers and customer service representatives of one or more enterprises. Based, based on the stored records, a channel is formed of customer interactions between customers and customer service representatives of the enterprise. The channel is predictive of effects of activities included in the stored records and occurring during electronic customer interactions on outcomes of the customer interactions. The channel is applied to a current electronic customer interaction between a customer and a customer service representative of one of the enterprises to generate a proposed action to be taken with respect to the current electronic customer interaction on behalf of the enterprise. The proposed action is caused to be taken.

Implementations may include one or a combination of two or more of the following features. The storing of the records of the electronic customer interactions includes storing messages of the electronic customer interactions. The storing of the records of the electronic customer interactions includes storing information about activities during the electronic customer interactions. The forming of the channel also includes forming a channel based on demographic information about the customers. The forming of the channel includes forming a channel applicable to the enterprise. The forming of the channel includes forming a channel applicable to the customers of a particular enterprise. The forming of the channel includes forming a channel applicable to a particular customer of a particular enterprise. The causing of the proposed action to be taken includes automatically taking the action on behalf of the enterprise. The causing of the proposed action to be taken includes presenting to a customer service representative information about the proposed action and a control enabling the customer service representative to take the action on behalf of the enterprise.

In general, in an aspect, records are stored associating particular customers of an enterprise with a customer service representative of the enterprise who engages in successive customer interactions at different times with the customers. User interface controls are exposed to the customer service representative through a user interface of a device. The user interface controls enable the customer service representative to select one or more customer services or customer benefits to be provided to customers and to select one or more of the particular customers to whom the customer services or customer benefits will be provided. In response to an action by the customer service representative, at least one of the selected customer services or customer benefits is provided to the selected particular customers. User interface controls are presented enabling the customer service representative to use two or more different interaction channels for messages to be sent to customers and to use the two or more different interaction channels in any order from within the user interface to send messages to a customer being served. The different interaction channels include at least a chat channel or a voice channel and a image channel or a video channel.

Implementations may include one or a combination of two or more of the following features. The stored records contain information about the customers related to the customer interactions. The stored records contain demographic information about the customers. The stored records are presented to the customer service representative through the user interface and user interface controls are presented to enable the customer service representative to add, delete, edit, and manage information in the stored records manage stored records. The customer benefits include promotional benefits. The promotional benefits include offers with respect to one or more products of the enterprise. User interface controls are exposed to the customer service representative to enable generation of the marketing communications.

In general, in an aspect, user interface controls are exposed to a customer service representative of an enterprise. The user interface controls enable the customer service representative of the enterprise to define terms of one or more marketing communications associated with products of the enterprise. Records are stored representing the marketing communications. During electronic customer interactions with customers that include chat channel messages and in response to invocations of a user interface control by the customer service representative, one or more of the marketing communications are incorporated in chat channel messages sent to the customers, based on the stored records.

Implementations may include one or a combination of two or more of the following features. The user interface controls enable the customer service representative to identify customers to whom the marketing communications should be sent. The customer service representative is enabled to identify groups of the customers. The groups of the customers include customers who share a common demographic characteristic. The marketing communications are sent to the identified customers at a time when the customers and the customer service representative are not engaged in a customer interaction that includes chat channel messages. The responses to the marketing communications are received in chat channel messages.

In general, in an aspect, a chat channel system is presented to a customer of an enterprise through a user interface of an app or a browser running on a device of the customer. The chat channel system enables the customer to send and receive messages to and from a customer service representative of the enterprise as part of customer interactions. The customer interactions include messages containing information about products available from the enterprise to the customer. User interface controls are presented to the customer through the chat channel system to enable the customer to pay for products available from the enterprise in the course of a chat channel customer interaction.

Implementations may include one or a combination of two or more of the following features. The user interface controls presented to the customer enable the customer to pay for the products by a single on a display surface of the device.

In general, in an aspect, (a) at a first time, through a user interface of a customer service system of an enterprise, a customer service representative is enabled to engage in a first customer interaction with a particular customer, the first customer interaction including sending messages to and receiving messages from the particular customer in a chat channel and (b) through the user interface, the customer service representative is enabled to store records associated with the particular customer. (c) At a second time, through the user interface of the customer service system, the customer service representative is enabled to engage in a second customer interaction with a particular customer, the second customer interaction including sending messages to and receiving messages from the particular customer in a chat channel, and (d) at a third time, a marketing communication associated with a product of the enterprise is sent to the customer.

Implementations may include one or a combination of two or more of the following features. Multichannel messages are enabled as part of the first customer interaction and the second customer interaction. The multichannel messages include a voice channel, a chat channel, and a graphical channel.

In general, in an aspect, a chat channel system is presented to a customer of an enterprise through a user interface of an app or a browser running on a device of the customer. The chat channel system enables the customer to send and receive messages to and from a customer service representative of the enterprise as part of customer interactions. The customer interactions include messages containing information about products available from the enterprise to the customer. The customer is enabled through the chat channel system to complete a checkout form to buy a product from the enterprise during the course of one of the customer interactions. The messages of the customer interactions and the checkout form are communicated in a chat channel.

In general, in an aspect, a message is presented to a user of the user device as a communication that is part of an interaction between the user and another party on an asynchronous interaction channel. The message includes a request for confirmation of an action with respect to a proposed transaction. The request includes information characterizing the transaction. An invocable user interface control for confirming the action is included in the message. An invocation of the user interface control confirming the action is received. The action is executed based on the confirmation. The execution of the action is reported to the user.

Implementations may include one or a combination of two or more of the following features. The asynchronous interaction channel includes a chat channel. The interaction includes a chat session. The message includes a request to approve transaction. The user device includes a mobile device. The other party includes a representative of an enterprise and the user includes a customer of the enterprise. The action includes completing a transaction. The transaction includes a financial transaction. The financial transaction includes payment of a bill. The request for confirmation of an action includes a request for an authorization. The financial transaction includes presenting an invoice for an offer, a product, or a service. Metadata is recorded associated with the execution of the action. Presentation of the message includes displaying a panel containing the information characterizing the transaction. The panel includes the invocable user interface control for confirming the action. The confidentiality of at least some of the information is preserved. The interaction between the user and the other party is recorded and the transaction is associated with at least a portion of the recording in which the user interface control confirming the action was invoked. And identity of the user is authenticated before accepting the indication of the user interface control confirming the action. The message includes a bill from an enterprise. The user interface control enables the user to authorize payment of the bill from an account of the user. The action is executed based on the confirmation by transferring funds from the account of the user to an account of the enterprise. The reporting of the execution of the action includes sending the user a receipt for the payment of the bill. The user can invoke a wallet as part of confirming the action. Messages including such requests for confirmation for a group of such other parties are bundled and causes, in a single step, to be presented to the parties of the group. The messages include bills or invoices and the parties comprise customers of an enterprise.

These and other aspects, features, implementations, and advantages (a) can be expressed as methods, apparatus, systems, components, program products, business methods, means or steps for performing functions, and in other ways, and (b) will become apparent from the following description and from the claims.

### DESCRIPTION

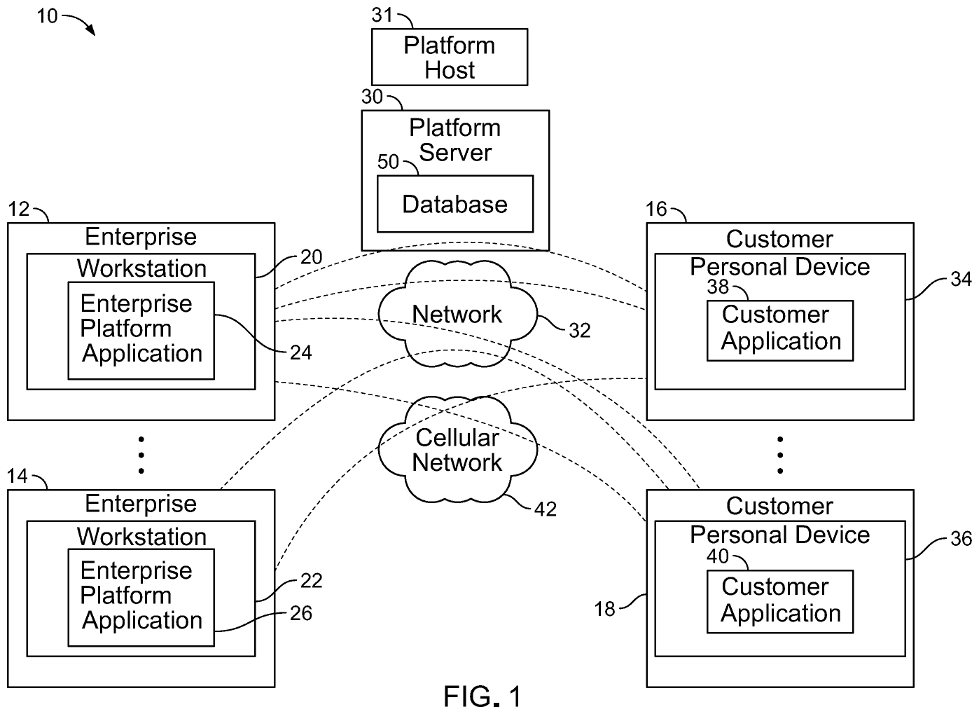

FIGS. 1, 38, 47 and others are block diagrams.

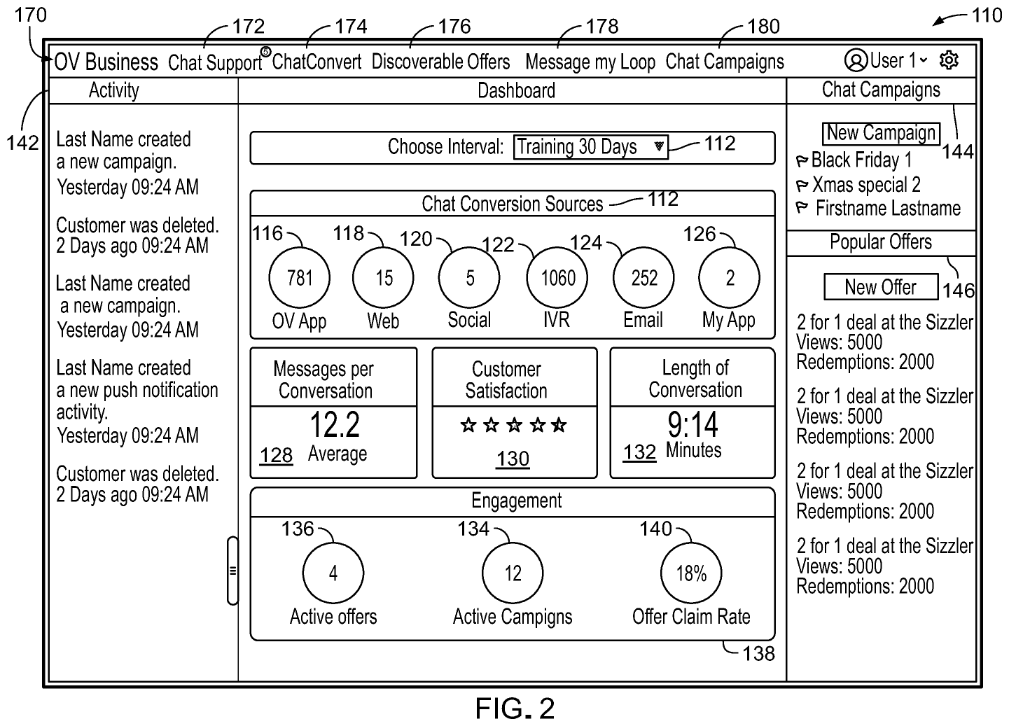

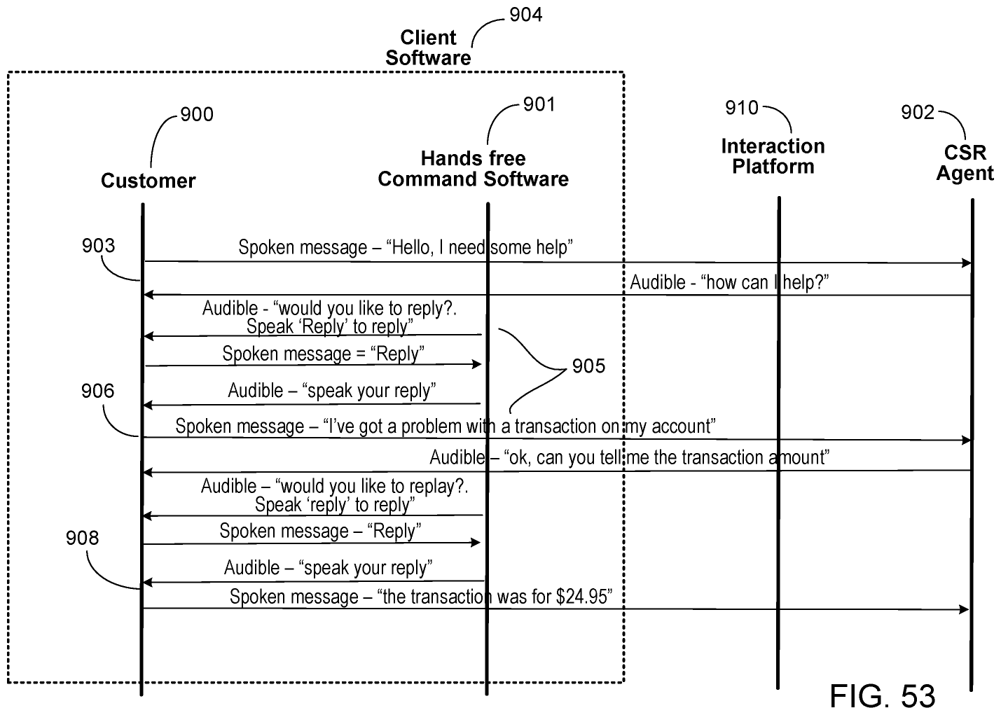

FIGS. 2 through 6, 78, 7B, 8 through 37, 39 through 45, 48, and 50 through 52are screenshots of user interface pages.

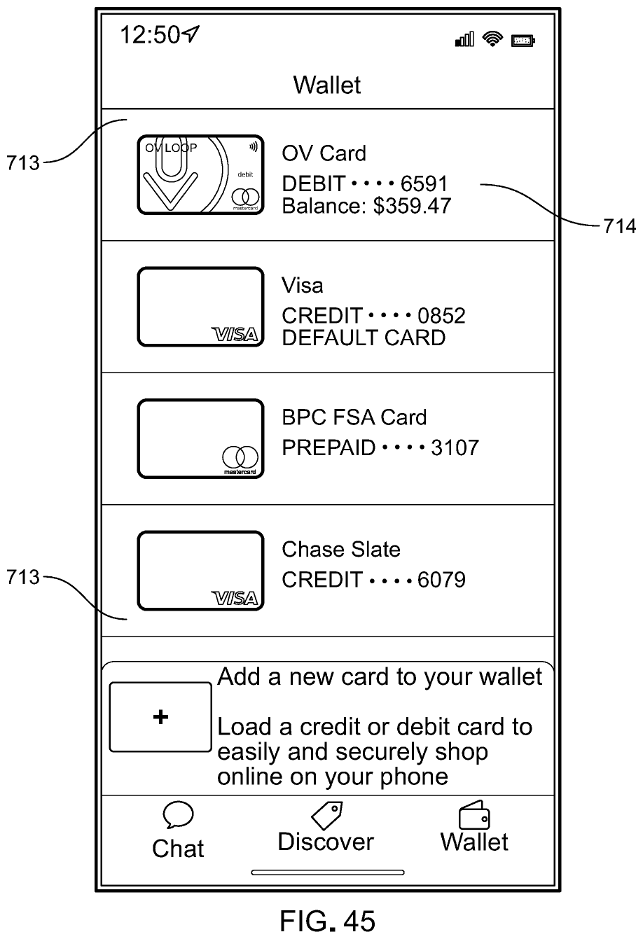

FIG. 46 is a flow diagram.

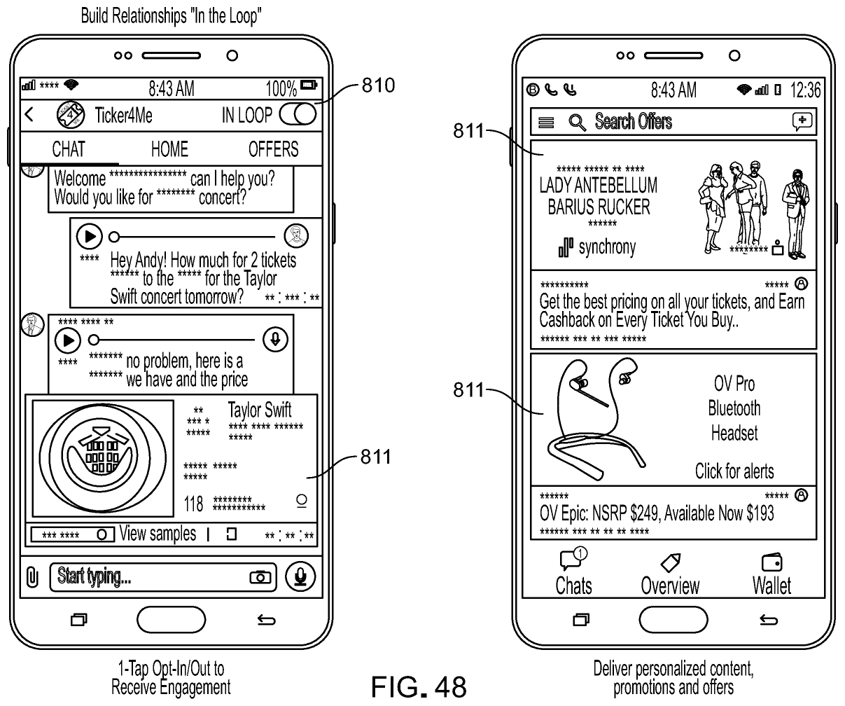

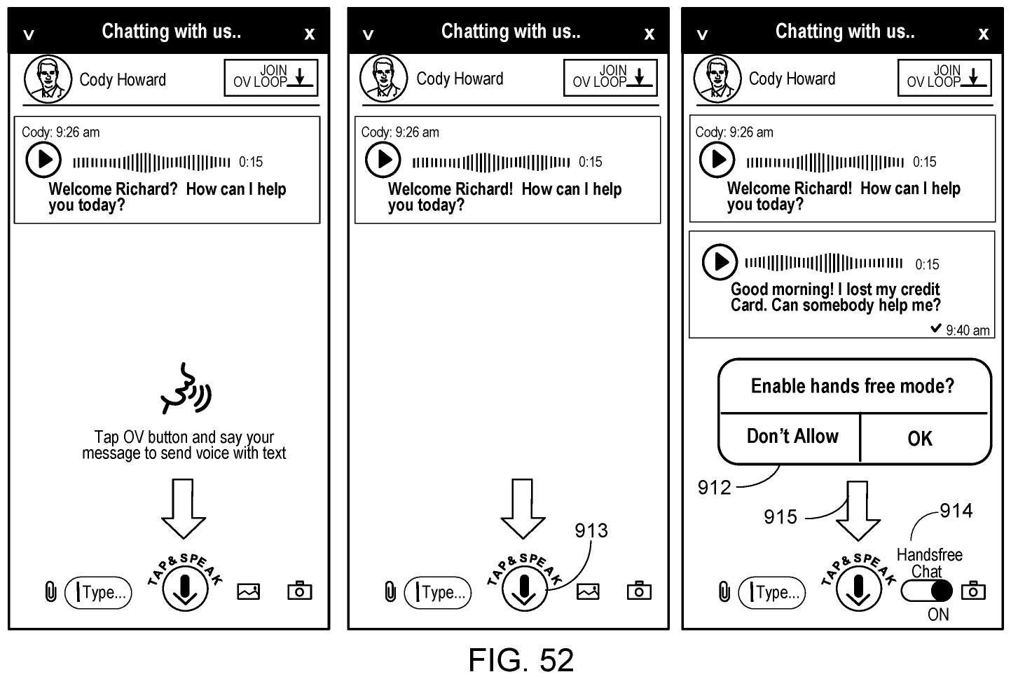

FIGS. 49 and 53 are interaction diagrams.

### OVERVIEW

Here we describe an enhanced customer interaction platform for enterprises (which we sometimes call simply the “interaction platform.”) Among other things, the interaction platform enables enterprises to more easily and productively start, grow, and maintain rich, robust, long-lived, deep, intense, high quality, efficient, and easy-to-manage customer relationships by improving the customer experience in customer interactions with the enterprise.

Customer interactions and customer relationships can serve a wide variety of purposes depending on the identity of the customer, the nature of the enterprise, and the context of the interaction, among other things. Among the purposes for customer interactions and customer relationships may be: providing service to the customer with respect to products of the enterprise; training the customer on the use of a product of the enterprise; managing billing, payment, collection, or refunds with respect to transactions and products of the enterprise; providing information to the customer about or related to products of the enterprise; managing returns, replacements, and cancellations for orders of products of the enterprise; receiving comments, praise, or criticism about products of the enterprise; and answering questions about the enterprise or its products; and combinations of these.

Terminology

We use the term “customer” broadly to include, for example, any individual acting on her own behalf or on behalf of an entity in interactions with an enterprise that typically involve goods or services or other products (or combinations of them) provided by, activities engaged in by, or other customer transactions with the enterprise, for example. The customer may be a prospective customer, a current customer, or a past customer.

We use the term “enterprise” broadly to include, for example, a commercial, governmental, or non-profit entity that has customers (sometimes a very large number of customers) and products of interest to the customers.

We use the term “customer relationship” broadly to include, for example, an affiliation, association, exchange, affinity, or other alliance between a customer and an enterprise. A customer relationship may relate to goods or services or other products (or combinations of them) provided by the enterprise, including information about the products, sales, customer transactions, instructions, training, advice, support, or other service with respect to the products, to name a few examples.

We use the term “customer interaction” broadly to include, for example, any occurrence, session, or event during which one or more messages are sent between a customer and an entity using one or more interaction channels. A customer interaction can occur during a particular time window beginning with a certain action or moment and ending with a certain action or moment. In some cases, a customer interaction can occur during a period that has a somewhat indeterminate beginning and end. One or more customer interactions of a given customer can be part of a customer relationship. Customer interactions can include customer transactions.

We use the term “customer transactions” broadly, for example, payments, loans, credit card and debit card uses, returns, refunds, shipments, purchases, sales, and other activities involving products of an enterprise.

We use the term “customer service representative” or simply “CSR” broadly to include, for example, a person who is employed by or acting on behalf of an enterprise to provide information, support, or responses to a customer of the enterprise or to engage in communication with the customer to enhance the customer relationship. Customer service representatives can include people who are formally called “customer service representatives” and are hired, trained, and managed in specific positions bearing that title. Customer service representative can also include other employees and people acting on behalf of an enterprise in such roles, for such purposes, and with such authority.

We use the term “interaction channel” broadly to include, for example, any particular approach, style, method, manner, or other way of communicating messages between a customer and an enterprise. Examples of interaction channels include voice telephone calls, chat, email, images, video, sounds, forms, texting, social networking, application features, speech, speech to text, checkout capabilities, first party marketing communications, third party marketing communications, URL links, payments, financial transactions, survey, and Web pages, for example. Interaction channels can be synchronous, asynchronous, and quasi-synchronous.

We use the term “marketing communications” broadly to include, for example, any kind of marketing communication, publicity, advertising, or other marketing message sent by or on behalf of an enterprise to a customer.

We use the term “synchronous interaction” broadly to include, for example, a real time back-and-forth communication session between a customer or a customer service representative and another party who are both engaged at the same time in the back-and-forth. Voice telephone calls are typically synchronous interactions. A synchronous interaction often spans a particular period between a start and an end of an interaction session, and the real time back-and-forth occurs only during that period.

We use the term “asynchronous interaction” broadly to include, for example, a back-and-forth communication between a customer or a customer service representative and another party in which the customer and the other party are not necessarily both engaged at the same time in the back-and-forth. For example, a message from the customer to the other party and a reply message from the other party to the customer may occur at different unrelated times or in different media. Email interactions are typically asynchronous. Some kinds or portions of chat are also asynchronous.

We use the term “synchronous/asynchronous interaction channel” or “quasi synchronous channel” broadly to include, for example, back-and-forth messages between a customer or a customer service representative and another party in which some messages or aspects of the interaction are passed synchronously and some messages or aspects are passed asynchronously.

We use the term “platform” broadly to include, for example, any combination of hardware, software, firmware, fixed or mobile devices, servers, clients, and other components that operate in a coordinated way to provide one or more services or features for customers, enterprises, third parties, or other users. For example, the services or features may be services or features of a customer interaction platform for enterprises.

We use the term “multichannel customer interaction” or “multimedia customer interaction” broadly to include, for example, any electronic interaction between an enterprise and one or more of its customers that includes two or more (e.g., multimedia) interaction channels. A multichannel or multimedia customer interaction can be synchronous or asynchronous or quasi-synchronous and can occur in one session or multiple sessions, and at one time or multiple times, and over a short period of time or over a long period of time, for example.

Among particular benefits of the interaction platform is making customer interactions more convenient and frictionless. In some implementations, by converting traditional telephone calls to an enterprise into asynchronous multimedia channel customer interactions, better customer service relationships can be achieved. For example, a given CSR can handle multiple customers simultaneously and make his messages to customers richer by including video, images, voice, marketing communications, and deep link URL's, among other things.

Hardware and Software Architecture

To provide the capabilities described in this document, the customer interaction platform can host and expose a variety of functions, facilities, and features using a variety of hardware and software architectures.

As shown in FIG. 1, in some implementations the interaction platform 10, one or more enterprises 12, 14 are platform participants for the purpose of starting, growing, and maintaining rich, robust, long-lived, deep, intense, efficient, and easy-to-manage customer relationships with customers 16, 18 who are also platform participants.

We use the term “platform participant” broadly to include, for example, any enterprise or customer or other party who has engaged with, registered with, interacts with, uses, or otherwise participates in the activities of the platform. We sometimes refer to particular platform participants as “enterprise participants” or “customer participants.”

Typically, the enterprises that are platform participants are independent of one another even though they share participation in the platform for customer relationship purposes. The platform is designed and implemented so that each of the enterprises can make use of and expose to its customers features of the platform in a private label mode. In such a private label mode, features of the platform are exposed to the customers in the context of marks and branding materials of the enterprise. The customer believes that he or she is dealing with particular enterprises even though that in some respects the customer relationship is facilitated by features of the common platform in which the enterprises participate.

The customer relationships of an enterprise can extend to multiple (sometimes a very large number) of different customers, and the customer relationships of each of the customers can extend to more than one of the enterprises in a separate way.

The activities of enterprises as platform participants generally occur through user devices owned or controlled by the enterprises, for example workstations 20, 22. The participation at each workstation occurs through a platform application 24, 26 provided by a host 28 of the interaction platform and installed on the workstation, or through webpages served from a central platform server 30 through a communication network 32 such as the Internet to a Web browser running on the workstation, or in both ways. We use the term “enterprise platform application” to refer to either or both of an application installed on the workstation or an application served through webpages from the central server.

The enterprise platform application provides features that, among other things, enable (a) the enterprise to register and manage an enterprise profile on the platform server, (b) customer service representatives of the enterprise to engage in customer interactions and customer relationships with customers of the enterprise, and (c) the enterprise to manage the appearance and branding of its private labeled presentation to its customers.

The activities of the customer platform participants generally occurs through personal user devices 34, 36, including mobile phones, tablets, laptops, and other mobile devices, and home computers, workstations, and other generally static devices. The participation at each of the personal devices occurs through a customer application 38, 40 provided by the host of the interaction platform and installed on the personal device, or through webpages served from the central platform server through the communication network to a Web browser running on the personal device, or in both ways. We use the term “customer application” to refer to either or both of an application installed on the personal device or an application served through webpages from central server. In some implementations, the consumer application can be a native application already available on the personal device, such as an email, voicemail, video, text, or chat application associated with or provided by an operating system running on the personal device. In some cases, plug-ins or add-ons can be provided for the native application. A wide variety of implementations are possible for the consumer application on the personal device including combinations of proprietary applications or features and commonly available non-criteria applications or features.

In any case, for purposes of participation by customers and enterprises in the interaction platform, communications using one or more interaction channels can occur either directly through the network between a customer's personal device and an enterprise workstation or indirectly through the platform server which can host and facilitate the communication, or a combination of both. When the interaction channel includes voice telephony, interaction channels between customers and enterprises can pass through the cellular network 42. In some instances, text, image, video, or voice data that is part of customer interaction can be passed as data through the cellular network. In some implementations, a variety of different communication media and communication networks can be used to carry and pass messages between customers and enterprises participating in the interaction platform.

The platform server of the interaction platform can be implemented as one or more servers in one location or distributed, and we sometimes use the simple phrase “platform server” to refer to any such arrangement. The platform server includes hardware and software appropriate for providing the features and functions of the interaction platform described in this document. In general, the platform server communicates with customer devices and enterprise workstations through one or more communication networks. In some implementations of the interaction platform, the server (and sometimes other components) is hosted by a platform host unrelated to or not under common control with any of the enterprise participants or the customer participants. In some examples, each of the enterprises or groups of them can control and be served by their own replication or replications of the platform server. In some cases, control of the server can be shared between a platform host and one or more of the enterprises. In some of the figures, references to OV are to implementations in which the platform host is OV Loop, Inc., of Danvers, Mass.

Among other things, the platform server includes a database 50 that stores information useful to or required by the functions and features of the interaction platform. Among other things, the database includes information of the following kinds: profile and registration information for each of the enterprise platform participants and customer platform participants; authentication and security information; associations of customers with enterprises for which there are customer relationships; records and logs of messages, customer interactions, and customer relationships between customers and respective enterprises; information about customer service representatives and their relationships with respective customers; information about marketing communications, publicity, marketing, and advertising exposed on behalf of enterprises to their customers; information about the performance of customer service representatives; and information used by machine learning processes in analyzing logs of customer interactions and information about the results of such machine learning processes; and other kinds of information and combinations of all of these. Information in the database is kept current based on information identified or received by the platform server from the enterprise workstations, the customer personal devices, and from observing content, timing, and connections among messages passing through the platform server between customers and enterprises, among others.

In some implementations, some of the information stored or to be stored in the database at the platform server can be temporarily accumulated and stored at one or more of the enterprise workstations or one or more of the customer personal devices and later forwarded to the server. In some examples, portions of the database can be stored persistently at the enterprise workstations or customer personal devices.

In some instances, the enterprise platform application can be coupled to or otherwise interact with other applications or operating systems running on one or more of the enterprise workstations or one or more of the customer personal devices. For example, the enterprise platform applications can be part of more comprehensive customer service systems of the enterprises.

Main Functions and Features of the Interaction Platform

As discussed in more detail later, the interaction platform is configured to perform several main functions and features intended, among other things, to enable enterprises to significantly improve the richness, depth, closeness, duration, quality, and intensity of customer relationships with their customers. These features and functions include the following (and combinations of them), among others:

1. Managing and facilitating participation in and use of the interaction platform by enterprise participants and customer participants.

2. Facilitating customer interactions and customer relationships between enterprises and their customers.

3. Maintaining, updating, and providing access to the database.

4. Distributing enterprise platform applications and customer applications through the networks to the enterprise workstations and the customer personal devices.

5. Serving interactive Web pages through the networks to the enterprise workstations and customer personal devices and receiving and acting on requests and information received through the Web pages.

6. Receiving, forwarding, and analyzing messages communicated to and from clients and enterprises as part of customer interactions and customer relationships.

7. Interacting with third parties in connection with execution of customer transactions such as payments and for other purposes.

8. Facilitating activities of customer service representatives of enterprises, enabling customer service representatives to engage in “concierge” services, and enabling customer service representatives to create and manage customer service loops.

9. Presenting marketing communications, publicity, offers, and advertising to customers on behalf of enterprises.

10. Managing and facilitating interaction channels and conversion of interaction channels during the course of a customer interaction.

Certain of these features and functions are described in more detail later.

### Interaction Channels

The interaction platform can be deployed in contexts involving a wide variety of different interaction channels and combinations of them for customer interactions between an enterprise and its customers. Customer interactions can be initiated either by a customer or an enterprise. When a customer interaction is to be started, the customer or enterprise must take an action to initiate the customer interaction in one or a combination of particular interaction channels. For this purpose each interaction channel typically is presented to the user through an interaction user interface of an interaction application.

For example, when the interaction channel is a voice phone call, the interaction application can be the telephone application included in an operating system of a mobile phone and the interaction user interface can be the touchpad of the telephone application. If the interaction channel is chat, the interaction application can be a chat application native to a mobile phone or a chat application of the third-party installed and running on a mobile phone or a telephone call interface of the Web browser running on a mobile phone. For such a chat interaction channel, the user interface can be a chat window including a text entry box, for example.

Entry Step to an Interaction Channel

To start a customer interaction or to send a message, the customer, for example, enters a phone number for a voice telephone call or types a chat message in the text box and touches “enter”. We use the term “entry step” to refer to the action taken by a customer, or an enterprise, to initiate a customer interaction using a particular interaction channel or channels. Once the entry step has been taken, the device of the other party (the customer or the enterprise) receives the inbound message and typically either ignores the inbound message or responds to the inbound message in the same interaction channel. We use the term “inbound message” broadly to include, for example, any message directed to, communicated to, or received by the customer or an enterprise.

As described below, using the interaction platform, the party receiving the inbound message can instead of responding using the same interaction channel, convert the customer interaction from one interaction channel to another, say from a voice telephone call to a chat session. In some cases, the conversion can be done in response to an initial message of a customer interaction. In some instances, the conversion can be done in response to a message that occurs later in the customer interaction. In some examples, the entry step occurs immediately prior to the entry of the initial message. For example, as explained below, when a user initiates a voice mobile telephone call to a CSR of an enterprise, the enterprise can cause a message to be immediately presented to the customer within an interaction user interface of a particular interaction channel or channels including a URL that can be invoked within the user interface of that particular channel or channels. Invoking the URL can trigger a connection or session or other customer interaction using an interaction channel of a particular type between the customer and a CSR at the enterprise.

The type or purpose of a customer interaction can affect characteristics of the entry step for the customer and characteristics of the user interface exposed by the platform to one or more CSRs. For example, the entry point for a customer who wants to ask a question of a CSR can be a chat window presented in a browser or in an interaction application for a chat session. Each interaction channel can have one or more specific corresponding entry steps for a given interaction channel. Entry steps can be performed manually, automatically, or by a combination of automatic and manual activities. Entry steps can be exposed to customers or enterprises in a variety of ways and at a variety of times.

Typically, once an entry step has been performed and a corresponding interaction channel becomes available, that interaction channel remains available to the customer or the enterprise until the availability is terminated by action of the customer or the enterprise, or automatically by the interaction platform, or by the termination of a given customer interaction, or a combination of two or more of these.

Sometimes an entry step is indicated explicitly through a user interface to a customer or customer service representative. Sometimes the entry step is implicit so that when the customer or customer service representative begins to use a particular interaction channel, the first use implicitly serves as an entry step and makes that interaction channel available thereafter.

Entry steps could include, for example, simply beginning a chat session in a chat window or initiating a voice telephone call on a mobile device or beginning to answer survey questions on a Web page, to name a few. In some cases, the entry step could be associated with the launching or invocation of an interaction application available on the customer's device, for example, the opening of a social network and the typing of a post in the social network window.

The entry step used by a customer to begin a customer interaction with an enterprise can be important for activities performed by the interaction platform. For example, if the entry step is a telephone call interaction channel, the CSR may choose to promote a conversion from the telephone call interaction channel to a multimedia chat interaction channel.

The entry step can be exposed to the customer through a Web site or through an interaction application running on the customer's device that is provided or served by the platform host, is specifically designed for use with the interaction platform, is configured to enable access by the customer to the CSRs of one or more enterprises, and (in the case of an interaction application) is downloaded and installed by the user. In some examples, the interaction application or Web page can be provided or served directly by an enterprise for use by its customers.

Interaction Channel Conversion (for Example, Voice to Chat)

As mentioned above, the interaction platform can convert (and enable the conversion by a CSR or customer of) a traditional voice telephone call to an enterprise using a telephony interaction channel into a customer interaction on an asynchronous multimedia interaction channel for more convenient and frictionless communication, for example, for a better customer relationship and better customer interaction.

We use the term “multimedia interaction channel” broadly to include, for example, an interaction channel that enables messages to be sent or received using two or more different forms of messages. For example, a multimedia interaction channel could enable messages to be sent or received using any combination of two or more of the following forms: text, voice, images, videos, forms (including checkout forms), or identity scoring. In a particular case, the multimedia interaction channel could be a chat channel combined with video, image, and speech to text features. The concierge assistance of a CSR can be provided in various individual interaction channels and combinations of them in the form of multimedia customer interactions. In some examples, multimedia customer interactions can include simultaneous presentation and use of two or more distinct interaction channels in a given customer interaction, such as video and chat at the same time. In some cases, multimedia customer interactions can involve supplementing a base interaction channel, such as chat, with a supplemental interaction channel (such as video or image) made available within and as part of the base interaction channel. In some implementations, multimedia interactions involve the ability to use supplemental interaction channels continuously while the base interaction channel is active. For example, when the base interaction channel is a chat session and the supplemental interaction channels are video, image, and others, the multimedia interaction includes the ability of the customer and the CSR to continue to use the supplemental interaction channels as long as the base interaction channel, e.g., the chat session, continues.

Although we use the example of converting from a voice telephone call interaction channel to the asynchronous multimedia interaction channel, the conversion can be from other kinds of interaction channels, such as Web pages, applications running on a device, email, or QR codes in physical locations or on packages. More generally, we use the term “interaction channel conversion” to include, for example, a conversion from any interaction channel or combination of interaction channels to any other interaction channel or combination of interaction channels, including multimedia interaction channels.

Among the advantages of an interaction channel conversion from a synchronous channel (e.g., a voice telephone call) into a multimedia asynchronous channel, such as multimedia chat, is making it easier for a single CSR to handle multiple customers simultaneously. By working in a multimedia asynchronous channel, the CSR also can make her messages to customers richer by including video, images, voice, marketing communications, and deep link URL's, combinations of them, for example.

Conversion from synchronous interaction channels to multimedia asynchronous interaction channels can be applied to, for example, payment channels, payment methods, customer service systems, customer relationship management systems, and any other application or process that interfaces with customers of an enterprise.

In some implementations of the interaction platform, interaction channel conversion can be effected automatically without input or approval by a CSR or a customer, or can be effected after the channel interaction conversion has been offered, requested, encouraged, or required (or a combination of these) of either or both of a CSR or a customer who are engaged in or are about to engage in a customer interaction. In some cases, interaction channel conversion can include adding one interaction channel or multimedia interaction channel to another interaction channel or multimedia interaction channel, so that all of the interaction channels involved can be used simultaneously or in any order in a customer interaction.

Channel conversions can be between asynchronous, quasi-synchronous, and synchronous channels and between oral telephony channels and non-oral telephony channels. Often the purpose of a channel conversion is to enhance the speed, effectiveness, richness, and ease with which a customer interaction proceeds. For example, channel conversion can be from a synchronous telephone call to a quasi-synchronous multimedia chat, which can reduce the waiting time of a customer seeking service and improve the quality of the customer interaction with the CSR. In some implementations, channel conversion can be from an IVR interaction channel to a multimedia asynchronous chat session, or from an email channel, a Web page channel, a mobile app channel, or a social network channel to an asynchronous multimedia customer interaction with a CSR.

Chat Convert Example

Here we discuss a particular example of interaction channel conversion which we sometimes refer to as “chat convert”. In some implementations, chat convert includes converting an incoming customer voice telephone call from a synchronous IVR channel to an asynchronous digital channel (which we sometimes call simply and asynchronous channel, e.g., a non-voice-telephone-call channel) for on-going customer interaction with that consumer.

We use the term “third party” or “third party service” broadly to include, for example, any entity other than the customer or the enterprise interacting with the customer that supplements or performs certain or all technical activities related to or required for implementation of chat convert. In some implementations, the third party is the interaction platform host.

As used herein the term “caller ID” refers to an identifier of a customer's mobile device, for example, such as the phone number of the mobile device of an incoming call. The caller ID may be used by the interaction platform to collect the phone number of the customer and then also sometimes to perform tests on that phone number to discover more attributes about it or the identity of the customer.

As used herein the term “CRM” or “CRM agent” refers to a Customer Resource Management agent. We sometimes use the terms CRM and CRM agent interchangeably with the terms CSR or CSR agent.

As used herein the term “business ID” refers to an identifier of a business from which an incoming call originated, which can be used to identify the phone number of a business customer associated with an incoming call. The business ID may be used to collect the phone number and then also sometimes to perform tests on that phone number to discover more attributes about it or the identity of the business customer.

As used herein the term “short link” refers to a type of URL. A short link typically includes a link text shorter than the URL to which it refers. A short link can be used for purposes of forwarding to a new URL. For example, a short link may be “http://gane.io/XFFCRD” which, when activated by a customer, may forward to a new URL such as “https://clemsontigers.com/sports/football/”.

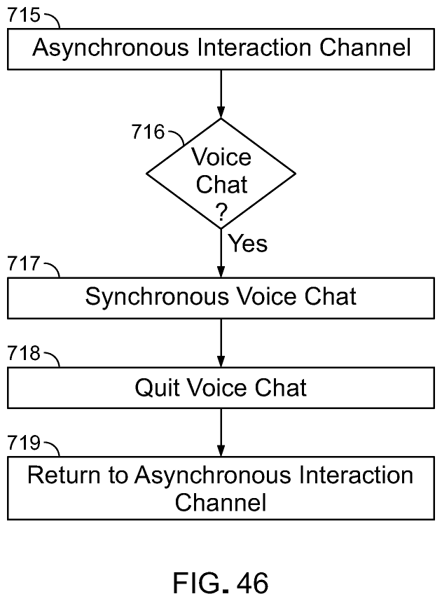

FIG. 47 illustrates an implementation of an interaction channel conversion system. When an enterprise initiates the process of implementing features of the interaction platform for its own use, it may have particular business reasons to decide 801 whether to implement chat convert on its own existing IVR 801 or to allow a third party (such as the host of the interaction platform) to host the IVR 802. Selecting the hosting method 801 or 802 depends on the characteristics of the existing IVR technology at the enterprise as well as business-related considerations. One advantage of some implementations using an existing IVR system 801 is that the phone number previously provided to the general public does not have to be altered in order to present the new chat convert option for a set of existing customers who would be calling the IVR phone number. For this reason it is important for chat convert implementations to be flexible in order to handle different implementation types.

In the event the enterprise elects to enhance their own IVR 801 with the chat convert feature, there are other features of the IVR that need to be assessed to confirm that they can properly support chat convert. For example, the IVR system 801 may natively support the ability to create a digital (non-voice) URL for forwarding to the customer 805. If the IVR 801 does not support URL forwarding 805, then the enterprise IVR system 801 can be configured to use a third-party service 806 to handle URL forwarding.

The customer experience with the self-hosted enterprise IVR system 801 is only slightly altered with the addition of chat convert. Initially, the customer dials the same phone number that has previously been published for reaching the enterprise. When the customer reaches the IVR system through a phone call, the customer is given an option for example to stay on the line for a live call or to press 1 to start a chat. When the customer elects to stay on the line, the customer is directed to a live CRM agent 803. If the customer elects to begin a chat session, then the enterprise IVR system creates a URL for forwarding 805 to the customer's device. The forwarded URL contains a digital link that the customer will receive and can activate on their personal digital device. The term “chat” when used in communications with the customer in this context will imply to most customers that, by invoking the length, they will be entering into a textual asynchronous interaction with the CRM agent. The customer experience generally will be the same if the chat convert implementation uses the enterprise's own IVR system's URL forwarding 805 or the third-party (e.g., interaction platform host) URL forwarding service 806.

If the enterprise elects to have a trusted third-party service host the IVR system 802, there may be need to be no altering of the enterprise's existing IVR system. It may be required, however, for the enterprise to publish a new phone number for reaching the third-party IVR system 802. Once the customer reaches the third-party IVR system 802 using the new phone number, then the customer experience can be identical to the experience described with the enterprise IVR 801. In the voice telephone call, the consumer is presented audibly with a choice to press 1 for a chat or to stay on the line to talk to a live CRM agent. If the customer elects to begin a chat session, then the third party IVR system creates a URL for forwarding 806 where the URL contains a digital link that the customer will receive and can activate on their personal digital device.

In some implementations, before the new URL is sent to the consumer, the customer's phone line connection may be evaluated to verify the identity of the customer. For this purpose, the interaction platform may look at a caller ID or a business ID in order to increase its confidence or confirm the phone number is a mobile number and not a land line number, for example, as well as make a better decision on whether to proceed with converting a customer to an asynchronous interaction channel on the customer' s mobile device. If the system does not obtain greater assurance through caller ID or business ID checks, the IVR system 801 or 802 may simply forward the voice telephone call from the customer on the phone to a live CRM agent 809 or another IVR system instead of forwarding a URL.

The URL created and forwarded to the customer in 805 and 806 may be configurable. There are various options for configuring a forwarded URL. For example, as shown in box 807 a software process may be executed by the interaction platform (e.g., the IVR system) to assess whether to proceed with URL forwarding 808, or forward back to a live CRM agent 809. A process may include running a test to see if the phone number associated with the caller ID or business ID is a land line. If the phone number is a mobile number, the URL may be sent via SMS text message.

The URL can then be created to have a certain configuration so that when the URL is activated, the customer can continue a conversation with a CRM agent using an asynchronous interaction channel (e.g. a chat session). Other configuration parameters are also possible. For example, the URL may be formed as a short link and also may include a deep link to begin the customer interaction on the asynchronous channel. The configured URL is forwarded to the mobile phone 808. When the customer activates the URL, if the customer's mobile phone has an associated interaction application installed, the deep link may automatically switch the customer into the associated mobile application to continue a mobile interaction application-based asynchronous interaction channel. If the customer does not have an associated mobile interaction application, then the URL may automatically switch the customer into a web browser running on the mobile device to continue an asynchronous web interaction channel.

Chat Convert in a Web-Based Context

In contexts in which the conversion to chat from the IVR system is to be a conversion to a Web-based chat application, the server of the interaction platform will create, on behalf of the enterprise IVR system, a client account for use of the Web chat application and will provide API credentials (username & password) for the chat convert function to the IVR system and the URL needed to reach the API. The enterprise then updates the call flow of the existing IVR system, for example, to change what customers hear before and after pressing a voice call option for Web chat, e.g., “Press 1 for Web chat!”. When the IVR system invokes the chat convert API from the existing IVR system it passes the CallerID (required) and the DNIS (optional) and then terminates the call. The call-to-chat conversion API then sends an SMS to customer (at the CallerID) with a customized text message and a unique URL to enable the user to open and start the Web chat.

In some implementations, the IVR system of the enterprise may not support URL forwarding or restful APIs, but the enterprise wants to continue to use the IVR system. Then the IVR system can be configured to address the call to the interaction platform phone number which then forwards the call to the Web chat application. As in the previous description, the interaction platform will create a client account, and the enterprise will customize the existing IVR call flow. When the customer chooses the chat convert option, the IVR system passes the original CallerID to the provided phone number of the interaction platform server. The interaction platform then plays the IVR recording (e.g. “Thank you for contacting us, a chat link has been sent to your mobile phone”) and terminates the call. The interaction platform server sends an SMS to customer (at the CallerID) with a customized text message and a unique URL to open and start a Web chat.

In some cases, the enterprise may not have an IVR system in place or for other reasons wants the interaction platform to handle the calls to the IVR system and the restful API calls. In such situations, the interaction platform can generate a new IVR system for the enterprise and manage the call flows and the recordings for the enterprise.

Chat Convert API Protocol

The following guide outlines the chat convert API for an IVR system that can be requested to transfer a call request from a customer to a Web chat link that is delivered to the customer by SMS.

An example of the flow follows:
1. The customer calls a phone number of the enterprise's IVR system (e.g., 1-800-123-4567)
2. The IVR system plays available options to the customer:

“Thank you for calling Amalgamated Widgets,

Press #1 to join a Web chat with one of our Amalgamated Widgets representatives, Press #2 for sales and support.”
3. When the customer invokes option #1, the IVR system invokes the call convert API and terminates the call after playing:

“Thank you for contacting us, a chat link has been sent to your mobile phone.”
4. The customer receives an SMS with a customized text message and a unique URL to open and start a Web chat immediately.

REST API, URL, and Versioning

For purposes of authentication, the interaction platform server provides a set of credentials (a username and password) to each IVR system to enable it to be authenticated and authorized to execute the endpoint. HTTP requests to the REST API are protected using HTTP basic authentication.

Methods of the REST API

POST

The POST method enables a phone call (REQUEST) to be converted to an SMS (RESPONSE). The fields of the POST method include the following:

| | |
|---|---|
| dnis | Dialed Number Identification Service |
| cid | Caller ID (phone number) where the customer is calling |
| | from |
| first_name | Customer's first name |
| last_name | Customer's last name |
| email | Customer's email |
| dob | Customer's date of birth |
| external_id | Identifier of the customer in an |
| | external platform. This could be useful for the enterprise |
| | to understand the relation of a customer on the interaction |
| | platform and on the enterprise's platform. |

Responses provided by the POST method can include: “unauthorized” (when empty or bad credentials are provided) and “bad request” when bad or missing input parameters are provided.

CS Ticket API
all entities generated by the service are identified by a UUID
the entities generated by the service are tickets and events

A ticket entity can be represented as a JSON object used by any process that retrieves a ticket.

Each ticket has a reference field that identifies the ticket by a sequential number. Each participant enterprise uses ticket numbers beginning with digits unique to that participant enterprise. Each ticket also carries a source field that is a combination of an identifier for a client application that was the source of the ticket and an identifier for a communication channel in which the ticket was received. For example, communication channels could include applications, Web sites, social network platforms, IVR, and live chat. The client application could identify an application provided by the platform host for use on customer devices. In some cases the CS ticket API can reference entities owned by others. For example, such other entities can be enterprises (owned by the biz API discussed later), CSRs (owned by the biz API), and messages (owned by the PS API discussed later).

Ticket API

The ticket API supports the following methods:

GET /tickets

GET /tickets?{FILTERS}, which lists tickets that match a past filter as an array by the date created.

GET /tickets/counters?{FILTERS}, which gets activity counters related to tickets filtered by passed parameters.

GET /tickets/in-thread?{FILTERS}, which gets an array of tickets that are and/or were part of a communication thread. The timestamps can be combined, only one can be used or none of them and the method will return all tickets in the thread.

GET /tickets/current?organizationId=ORGANIZATION_ID&consumerId=CONSUMER_ID, which gets the current active ticket between an enterprise participant and the customer.

GET hickets/count?organizationId=ORG ID, which returns the number of pending tickets.

GET /tickets/{id}, which gets a ticket identified by an id.

POST /tickets

This method creates a new ticket. If an open ticket already exists for the customer and the enterprise participant, the method will return a corresponding status code. A protocol field of the ticket tells from where the client application is opening the ticket (generating messages from X and PP/WS). A source field indicates through which channel the “gross hacking” link was passed around. The method passes fields defined in a ticket entity and required to be passed at ticket creation. The POST /tickets methods includes the following:

POST /tickets/pull, which gets a ticket from a queue of tickets and assigns it to a CSR whose identity is included in a request for ticket, the same CSR performing the action.

POST /tickets/{id}/assign, which assigns a ticket to a CSR. If the ticket is already owned by the CSR the method returns a corresponding value. The method can be used to assign a ticket for the first time or to forward a ticket.

POST /tickets/{id}/release, which releases a ticket to the same ticket queue from which it originated. The method places the released ticket at the start of the queue so that the next action by the CSR to pull ticket will pull this ticket.

POST /tickets/{id}/end, which closes the ticket.

POST /tickets/{id}/rate, which returns the rating score for a ticket.

### B2P API

The B2P API provides services to the enterprise application and other applications sending messages to customers using the customer application on their devices. The B2B API service generates messages in the form: message (id in the UUID format). The B2P API references the following entities: listing (id with UUID format), offer (id with UUID format), customer (id as plain string), and advertisement id (id with UUID format). The B2P API method sends messages to one or more users of devices running the customer application. For example, an advertising campaign or a triggered location-based services rule may cause offer to be sent. A listing field identifies the participant enterprise. A recipients field identifies the customers to receive the message.

### Config API

The Config API is used by CSRs who want to change a configuration or behavior of the CS system. The Config API service generates the following entities: future-holiday and canned-content. The Config API service also references the following entities: listing and offer.

The following endpoints, resources, and methods are provided by the Config API in some cases with and in some cases without authentication:

/listings/{listing_id}/schedule, which represents the scheduled working ranges over the week that the CSRs of the participant enterprise will be working.

PUT {base_uri}/listings/{listing_id}/schedule, which updates the week days passed in the request.

GET {base_uri}/listings/{listing_id}/schedule, which gets the working ranges inside the week.

/listings/{listing_id}/future-holidays, which represents the future holidays in which it is known that the CSRs for the participant enterprise will not be operational.

POST {base_uri}/listings/{listing_id}/future-holidays, which adds a future holiday and returns the ID of the added holiday.

/listings/{listing_id}/automated, which sends automated messages to customers in particular circumstances:

Welcome: This message is sent to the customer when he accesses the interaction platform from the Web chat application, right before a ticket gets created. An example is “Hi <name>, helped can we help you today?”

Inactive: This message is sent to the customer when he has been waiting on an unassigned ticket for more than X minutes. Each message has an amount of time that triggers it, and there can be more than one inactive message. The inactive message is sent only during enterprise hours. An example is: “Thank you for your patience. The next available representative will be with you shortly.”

Offline: This message is sent when the customer initiates a ticket during enterprise hours and there is no CSR online. If this is sent, then the inactive message is delayed until CSRs are online. An example is “Thank you for your patience. The next available representative will be with you shortly.”

After Hours: This message is sent when a customer sends a message outside of enterprise hours, whether there are CSRs online or not.

PUT {base_uri}/listings/{listing_id}/automated. Every time this method gets called, all automated types are updated. If any of them is not passed then it's taken as disabled.

GET {base_uri}/listings/{listing_id}/automated, which enables viewing automated behavior.

/listings/{listing_id}/canned-content, which represents content that is predefined by configuration on behalf of each participant enterprise and can be sent by CSRs quickly.

POST {base_uri}/listings/{listing_id}/canned-content, which adds canned content, such as a gift or other offer.

PUT {base_uri}/listings/{listing_id}/canned-content/{canned_content_id}, which updates canned content. This method passes an entity that is interpreted as the new entity to be used, in other words, the new snapshot of the entity.

DELETE {base_uri}/listings/{listing_id}/canned-content/{canned_content_id}, which deletes canned content.

GET {base_uri}/listings/{listing_id}/canned-content/{canned_content_id}, which retrieves requested canned content.

GET {base_uri}/listings/{listing_id}/canned-content, which retrieves an array of all canned content associated with a particular participant enterprise.

/listings/{listing_id}/chat-sessions, a resource that provides URLs that participant enterprises will embed in different communication channels with customers.

GET {base_uri}/listings/{listing_id}/chat-sessions?source={source}, which gives a link to be used to access a Web chat. The source tracks where the ticket was created from.

/listings/{listing_id}/availability, a resource that represents the current availability of the CSRs of a participant enterprise.

GET {base_uri}/listings/{listing_id}/availability?channel=timestamp&at=[IUNIX_TIMESTAMP_SECONDS], which gets the availability for the next timeframe of CSRs.

Managing Interaction Channels

The process of enabling, permitting, or causing an interaction channel conversion is an example of a more general feature and function provided by the interaction platform, which we sometimes refer to as the “interaction channel management”. One or more interaction channels can be managed with respect to a given message or two or more messages or an entire customer interaction.

Interaction channel management can include determining which channel or channels will be active, activating additional interaction channels, deactivating interaction channels, and configuring interaction channels, among other activities. Managing the interaction channels can be done automatically by the interaction platform or manually by customers, customer service representatives, or other people using user interface controls presented through user interfaces of devices of platform participant. In some cases interaction channel management can be done cooperatively by automated features of the interaction platform in cooperation with actions of the customers, the customer service representatives, or the other people.

In some cases interaction channel management can include converting one interaction channel available for a message or a customer interaction to another interaction channel, such as from a synchronous voice telephone call to a quasi-asynchronous chat.

Decisions that are part of interaction channel management can be based on a variety of information about the customer or customer service representative involved in the customer interaction, the nature of the messages that are part of the customer interaction, the availability and quality of communication channels to be used by different interaction channels, and other information. Decisions that are part of interaction channel management can be implemented by instructions to or from a server that supports one or more different interaction channels for customer service representatives and customers or by instructions to interaction applications running on mobile devices of customers or customer service representatives or by instructions to interaction applications running on static devices of customers or customer service representative, or combinations of them. The server, interaction applications, or other components of the interaction platform can respond to interaction channel management decisions by adding or enabling, removing or disabling, or configuring interaction channels, interaction applications, devices, or features that affect interface controls of user interfaces presented to customer service representative or customers.

Interaction channel management, including channel conversion from a synchronous interaction channel to a multimedia interaction channel, can be applied, for example, to messages that communicate information between the customer service representative and the customer, as well as to payment channels, payment methods, customer service systems operated by an enterprise, customer relationship management systems operated by an enterprise, and any other application or process that interfaces with customers or customer service representatives of an enterprise.

As mentioned earlier, in some implementations, the customer can be optionally offered, requested, encouraged, or required to use a particular interaction channel or combination of interaction channels. In some cases these options are determined automatically and presented automatically to the user at an entry step for an interaction channel or during an ongoing customer interaction. In some instances, the enterprise, for example, through a CSR, can determine which interaction channel or channels to present to the customer. In some examples, the customer can determine which options to impose on the enterprise. In some cases, the customer can use interactive controls of the user interface of the interaction application or browser to select which interaction channel or combination of interaction channels to use for a given message or customer interaction.

The interaction platform can include an interaction channel manager to implement the features required for interaction channel management as described above. The interaction channels controlled by the interaction channel manager can include asynchronous channels, quasi-synchronous channels, and asynchronous channels and can be carried on packet-based communication channels (such as the Internet or packet-based telephony) or on public switched telephone networks (such as land-line telephony or cellular telephony).

The interaction channels managed by the interaction channel manager can be applicable globally to all customer interactions between every enterprise and their customers, or between a given participant enterprise and its customers, or between a given participant enterprise and a given demographic group of its customers (for example, its customers located in the American Southwest) between a given participant enterprise and a particular customer. For example, the interaction manager can generate, update, and maintain a particular interaction channel for interactions between a clothing retailer and a particular male customer based on customer interactions that occur over time. Among other things, the interaction channel manager may be able to predict purchase decisions that will be made by the customer when the messages of a particular customer interaction with a CSR reach a certain stage.

Interaction channel management can include controlling features of an interaction channel presented through a user interface of a browser or interaction application running on a CSR's device or a customer's device, or both, so that tools and functions for one or more individual interaction channels or multimedia interactions are provided, removed, combined, or altered for use by the CSR or the customer. In some implementations, interaction channel management can include effecting, altering, controlling, or supplementing features and functions of message passing processes at a server of the interaction platform or at devices of the CSR or the customer, so that messages are packaged and communicated in forms that include appropriate features for the interaction channel mix in effect at a given time.

Message Packages

One or more messages sent between a customer and a customer service representative using the interaction platform can be sent in the form of a message package that incorporates content associated with one or more different interaction channels or multimedia interactions. For example, a message sent in accordance with a multimedia interaction can, in some cases, be sent in the form of a package including content expressed according to one or any combination of two or more of the following content types: text, recognized speech, video, voice, pictures, first party marketing communications, third party marketing communications, URL links, payments, or financial transactions, and others.

User Interfaces

The interaction platform is configured to provide through one or more interaction applications a wide variety of interaction user interfaces available to customers, CSRs, and others in connection with their use of the interaction platform and their sending of messages. The interaction user interfaces can be presented on a wide variety of personal devices of customers or workstations of CSRs or devices of other people. In some cases, the interaction platform can provide its features or functions through user interfaces of native applications running on devices. In some instances, the interaction platform provides its features or functions through user interfaces of interaction applications that are designed or provided by the host of the interaction platform or by one or more of the enterprise participants.

Examples of interaction user interfaces for CSRs and for customers are discussed later.

### CSR as Concierge.

The interaction platform can present features and functions to CSRs through user interfaces of interaction applications running on enterprise devices that enable the CSRs to provide “concierge” type services to customers of the enterprise.

Such concierge services can include a broad variety of assistance. The assistance can encompass one or a combination of conventional or unusual CSR services such as locating and providing information; answering questions; managing billing, payment, collection, or refunds with respect to transactions and products of the enterprise; managing returns, on-line banking, and financial transactions, replacements, and cancellations for orders of products of the enterprise; training; and others.

Using the interaction platform, a customer service representative can choose one or more selectable customer relationship channels for a customer interaction with a customer, for example, after any inbound messages received from the customer. The inbound message can use any of the interaction channels or combinations of (e.g., a multichannel communication). In serving the customer after the inbound message, the CSR can choose a single interaction channel or a combination of two or more interaction channels (e.g., a multichannel communication). In some implementations, the CSR can use an outbound interaction channel that is different from the inbound channel used by the customer. Or, if multichannel communication is used inbound, outbound, or both, the CSR can choose to send the outbound messages by a channel or channels that exactly match the inbound channel or channels, or overlap but not exactly with the inbound channel or channels or are completely non-overlapping. In some examples, the CSR can invoke features that offer, request, encourage, or require the customer to change the channel of inbound messages or to change the mix of multichannel interaction channels.

CSR User Interface

In some implementations, interaction user interfaces presented by the interaction platform to CSRs can have features and functions that we describe here, among others.

As shown in FIG. 2, in some implementations of an interaction user interface served by the server through the Internet to an interaction application at a CSR device of an enterprise, a CSR dashboard 110 enables a CSR to navigate and manage customer service tasks interactively. On the page shown in FIG. 2, the CSR can choose an interval for reporting of activity in drop down box 112. Based on the selected interval, the CSR is presented information about interaction conversion sources 114. As shown there are six different interaction channels for which interaction channel conversions are reported. These include OV app 116, which represents, for example, an interaction application provided by the host of the interaction platform and running on customer personal devices. Also shown as interaction channels from which interaction channel conversions to chat occurred are websites 118, social networks 120, IVR 122, email 124, and my app 126. Box 128 of the interaction user interface presents the average number of messages per conversation (e.g., customer interactions by chat). Box 130 presents a report of average customer satisfaction for the customer interactions involved. Box 132 reports the average time for the customer interactions by chat. The engagement box 134 reports the number of active offers 136 outstanding to customers (further discussion of offers appears below), the number of active marketing campaigns, and the offer claim rate 140 at which the offers included in the active campaigns were accepted. An activity pane 142 shows specific activities performed by the CSR. A panel 144 lists chat campaigns and a panel 146 presents popular offers available for use by the CSR.

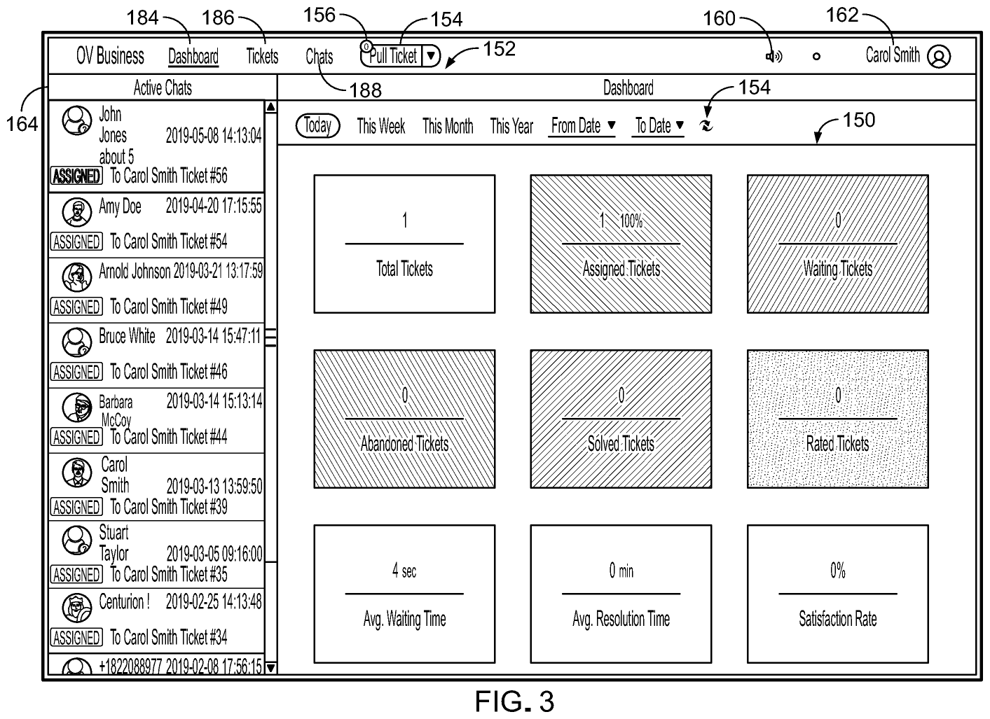

FIG. 3 shows an example of a ticket summary page of the interaction user interface of the CSR presented as part of the dashboard. When customers initiate customer service communications with the enterprise, each of the initiated communications is referred to as a ticket. Cards 150 arrayed on the page report total tickets, assigned tickets, waiting tickets, abandoned tickets, solved tickets, rated tickets, average waiting time, average resolution time, and satisfaction rating for tickets handled by the CSR during a selected time. Below a banner 152 and above the main panel 150 is a menu bar 154 that enables the CSR to change the period of time spanned by the information reported in the cards of the main panel. The CSR can choose to have data reported for this week, this month, this year, or to specify a date range, and to refresh the display.

The banner 152 at the top of the dashboard provides a control 154 that identifies the number 156 of unserved tickets. The CSR to whom the dashboard of FIG. 3 is presented may be one of many CSRs of the enterprise who are dealing with incoming customer service tickets at a given time. The number 156 of unserved tickets may be the total number of unserved tickets for the enterprise as a whole. When the CSR is able to work on a new ticket the CSR can click the user interface control 154 to “pull” an unserved ticket. The banner 152 also includes a speaker icon 160 indicating whether the speaker of the CSR device is active or not, and an identification of the CSR 162. At the left side of the page, a panel 164 provides a list of active chat sessions with customers. Each item in the list includes a name, date, time, CSR serving the customer, and a ticket number.

The banner 152 also includes a control 184 enabling the CSR to invoke the dashboard, a tickets control 186, enabling the CSR to go to the tickets page, ended chats control 188 enabling the CSR to proceed to the page in which the CSR can engage in chat sessions with customers.

The CSR dashboard of FIG. 3 is reached from the higher-level interaction user interface page of FIG. 2. On page 110 of FIG. 2, a banner 170 enables a CSR to invoke a chat support control 172 (including a number badge 174 that identifies the number of active chats related to tickets). The CSR can invoke control 172 to reach the CSR dashboard of FIG. 3. The banner 170 also includes a chat convert control 174, which enables the CSR to engage in an interaction channel conversion to chat, a discoverable offers control 176, which enables the CSR to review offers that can be made to customers in the CSRs customer loop (discussed later), a message my loop control 178, which enables the CSR to manage the sending of messages to customers in the CSR's customer loop, and a chat campaigns control 180, which enables the CSR to review and use available marketing campaigns in a chat interaction channel.

Customer Service Tickets

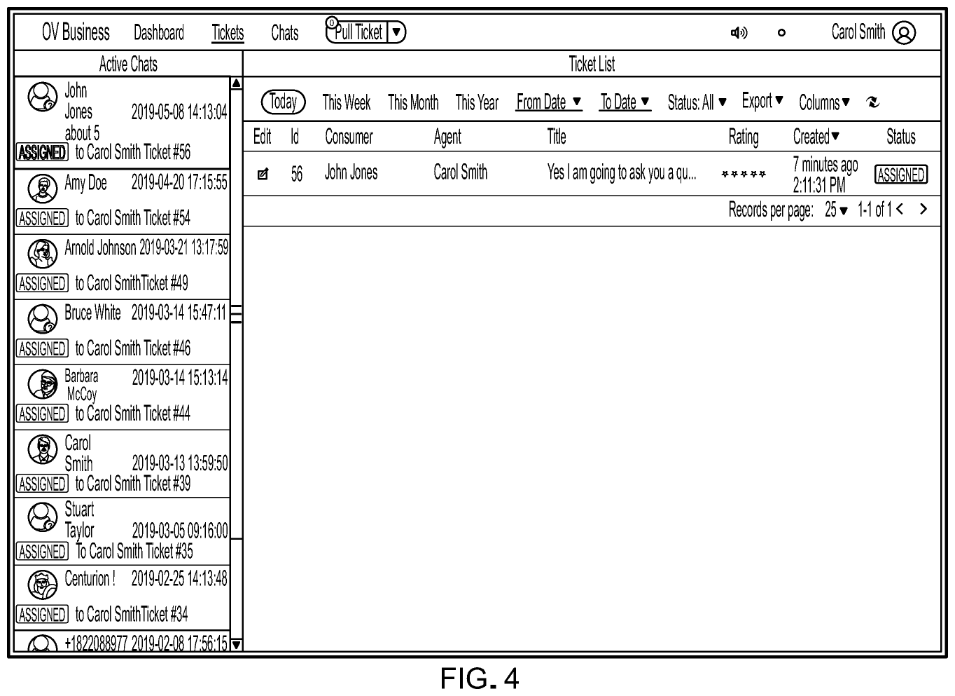

FIG. 4 illustrates an example of a tickets page that the CSR could reach by clicking on the tickets control 186 of FIG. 3. The tickets page includes a ticket list 190 having records 192 each of which summarizes the status of a current ticket, including the names of the customer and the CSR, a ticket ID, a rating, the creation time, and the assignment status.

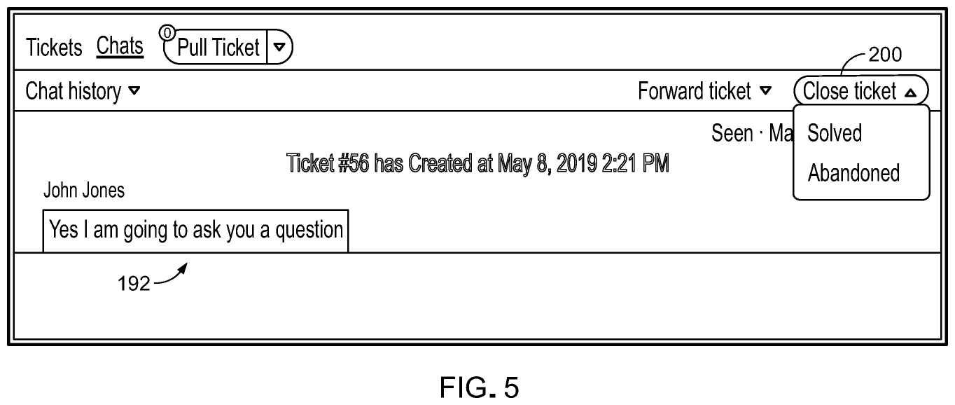

When the CSR invokes the chats control 188, the CSR is presented with a chat history 192 as shown in FIG. 5. The chat history includes a record for each active chat session for a ticket being handled by the CSR. The CSR can click on the close ticket control 200 to see a drop down menu enabling the CSR to identify the ticket as solved (meaning that the customer has been served satisfactorily) or as abandoned (indicating that the customer has stopped engaging in the chat session).

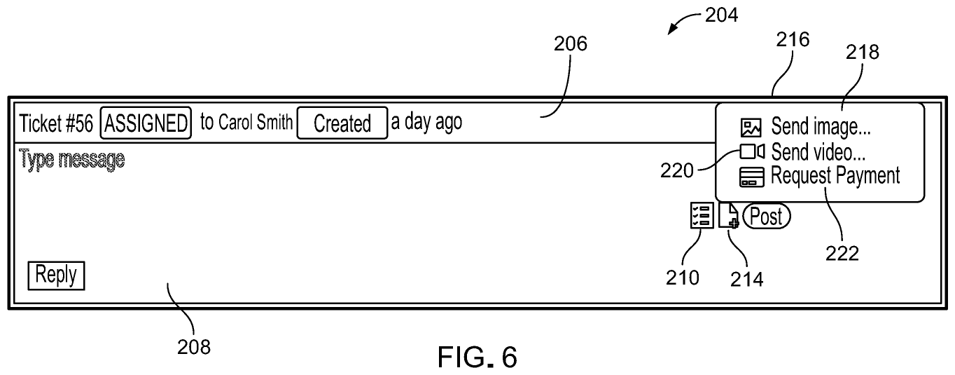

FIG. 6 illustrates an example of a chat session window 204 that enables the CSR to engage in one or more interaction channels for the purpose of creating and sending a message to a customer. A banner 206 provides information about the ticket including the number, the assignment status, the name of the CSR, and the age of the ticket. A text box 208 enables the CSR to type a message as part of the chat session with the customer. An icon 210 can be invoked to explore stored files that can be attached to the multimedia chat message. An icon 214 can be invoked to open a panel 216 offering the CSR opportunities to include in the multimedia message an image 218, a video 220, or a request for payment 222. In some implementations, other opportunities can be provided to the CSR to provide other concierge services, add other kinds of attachments, and perform other tasks in connection with the creation or sending of a chat message.

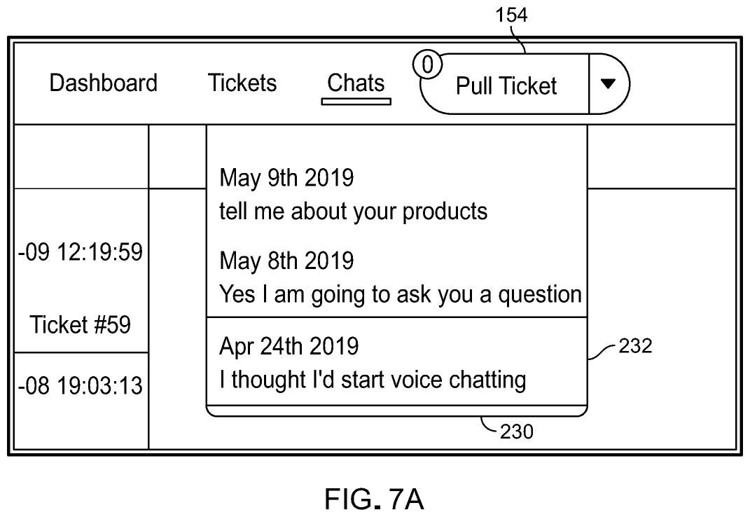

FIG. 7A shows an example of a drop-down menu 230 that appears when a CSR invokes the pull ticket control 154 by invoking one of the items in the drop-down menu, such as item 232. Then the CSR can view a selected ticket in detail. FIG. 7B shows inbound messages and outbound messages of a chat 250 corresponding to the ticket 252 which the CSR has selected in the active chats pane on the left side of the window. A pane 254 on the right side of the window reports customer information about the customer including a name, phone number, email address, date when the customer became active, identification of the personal device being used by the customer, the interaction channel source of the ticket, the version of the interaction application running on the customer's device, and the source from which the customer registered. The active message creation panel 256 at the bottom of the page corresponds to FIG. 6. The microphone button 258 enables the CSR to speak a voice message to be included in the message package that carries the multimedia message being created in the panel 256.

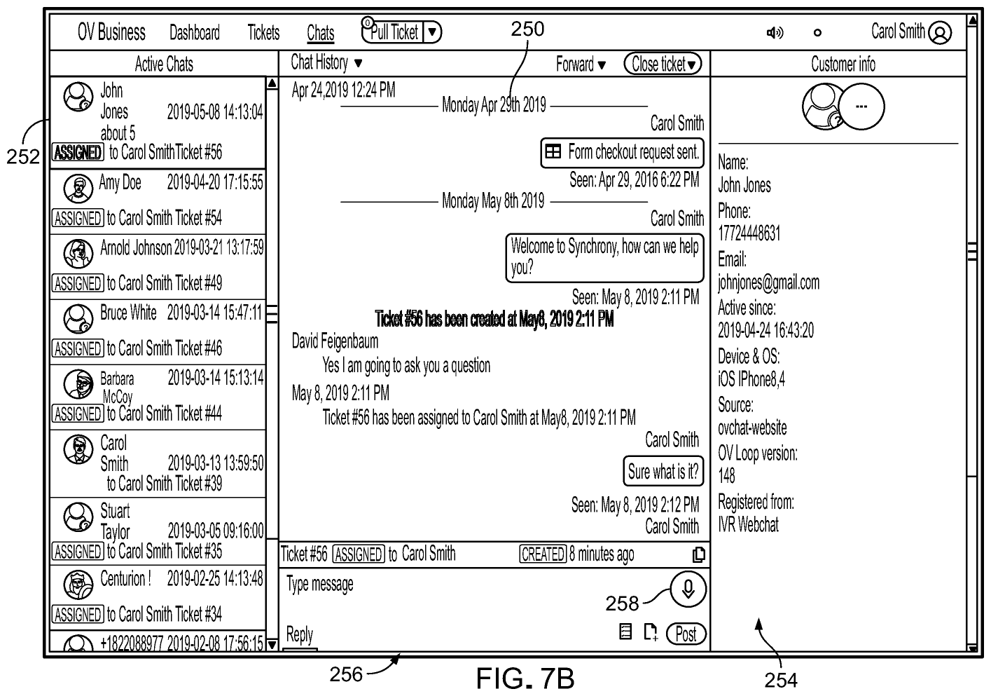

FIG. 8 illustrates another example of the CSR user interface in which the ticket panel 260 has been invoked. In this example, the pull ticket control is shown in a my ticket queue panel 262, and the customer information is shown in the customer information panel 264 on the left side of the page.

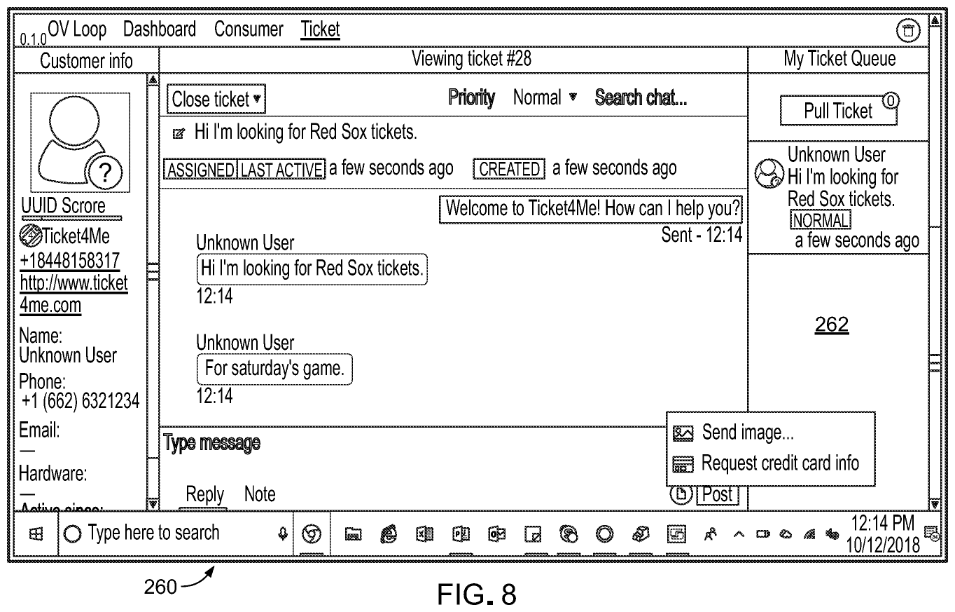

FIG. 9 shows a portion of the CSR user interface associated with a ticket created through an interaction application running on a customer personal device and presented by an enterprise called “Ticket4Me”. FIG. 9 illustrates a CSR concierge service in which a customer may be seeking to buy tickets, in this case to a Red Sox baseball game. The CSR user interface displays information 266 enabling the CSR to interact with a Fenway Park application in which tickets for seats can be located and ordered.

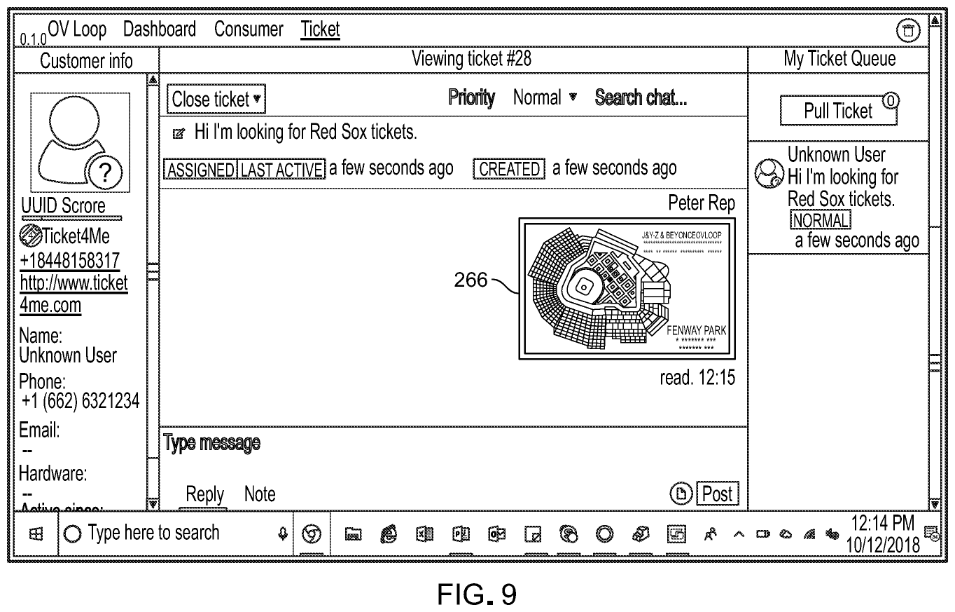

FIGS. 10 through 13 show features and functions of the CSR's user interface of the interaction application running on the workstation of the CSR that enable the CSR to create parts of multimedia messages using various multimedia interaction channels.

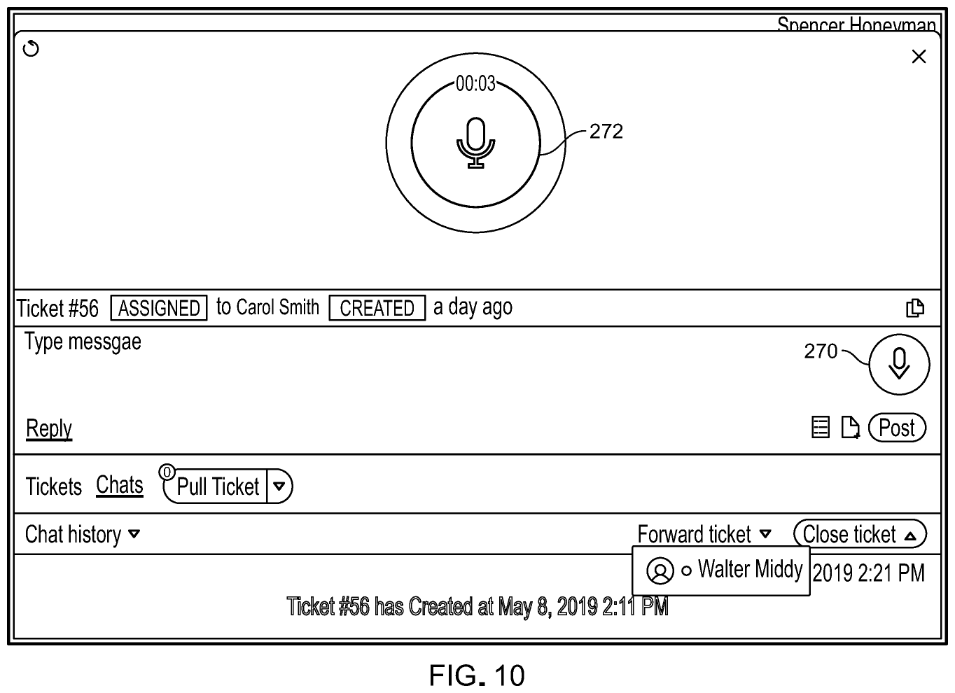

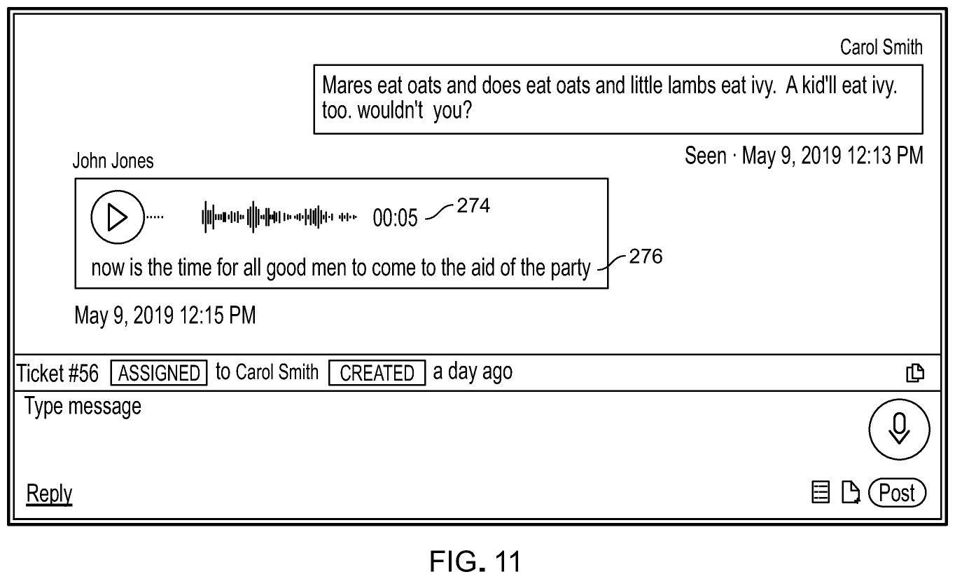

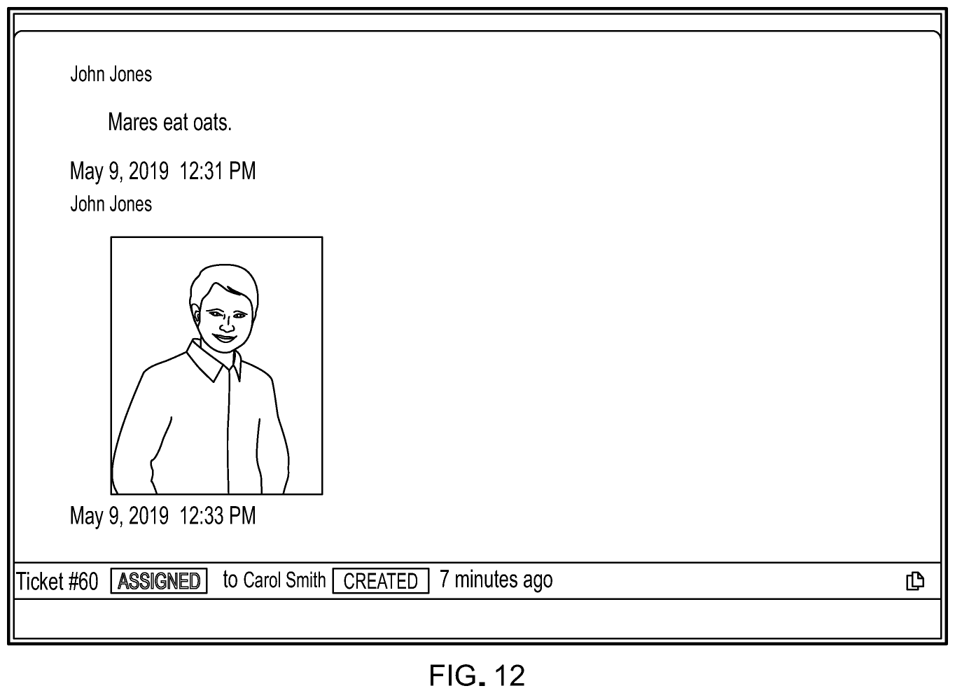

As shown in FIG. 10, when the CSR invokes the microphone 270, a recording icon 272 appears confirming to the CSR the what is being spoken is being recorded for use with the outbound message. FIG. 11 illustrates that when the recording has been completed and the multi-media message including a recording 274 and typed text 276 has been sent (e.g., as a package), the user interface provides, in the presentation of the outbound message, an opportunity 274 for the CSR to observe a graphical summary of the voiced message and to play the voiced message. Similarly, FIG. 12 shows how a selected image appears in the chat session sequence in the CSR's user interface. And FIG. 13 illustrates how a video captured and included in the outbound message appears in the CSR's user interface as part of the chat session. Controls are provided to enable the CSR to play video and show it “full-screen”.

Customer Loop

One objective of the interaction platform is to enhance the duration, quality, depth, and intensity of customer relationships that the enterprise has with customers in order to, for example, improve the reputation of the enterprise, increase sales or distribution or use of its products, and develop a larger body of satisfied customers. One purpose of the CSR user interface is to provide tools and features to enable the CSR to engage in the process of enhancing the customer relationships.

In some implementations, the customers involved in particular customer relationships can be associated with an enterprise or with particular CSRs of the enterprise in what is sometimes called a “loop” or “a customer loop” or “loops”. The enterprise, through its presentation and implementation of features and functions available through the interaction platform, encourages CSRs to understand and develop their loops with particular customers for the benefit of the enterprise. In some implementations, the CSR can refer to its activities with such customers as “My Loop”. Growing a CSR's loop can include increasing the number of particular customers with whom the CSR engages in customer interactions over a period of time (short or long) and also can include engaging in a greater number and a greater variety of customer interactions with those customers, for example, through activities that we have called concierge services.

When a customer and an enterprise engage in a conventional customer interaction, the messages or other communications tend to be simple, unenhanced questions or answers which the customer may not perceive as contributing to a customer relationship that is strong, effective, or durable. In other words, these interactions may not create an effective two-way, reliable, engaging relationship loop between the customer and the enterprise. Features of the interaction platform are designed to enable the enterprise, for example through its CSRs, to establish, improve, and maintain relationship loops with particular customers that are rich, deep, and long-lasting. These relationship loops strengthen the enterprise's overall body of customer relationships. For example, as noted earlier, the interaction platform enables the CSR to operate as a concierge for customers in the CSR's loop and to apply channel conversion to customer interactions without regard to the entry step by which the customer reached the CSR. In some implementations, the interaction platform itself can automatically, or with the help of a CSR, engage in channel management, channel conversion, and concierge-type servicing of customers.

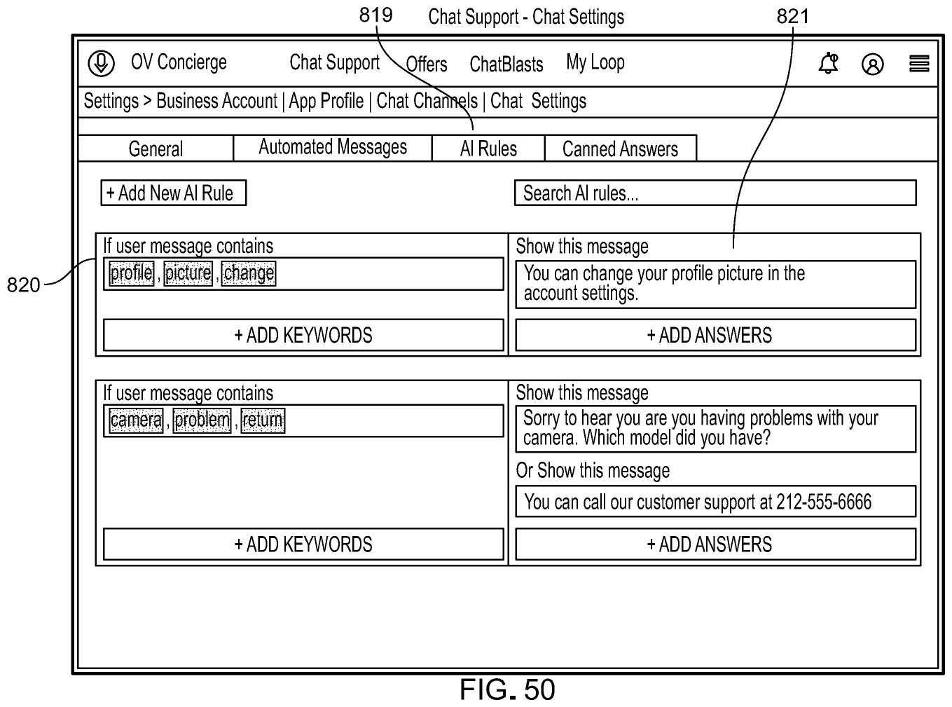

As shown in FIG. 51, in some implementations, in addition to the controls already discussed, the user can invoke a control called “My Loop” 301 to cause the display of information about the CSRs loop.

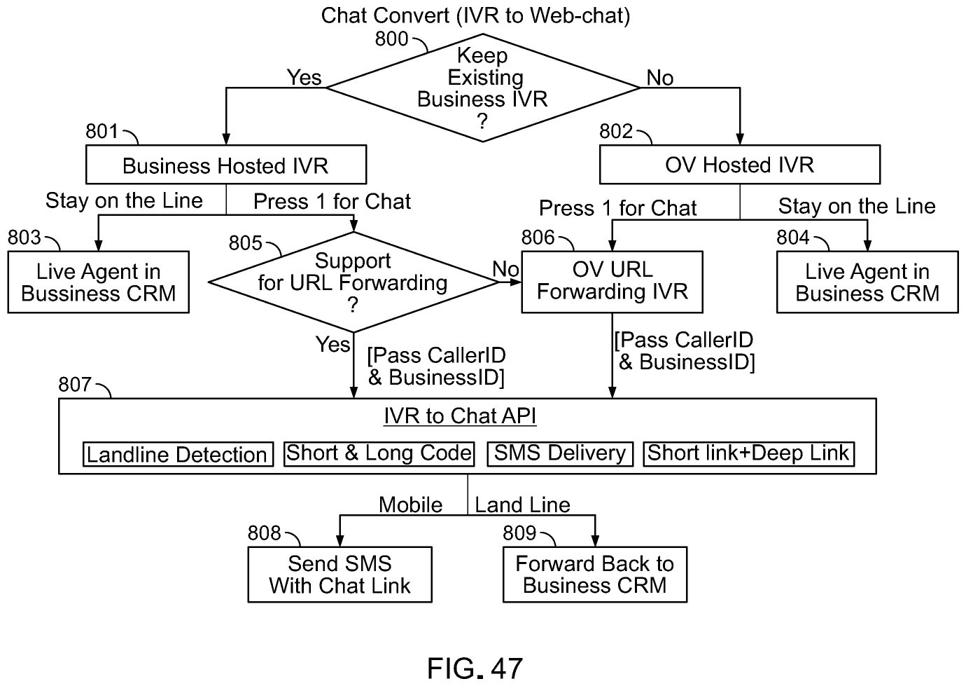

FIG. 48 illustrates a screen image shown on a mobile device. The “My Loop” control 810 is seen activated in this view. That control can be toggled on or off at will by the customer. The control 810 effects what type of content is allowed to be posted by the CSR or marketing system into the thread to the consumer. While the control is “on”, the business may post marketing content such as promotions or offers 811 as displayed in the figure. When the control 810 is turned off, it puts a block in the interaction platform that monitors and blocks certain types of contents.

As shown in FIG. 51, in some implementations, the CSR can manage and navigate the records corresponding to customers that belong to her loop. For each customer, a row 5120 is displayed in a table 5122 and shows the first name, last name, phone number, email, data added, and other information. The CSR can search the customers using the search box 5124 and can add, edit, delete, and bulk upload the customers using corresponding controls.

Marketing

One aspect of a CSR's activities with respect to the CSR's customer loop is the development and implementation of marketing, publicity, advertising, and similar efforts to engage with the customers, enhance their view of the enterprise, and increase their engagement in transactions with the enterprise. Typically, such activities are performed largely by other employees and agents of an enterprise who are engaged particularly in marketing efforts that may result in messages sent through various interaction channels to customers of the enterprise. In the interaction platform that we describe here, one or more CSRs themselves participate in or fully control the development of some or all of the electronic marketing activities of an enterprise that use one or more of the interaction channels available to the enterprise. Enabling the CSRs to perform these tasks can reduce the cost, time, delay, and complexity of particular marketing activities or of an entire marketing campaign or a complete marketing program of an enterprise. Particularly in the case of small enterprises, these aspects of the CSR work can be especially effective.

Create New Offer

In some implementations, electronic marketing activities can include offers made by an enterprise to customers. The interaction platform enables a CSR to develop and deploy offers as part of multimedia customer interactions in a way that is immediate, engaging, and in some cases more effective than offers provided independently of CSR customer interactions.

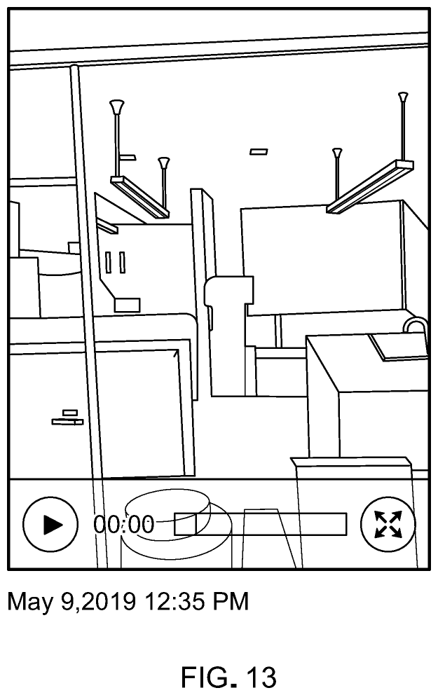

As shown in FIG. 14, the CSR user interface can provide an offers control 300 which, when invoked by the CSR, causes presentation of an offers panel 302. The offers panel includes a “Create New Offer” control 304 (which enables the CSR to create a new offer) and a “Search Offers” control 306 (which enables the CSR to hunt for existing offers). The offers panel 302 also lists offers 308 that are in the process of being created (drafts) and offers that are live and available to be used. Details about each offer are shown in a row of the panel, including an image to be presented in a multimedia customer interaction to customers in connection with making the offer, an offer title, a text of the offer, an expiration date, and publish settings (by which the CSR can control whether a given offer is in the draft state or published (available for use)).

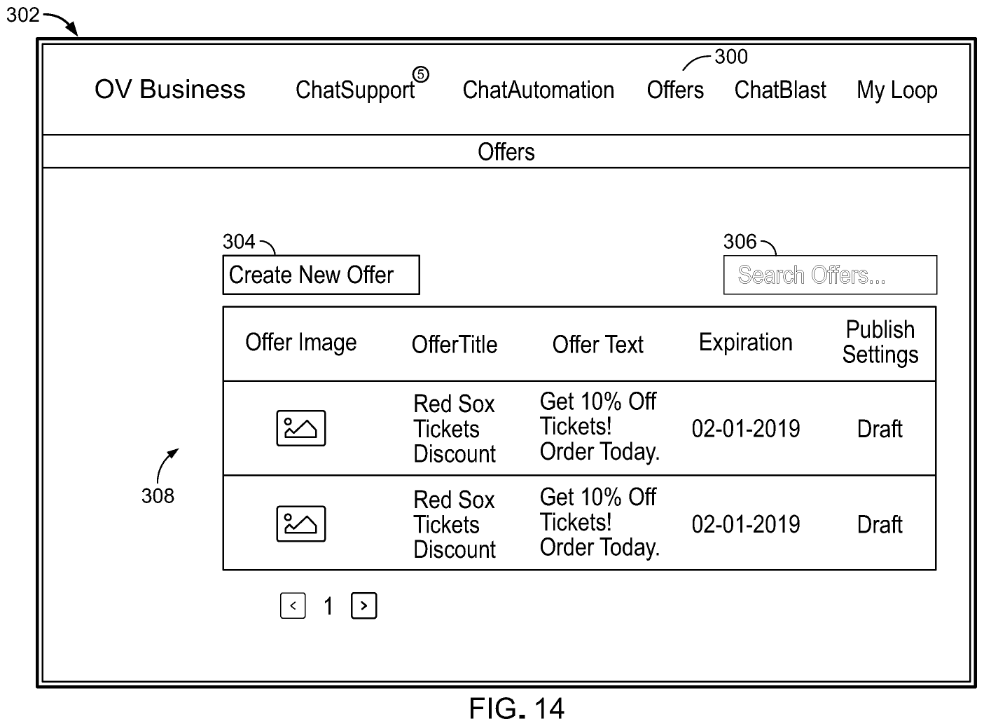

When the CSR invokes the create new offer control 306, she is presented with the window 312 shown in FIG. 15. The window 312 provides a three-step wizard of which the first step is shown in FIG. 15. This step provides image and text boxes 314, 316, 318, 320, and 322 that enable the CSR to provide an offer image, an offer title, an offer text description, an expiration date, and offer restrictions, terms, or legal compliance text. As the CSR creates the offer, a mockup 324 of the offer as it would appear on a display of a customer mobile phone or other personal device is presented. As shown in mockup 324 and as explained later, a customer participant can run the interactive application on the customer's mobile personal device and can invoke icons to engage in a chat with the enterprise 326, review offers 328, and manage a customer wallet 330.

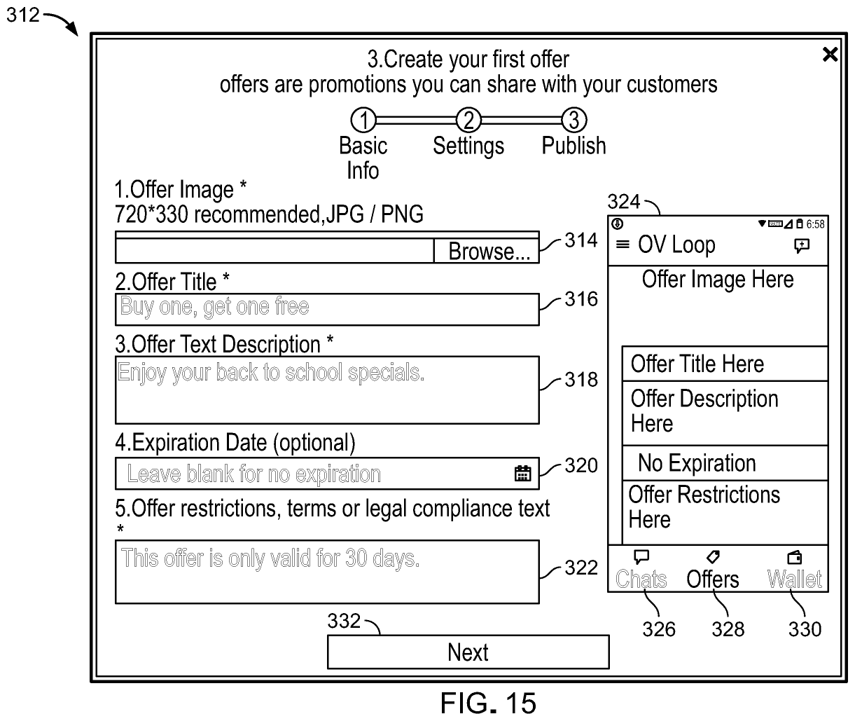

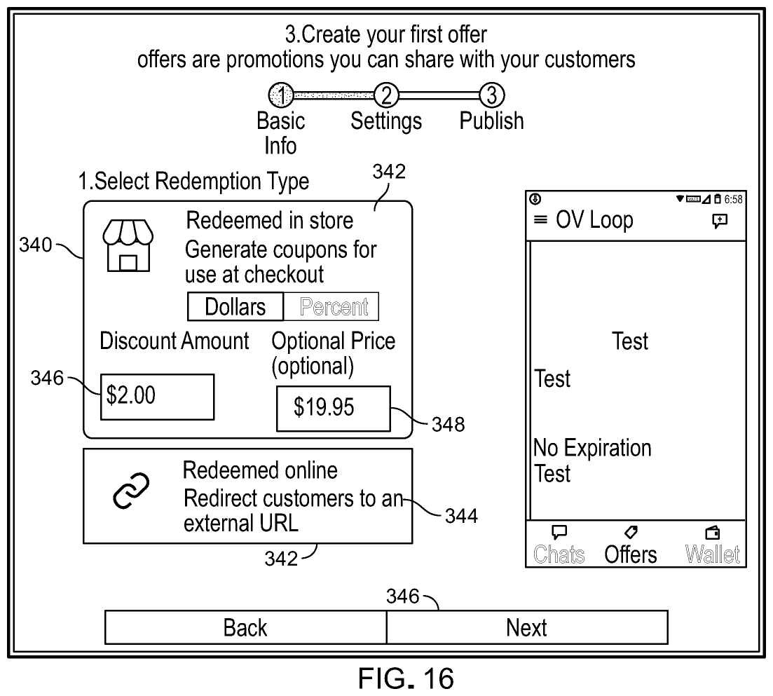

When the CSR finishes step one of the wizard and clicks the next button 332, she is presented with the second step of the wizard shown in FIG. 16. The second step enables the CSR to control settings for the offer being created, for example, including selecting a redemption type 340, either redemption at a store using coupons or online redemption 342 through an external URL 344, where the CSR can enter the external URL in a text box. When the redemption is to be in a store, the CSR is given the ability to enter a discount amount 346 in dollars and cents or percentage and can also enter the original price 348. By invoking the “Next” control 346, the CSR can work in the third step of the wizard, shown in FIG. 17. In this third step, the user can specify publication parameters by clicking on one of the four controls 348, 350, 352, 354. Control 348 saves the offer as a draft that is not available to customers in the CSR's loop. Control 350 saves the offer for use in particular customer interactions, for example, so-called chat blasts with particular customers with whom the CSR chooses to share the offer. Control 352 configures the offer to be available to any customer of the enterprise who is part of the CSR's loop. Control 354 configures the offer to be available to all customer participants associated with the enterprise whether or not they belong to this CSR's loop.

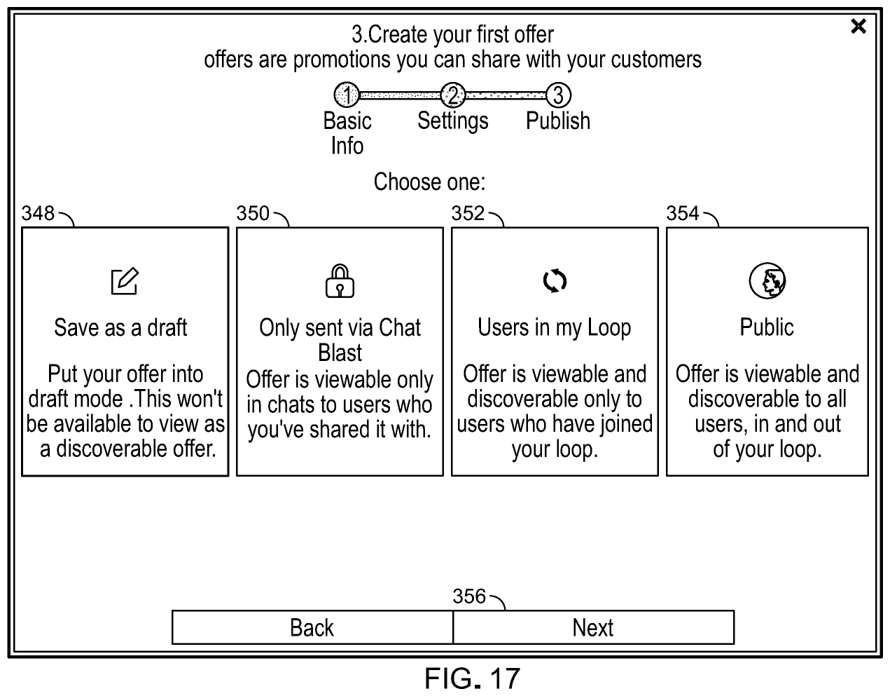

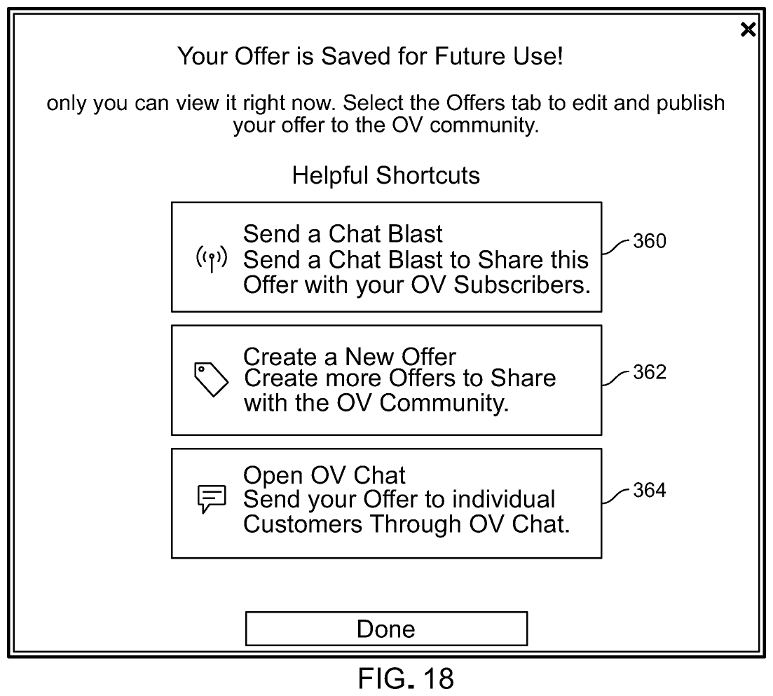

When the CSR invokes the “Save” control 356, she is presented the shortcut options 360, 362, 364 shown in FIG. 18. The “create a new offer” control 362 returns the user to the display of FIG. 17. When the CSR invokes the “send a chat blast” control 360, the CSR is presented the screen shown in FIG. 19.

In the screen of FIG. 19, the CSR can create a template for a chat message to be blasted (sent uniformly and without further action by the CSR) to customers or groups of customers of the enterprise who are in the CSR's loop. The CSR can enter the text of a chat blast name in box 370 and the text of the chat message in the chat text box 372. Then the CSR can invoke one of four controls 374, 376, 378, 380 to designate the attachment of content to the chat message to be blasted. When the CSR invokes control 374, she indicates that the chat message should be sent to targets of the chat blast without any attachment. Invoking control 376 opens a drop-down menu in which the CSR can select an existing offer to be attached to the chat message to be blasted. Control 378 triggers a browsing box for selecting an image to be attached to the chat message. Control 380 triggers a text box for entering a URL to be added to the chat message.

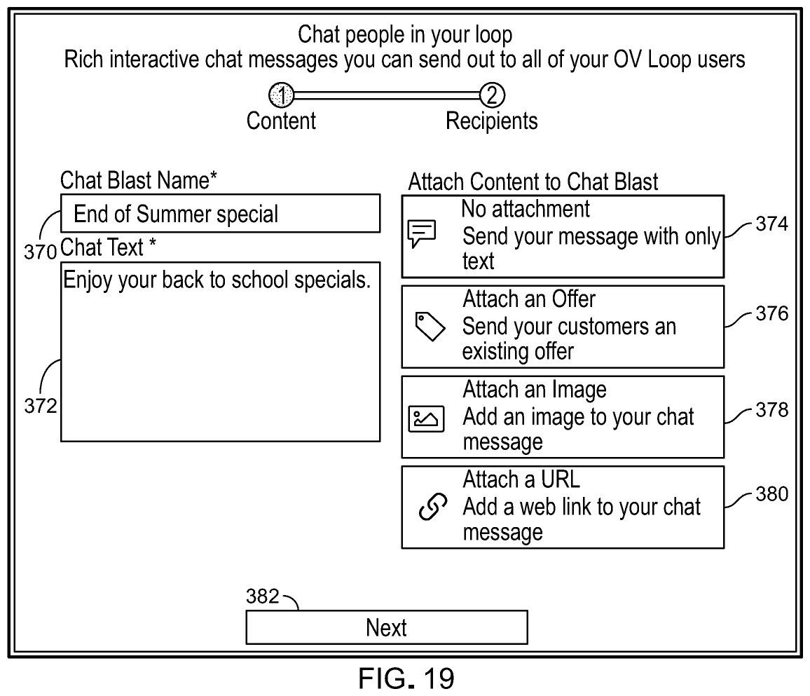

When the CSR invokes the “next” control 382, she is presented the screen shown in FIG. 20 enabling the CSR to invoke one of four controls 384, 386, 388, or 390 to specify the customers in her loop to whom the chat message should be sent. Control 384 will cause the chat message to be sent to all of the customers in her loop. Control 386 enables the CSR to have the chat message sent to a mobile device of any customer of the enterprise who comes within 500 yards of the retail location of the enterprise, for example. Other parameters for triggering the sending of the chat message are also possible. This enables the CSR to provide offers and chat messages suitable for customers who may be susceptible to the suggestion that they patronize brick-and-mortar facilities of the enterprise. Control 388 enables the CSR to specify demo-graphic or other filtering criteria to filter the body of all customers who belong to the CSR's loop to focus on particular groups or types of customers. Control 390 enables the CSR to select specific customers in her loop who are to receive the chat message.

Customer Relationship Enhancers

As illustrated in the figures and description above, the CSR user interface provides customer relationship enhancers (such as the offers that can be created and deployed) that the interaction platform makes available to CSRs for use in building customer relationships with the customers in the CSRs' loops. The offers discussed above are examples of features that enable CSRs to define and distribute through multimedia chat interaction channels or other interaction channels, marketing communications to incentivize behavior by the customers. They illustrate the use of templated chat messages that enhance the customer relationships and the capability of managing the constituent customers that are part of the CSR loops.

These example customer relationship enhancers represent only a small part of a wide variety of possible customer relationship enhancers that can be made available for CSRs to use in customer relationship building. In a sense, as implied earlier, the interaction platform enables a CSR to act as a concierge for the benefit of customer participants of the interaction platform on behalf of an enterprise. The customer relationship enhancers represent tools that can be applied by the CSR as the concierge to improve the experience of the customer in interacting with the enterprise.

The categories of possible customer relationship enhancers include: service providing tools; customer training tools; billing, payment, collection, or refunding tools; information providing tools; tools to manage returns, replacements, and cancellations; feedback tools to receive comments, praise, or criticism about products of the enterprise; and question answering tools.

Each of the customer relationship enhancers can be exposed to the CSR through user interface controls that enable the CSR to define the terms of and configure the enhancers, get access to enhancers from third party providers, and provide features of the enhancers to customers through customer interactions using a variety of different communication channels.

In some examples, the enhancers can be presented by the host of the interaction platform, a particular enterprise, or third-party participants. The enhancers can be presented through the CSR user interface, can be invoked by the CSR, and can be exposed to the customer as determined by the CSR. The exposure to the customer can be through one or more interaction channels.

For example, a bank that is a third-party participant in the platform could offer loan services to make loans to customers of a chain of furniture stores. The terms of the offers of the loan services could be subject to change over time, in different markets, and for different customers. The loan service customer relationship enhancers could be exposed to a CSR on a page of the platform user interface enabling the CSR to select the terms and in other ways to configure offers of loans to customers for buying furniture marketed by the enterprise. In some cases, the CSR could offer loans corresponding to the bank's loan service to customers in the CSR's loop by embedding the offers directly in chat messages or other communication channels. A wide variety of other examples are also possible.

Business Profile

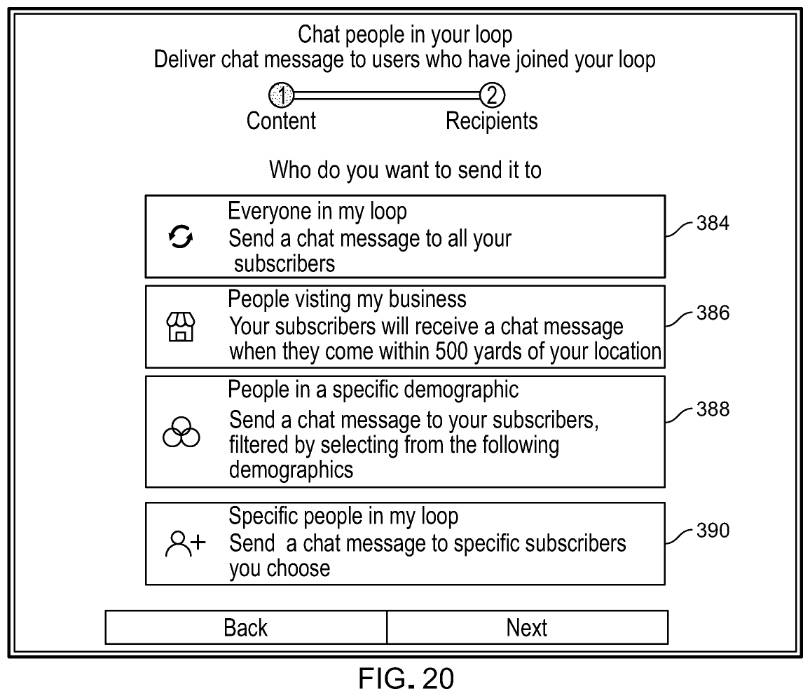

Each CSR is associated with an enterprise, called a business in FIG. 21. FIG. 21 presents information about the enterprise for which the CSR's loop is being maintained. FIG. 21 enables a CSR (or a manager or owner or other representative of an enterprise) to design the display 400 that will be presented to a customer on the mobile device by the interaction application when the customer uses the interaction application on the mobile device.

In the implementations illustrated in FIG. 21, the CSR can provide a logo in a box 402, navigate to find and enter an enterprise home banner in a box 404, and can enter text describing the enterprise in a text box 406. The CSR can also enter enterprise information in boxes of the panel 408. The platform generates the display 400 based on the entered information and uses the generated display to configure the interaction application running on the customer's device. In effect, the display 400 presents a private-labeled user interface for a corresponding enterprise based on information provided by the CSR.

The screen shown in FIG. 21 is displayed when the CSR invokes a control titled “business profile” 410. Also invocable is a “manage users” control 412 which causes the presentation of user interface features enabling the creation, deletion, editing, and other management of accounts and profiles for CSRs and other users of the interaction platform on behalf of the enterprise.

Automated CSR Guidance

In the course of customer interactions between CSRs and customers of an enterprise, patterns occur naturally in the back-and-forth of inbound messages sent by customers to the CSRs, outbound messages sent by CSRs to customers, and in the effectiveness of the handling of the customer interactions that result from the patterns. For example, the patterns of messages may indicate that when the CSR asks early in the customer interaction about the frequency of a problem the customer is having with a product the problems tend to be resolved better and faster than if that question is asked late in the customer interaction.

A wide variety of parameters of the customer interactions and patterns of them can be indicative of more effective and less effective approaches to the customer interaction. These parameters could include the length of each message, the number of messages passed back and forth before resolution of the issue, the tone of each message, the changes in tone of the messages, the presence of certain words, phrases, concepts, and combinations of them in each message and in combinations of the messages, the time of day, season of the year, location of the customer, proximity of the customer and the CSR, the interaction channel being used, whether channel conversion had occurred, the outcomes of the interactions, and others, and combinations of these parameters. All interaction parameters associated with every customer interaction (interaction records) occurring under the interaction platform can be stored in the database at the server, for example, for later analysis and other uses.

The interaction platform can include an interaction analyzer configured to automatically or with human help review and analyze the interaction records to identify interaction parameters and combinations of them (e.g., extract features) that tend to affect the quality of the interaction outcomes of the customer interactions. Among other things, the interaction analyzer can generate, update, and maintain one or more interaction models (also stored in the database at the server) using machine learning techniques that represent and predict aspects of customer interactions. When a current customer interaction occurs, the current parameters for the customer interaction that are accumulated as the interaction progresses can be applied to one or more of the interaction models to predict an interaction outcome of the customer interaction or content of messages that could be sent by the CSR to achieve a higher likelihood of the successful interaction outcome. Once these parameters have been identified, the interaction analyzer can provide information through user interfaces to the CSR or two a customer or both designed to improve the quality of the interaction outcomes of the current and future customer interactions.

For example, the interaction analyzer may identify a particularly useful phrase or sentence for inclusion in a message from the CSR at a particular point in customer interaction. The interaction analyzer can present such a phrase or sentence through the CSR user interface in a manner that permits the CSR either to click to include the phrase or sentence in a message or to incorporate portions of the phrase or sentence in the message being composed by the CSR. In some implementations, it may be possible for the interaction analyzer to observe the sequence of current messages in a customer interaction, apply them to one or more of the machine learning channels, and automatically generate messages to be sent to customers or other actions to be taken in the course of customer interactions. For example, the interaction analyzer may determine that a customer interaction has reached a point at which a highly likely way to achieve a successful outcome is simply to offer the customer a rebate on a purchase price. The interaction analyzer can automatically send a message making such an offer.

### The User Interface of the Interaction Application Presented to the Customer

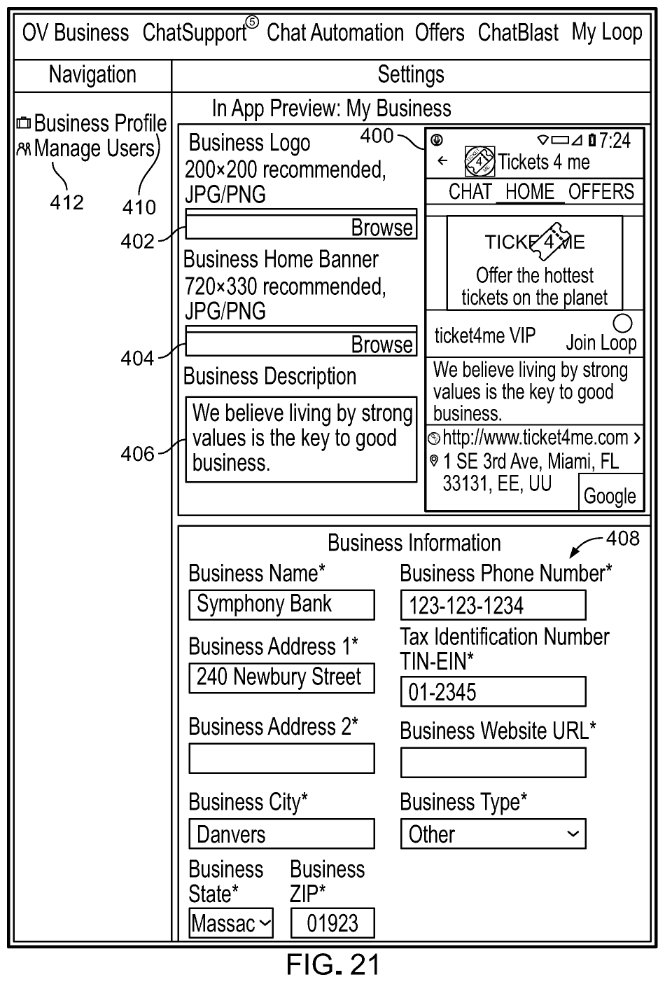

In some implementations as shown in FIGS. 22 through 37 the interaction platform can provide private labeled multimedia customer interactions beginning with, for example, a voice call initiated through the cellular telephone network from a customer's mobile telephone or other mobile device. In this example, the multimedia communication experience is presented on behalf of one of the participant enterprises, in this case the hypothetical bank “Symphony Financial”. In some implementations, the customer entry point could be a cellular telephone call made to a toll-free number provided by either the platform host or the participant enterprise.

As shown in FIG. 22, when the customer places a call to the toll-free number, in some cases a customer interaction system (such as in IVR system) of the participant enterprise answers the call and, using recorded or synthesized speech, tells 420 the customer that she can sidestep the usual IVR menu hierarchy and engage immediately in a chat session (e.g., a multimedia asynchronous chat session) with a representative of the participant enterprise by, for example, pressing key “1” and waiting for a text message containing a link to be invoked by the customer to initiate the chat session. Or, the customer could be invited to press key “2” to wait to speak with a representative in a live synchronous voice call.

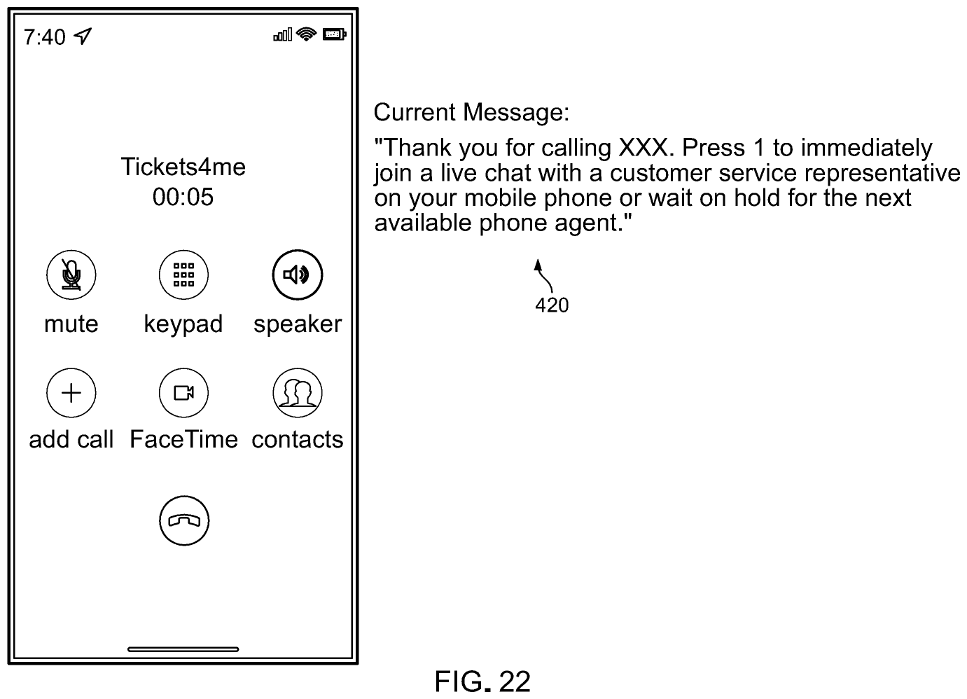

If the customer presses key “1”, she will receive a text message 422 as shown in FIG. 23 inviting her to click a presented link 424 to initiate the chat session with the customer service group of the participant enterprise. The chat session invitation refers to the chat session as “VoiceChat” with reference to the multimedia communication of the kind described in United States patent application publication 2018/0359349, which is incorporated here by reference in its entirety.

If the customer clicks the link, the interaction platform (e.g., the server) serves an interactive multimedia asynchronous chat (e.g., VoiceChat) session to the mobile device of the customer. The customer is one party in the VoiceChat session, and a CSR of the participant enterprise is the other party.

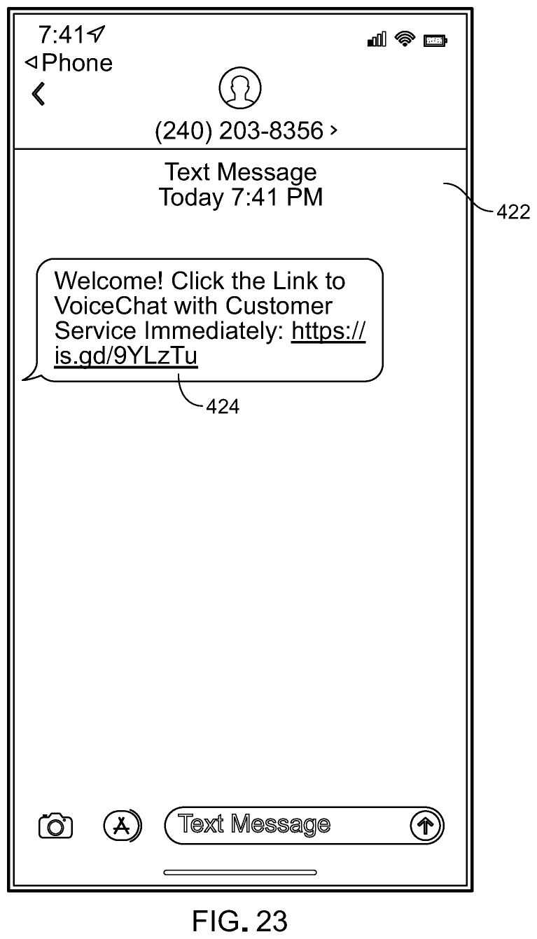

As shown in FIG. 24, at the top of the chat session 426 appears the logo 428 and brand name 430 of the participant enterprise (e.g., the “private-label”) and a notation 432 referring to the fact that the multimedia asynchronous chat session is being hosted and served by the host of the interactive platform (in this case OV Loop). An initial welcoming VoiceChat message 434 in text form is automatically presented as the first message from the CSR of the participant enterprise. The message invites the customer to respond.

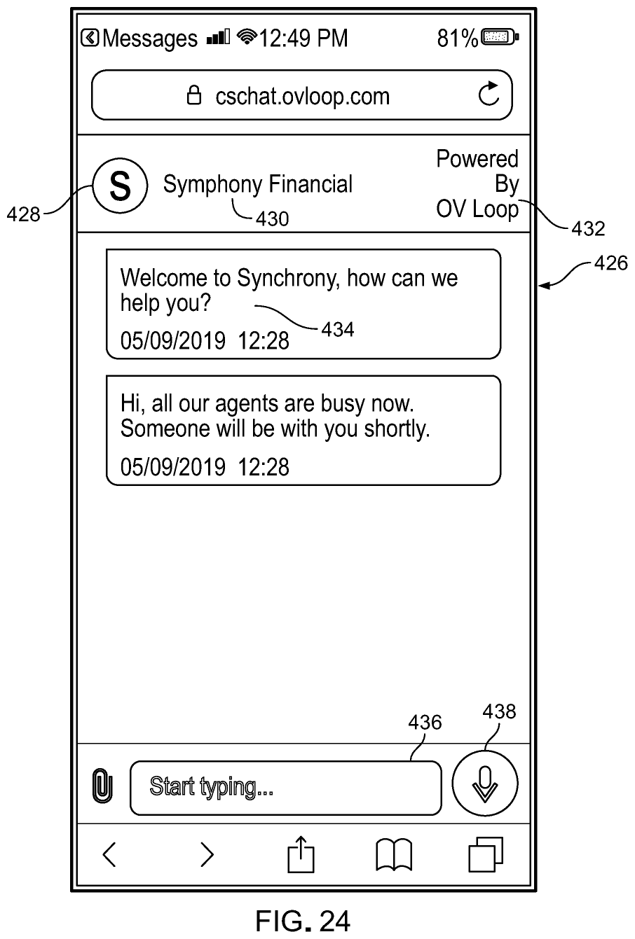

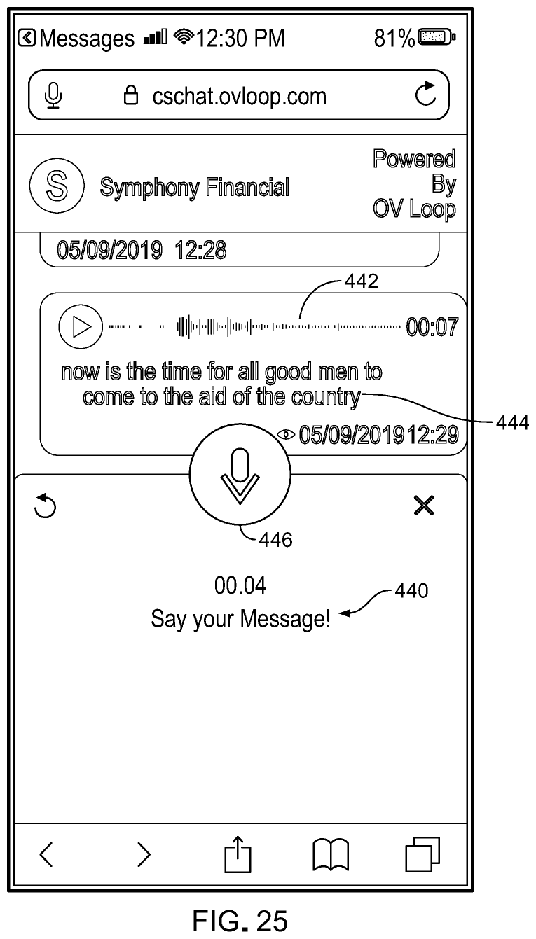

The response by the customer can be created using one or a combination of two or more interaction channels. In a traditional interaction channel, the customer types text in the chat session text box 436 and invokes the appropriate key to cause the typed message to be sent to the enterprise. In another interaction channel, for example the spoken channel, the customer can invoke the microphone button 438. Doing so causes the screen shown in FIG. 25 to be presented in which the customer is invited 440 to speak her message orally. As she speaks, her voice is recorded and the speech is transcribed. A graph 442 representing the sound recording, and the transcribed speech 444 are presented. When the customer is finished speaking the message, she clicks the microphone button 446 which causes the message to be sent and the chat session display to be updated as shown in FIG. 26, including a message panel 448 that includes the representation of the sound recording and the recognized text of the speech. An alternative way that a customer could finish and send a spoken message may be for the software to recognize a longer or abnormal pause in the cadence of the customer's spoken message and to automatically finish and send the message instead of clicking the microphone button 446.

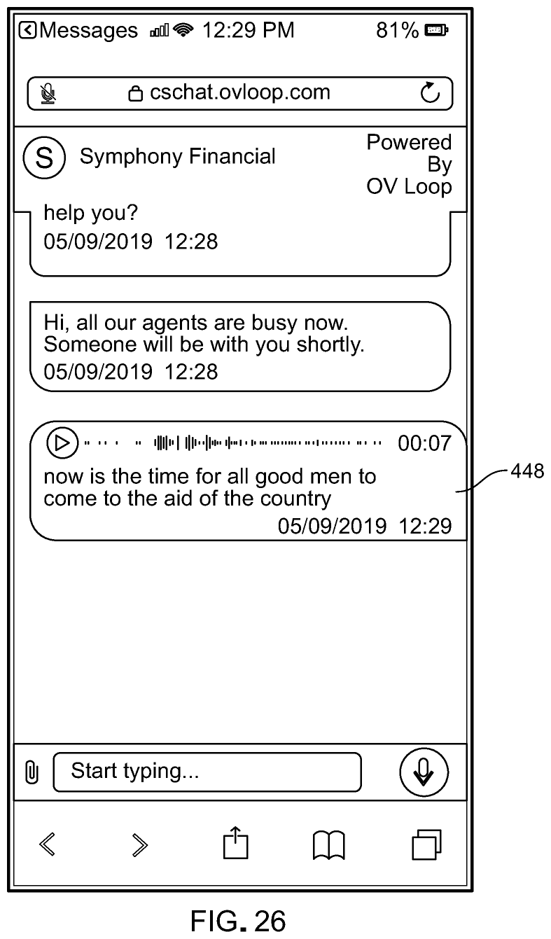

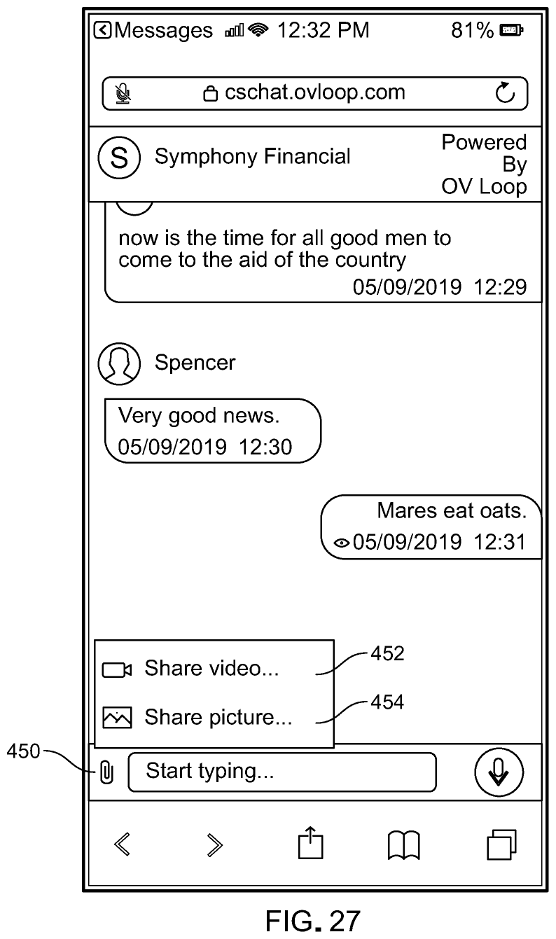

The customer then can either wait for an outbound message from the CSR or enter another inbound chat message. The customer also can invoke the attachment button 326 to locate an item of content to be attached to a message. Also as part of creating a multimedia message for delivery to the CSR, the customer can, as shown in FIG. 27, invoke the attachment button 450 which provides the opportunity to “share” a video 452 or a picture 454 by searching for or creating relevant video or image files on the mobile device. As shown in FIG. 28, for example, the customer could locate a picture 456 on her mobile phone and then send it as a message 458 with or without text and with or without a spoken message.

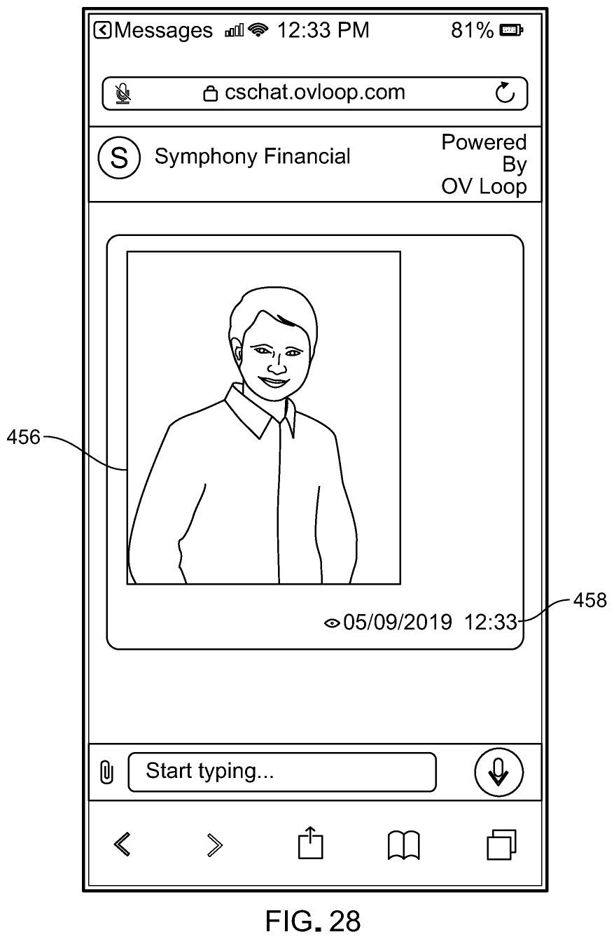

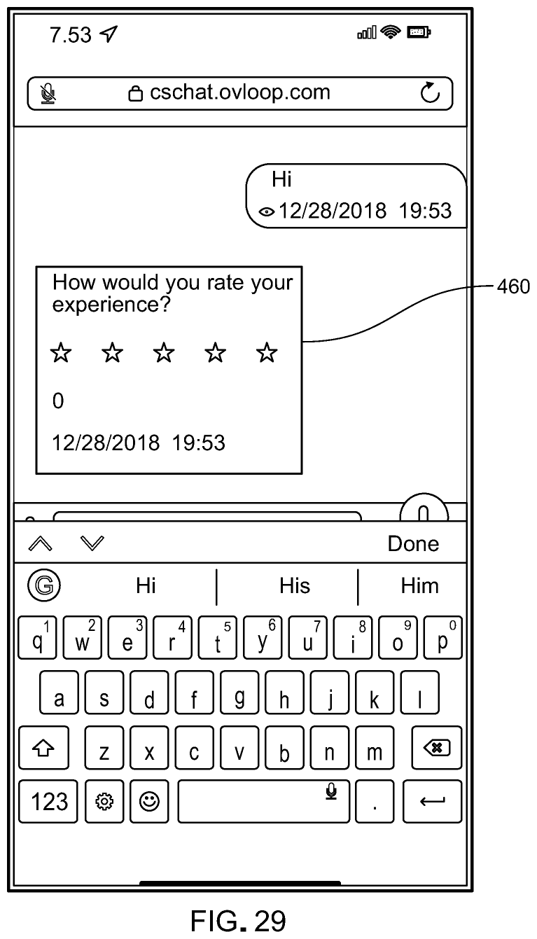

At the end of the chat session with the CSR, the interaction application can automatically present a feedback box 460 in the chat session window is shown in FIG. 29 and can acknowledge the ranking provided by the customer in and outbound message 462 as shown in FIG. 30.

As used herein the term “client software” refers, for example, to software that is running on the customer's device or is specific to the customer's device and is independent of the CSR software. The device may be a laptop, mobile device, or other computing device, and the software may include a graphical user interface that displays user interfaces to provide user experiences such as the ones illustrated and described in other parts of this document, for example, in FIGS. 24, 25, and 26. The software may also include the ability to interact with the device peripherals such as the microphone or speakers of the device.

As used herein the term “hands-free command software” refers, for example, to client device software that includes or in some implementations is limited to user interaction features and functions that are effected by the user by oral or spoken control or interaction. For example the client software may operate through the microphone or speakers or both of the customer device or through accessory microphones, head phones, or speakers of combinations of them to implement, for example, oral or spoken command interaction features for the customer. Among other things, the client device software could be configured to receive, process, and interpret the oral or spoken commands and to act accordingly as if, for example, the customer were interacting with physical or graphical user interfaces. Among the advantages of such features is that the client device software can enable the customer to interact exclusively through oral or spoken communication to respond and listen to an asynchronous interaction with a CSR. In some cases, the ability to interact by delivering oral or spoken communication and by listening to oral or spoken content need not be the sole means of interaction and can be combined at different times or at the same time with hands on interaction features.

As used herein the term “hands-free mode” refers, for example, to a method of interacting using oral or spoken messages from within an asynchronous interaction channel. Hands-free mode allows making commands available to the customer during an interaction enabling the customer to respond to messages from a CSR or enterprise in part or exclusively through oral or spoken communication, and without physically touching or interacting with the customer device, mobile application, or web chat application that is hosting the interaction channel. The commands can be made available to the customer through hands-free command software that is part of or enabled by client software.

The ability of a customer to interact with the CSR asynchronously using spoken messages may be further exploited by using a more convenient mode of enabling hands-free oral asynchronous interaction.

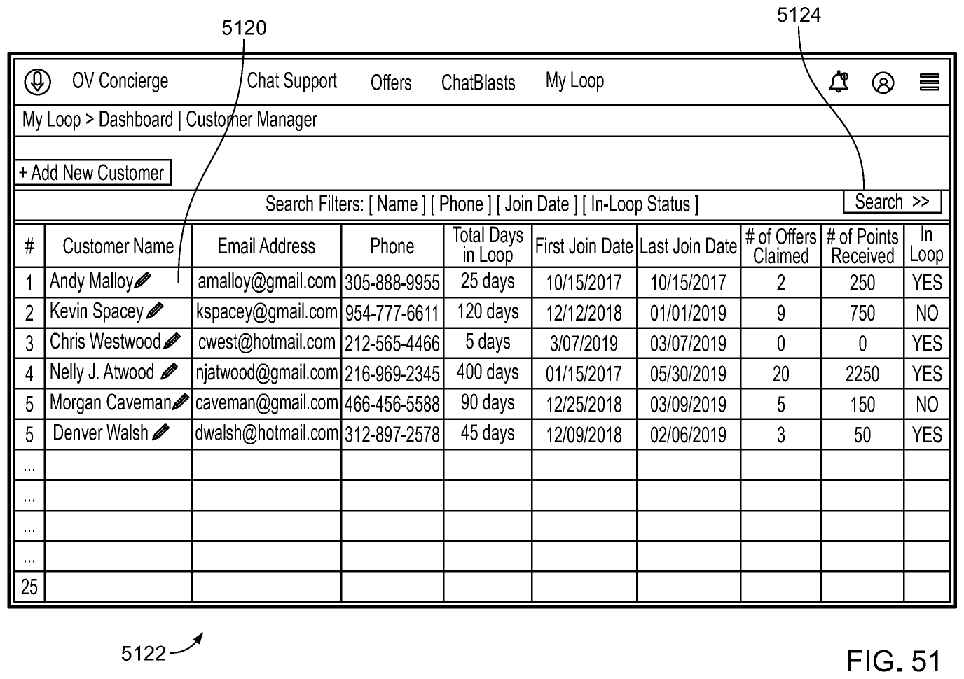

For example, FIG. 52 illustrates implementations in which a customer can enable and use hands-free mode for ongoing messages in an asynchronous interaction channel. Upon the customer tapping or clicking the microphone button 913 (e.g., for the first time during an interaction), a dialog message with a question 912 (“Enable hands free mode?”) and an arrow 915 could be presented to the customer enabling the customer to accept a hands-free mode opt-in (by clicking n the “ok” button) and continue the asynchronous interaction using hands-free mode going forward (e.g., for the remainder of the interaction). The hands-free mode indicator 914 can be used to show the customer that hands free mode is currently active (on) or inactive (off), and this indicator could be used to disable the hands-free mode or re-enable the hands-free mode (in other words, to toggle the mode) at any point or repeatedly during the interaction by clicking on the indicator.

FIG. 53 illustrates steps in one example of a customer using hands-free mode to interact with a CSR agent. The client software 904 encompasses the customer's device 900 and the hands-free command software 901 which is capable of controlling the microphone, speakers, and audio controls of the customer's device (for example, through the operating system running on the customer's device). When the customer speaks an initial question 903 to the CSR agent the message is transcribed and also capture in digital audio form from the microphone and sent to the CSR agent 902 as an interaction message through the interaction platform 910. The CSR agent 902 then reads or listens to the message and responds either audibly or by text only, or by a combination of them. The hands-free command software 901 interprets the response message and audibly plays the CSR's spoken response over the client software and audio system of the customer device to the customer 900. The hands-free command software then appends and presents further audible commands to the customer 905 in which the software audibly asks the customer if she would like to reply giving the customer the ability to speak “reply” in order to record a response for the CSR agent 906. The customer may also ignore the question from the hands-free command software which would signal the client software not to reply to the CSR agent right now. This pattern may continue as long as the asynchronous interaction continues as shown in the repeating interaction 908.

Ticket Buying Example

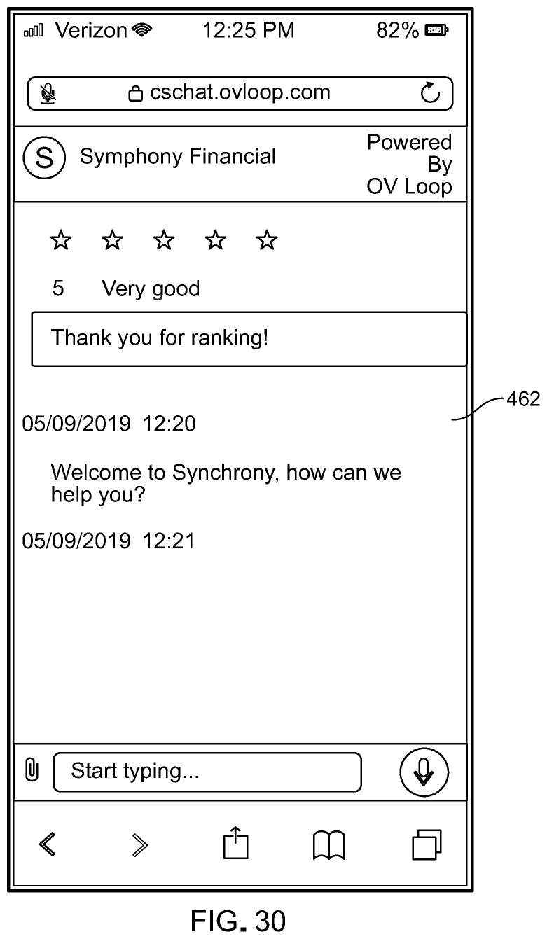

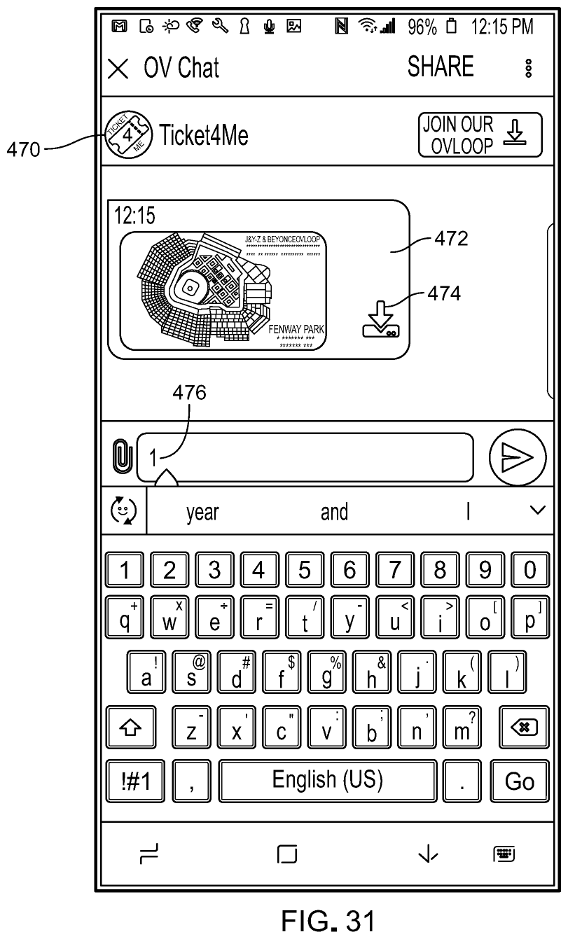

As shown in FIG. 31, in some implementations, an interaction application, private labeled for a ticketing service 470, can present, as a message, an image of a venue 472 including an invocable control 474 that enables downloading of the seating chart for the venue. The customer can then enter information 476 identifying a desired seat. Once an available seat is selected, payment information can be requested in an interactive message panel 478 as shown in FIG. 32. Unlike a typical text-entry message panel in a chat session, the panel 478 provides boxes for entry of information of the kind typically requested for a credit card transaction. Once the customer enters the information and sends the completed form back to the enterprise, payment is made and the transaction is completed by the enterprise on behalf of the customer.

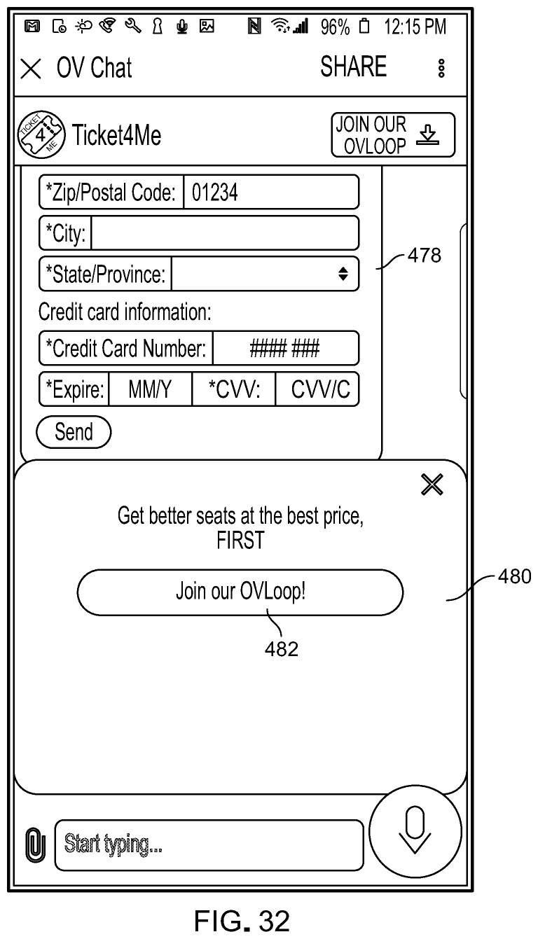

FIG. 32 also illustrates a marketing message 480 sent by or on behalf of the enterprise and promoting a product or service of the enterprise. The customer is invited to “join the loop” of the enterprise by clicking the button 482, which can be done directly within the chat session by the customer. If the customer clicks on the button 482, a subsequent interactive message 484 is presented to the customer in the chat session as shown in FIG. 33. The customer is offered the opportunity to invoke a slider control 486 to confirm the customer's wish to be included in the loop. The customer can then click the “I agree” button 488. Or the customer can decline by clicking the “maybe later” button 490.

Access to Multiple Enterprises

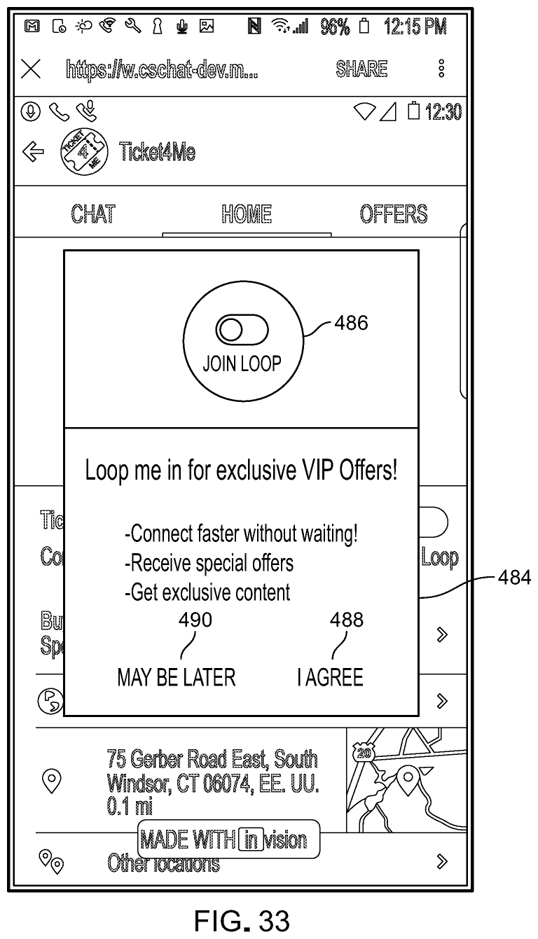

When the interaction application is one presented by the host of the interaction platform, and not on behalf of a specific enterprise, a variety of features can be presented to customers through user interface screens on their mobile devices that enhance the experience of the customers in their ability to maximize the benefits of the features provided by the interaction platform. Such a user interface screen is shown in FIG. 34.

As shown in FIG. 34, a panel 492 presented by the interaction application to the customer includes a text-entry box 494 in which a customer can explore available enterprises that offer services through chat sessions in private-labeled user interfaces. Also presented in the panel 492 is a list of such enterprises 496. For each enterprise, the entry includes a logo and a branding name together with the tagline and an icon 498 that can be invoked by the customer to initiate the chat session with that enterprise. The panel 492 also provides the user interface control 500 that the customer can invoke to see offers and other promotions available from enterprise participant in the interaction platform.

Automated Assistant

Enterprises, such as banks, sometimes offer automated voice assistant services or automated chat assistance services for customers who are interacting online either through a workstation or a mobile device with the enterprise. Typically, the customer is offered an opportunity to speak a question and receive a reply. In some cases, the customer is given a chance to type a chat request and receive a chat answer.

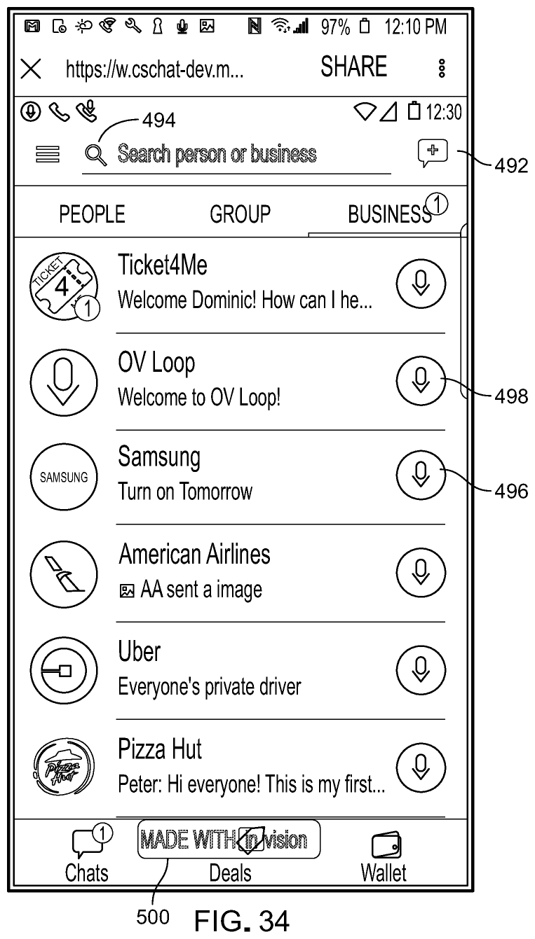

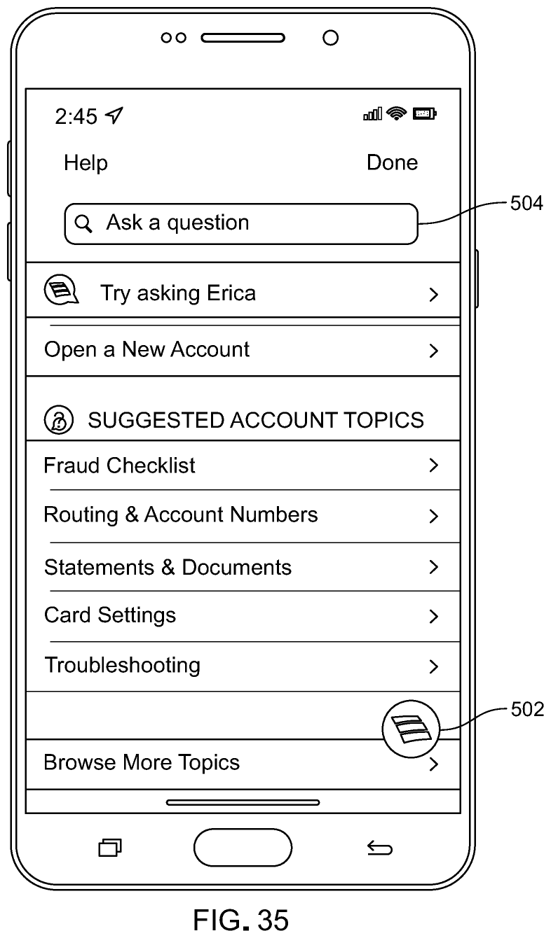

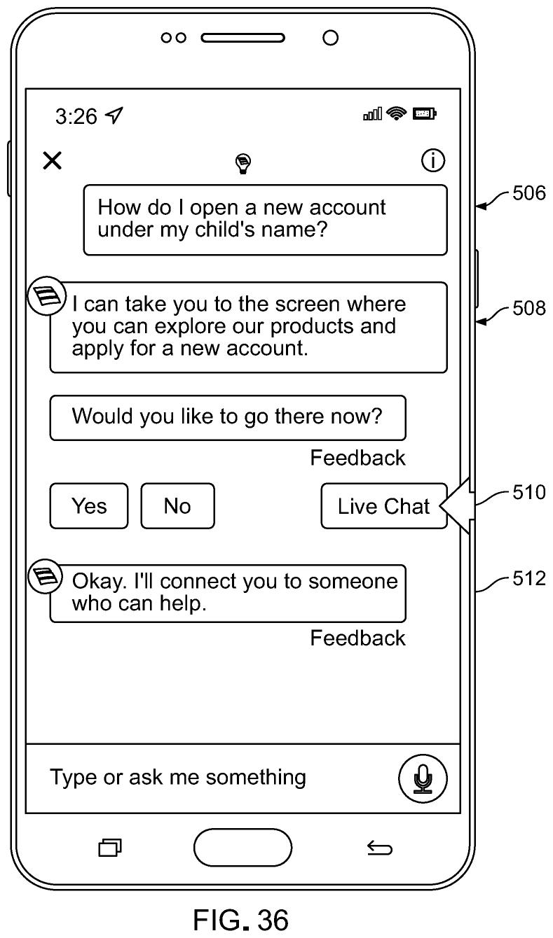

In some implementations of the interaction platform, an interaction channel conversion can be implemented automatically or by action of a CSR working on behalf of an enterprise. As shown in FIG. 35, a user interface presented by an enterprise on a mobile device can include a control 502 that can be invoked by a customer to initiate a voice assistant service or automated chat assistance service. Or the customer may type a request in a text box 504. As shown in FIG. 36, the customer has typed a question in box 506. The enterprise user interface then provides a standard chat reply in a box 508 and asks the customer whether the customer wishes to view a screen with more information. The customers also is given the options to respond “yes”, “no”, or “live chat” as shown in the row of controls 510. If the customer invokes the “live chat” control, the application being run by the enterprise automatically forwards the request to the interaction platform and provides a reply message 512 to the customer confirming a conversion of the interaction channel from an automated response system (either voiced or typed) to a live multimedia asynchronous chat session. As shown in FIG. 37, a CSR working for the enterprise then engages in a live multimedia asynchronous chat session 514 with the customer.

An important concept of an automated assistant use case is to be able to handle a handoff to a live CSR agent seamlessly and without a disruption to the communication flow. There are many questions that an automated assistant may be able to answer easily, but there are many that it cannot. If the automated assistant cannot service a customer request, then it should be able to easily hand that request over to a live customer service representative.

In some embodiments, as illustrated in FIG. 49 the flow of an interaction with an automated assistant results in a seamless transition (e.g., conversion) to a live CSR agent. Other embodiments of seamless handoffs (conversions) are also possible. FIG. 49 shows the sequence of an asynchronous interaction channel starting with a customer's 811 initial question 816 to the enterprise. The question (“what is my balance?”) is relatively simple so the automated assistant 812 has no problem providing the response ($42.34) without any other help. Then the customer asks a second, more difficult question 817 to the enterprise. The automated assistant 812 again analyses the question, but does not have an appropriate answer available, and so then forwards the question and the interaction history to the next available live CSR agent 813. The live agent 813 can then continue the asynchronous interaction through the asynchronous interaction channel with the customer 811. The following question 818 will bypass the automated assistant 812 and be fielded directly by the CSR agent 813.

As used herein, the terms “aided response” or “canned response” are sometimes used to refer to automatically created, pre-set, or pre-programmed responses. For example, the interaction platform has the ability to intelligently review or analyze comments, questions, or other data received from the customer on an interaction channel. Among other things, in some implementations, the analysis allows the interaction platform to select and present to the CSR agent a suggested response or responses, in some cases selected from a set of aided responses are canned responses, for communication to the customer. In some examples, the CSR agent may then select the response that makes the most sense given the context of the customer interaction. The aided responses may be automatically or dynamically generated by the interaction platform using technologies such as artificial intelligence (AI) or other machine learning techniques. They may also be pre-programmed or pre-set into the system as a “common response” that may be used frequently.

Another concept represented by some implementations involves a CSR responding to customer questions using so-called aided responses. For this purpose the interaction platform may store suggested or pre-programmed answers or canned responses that a CSR may use easily for quick responses two customers. Many of these answers can be made to be be easily accessible and can be changed by the interaction platform with each incoming message from the customer. The CSR agent may then select a response from a list of responses and the selected response could be populated into the interaction channel thread for the customer to read.

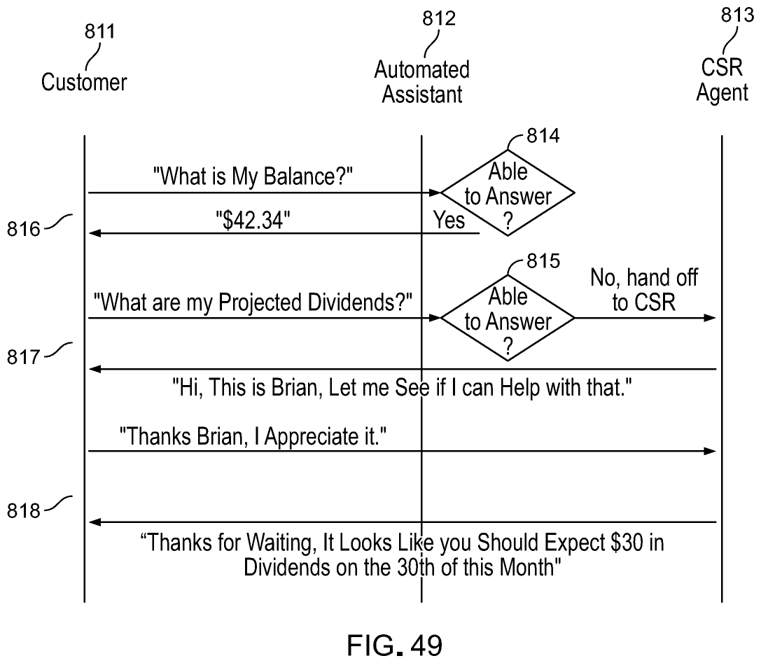

FIG. 50 illustrates embodiments of a user interface that a developer may use to configure aided responses to be presented by the interaction platform to CSRs. This user interface of FIG. 50 highlights the developer's ability to add AI rules 819. One way to populate and automated system that could show appropriate answers would be for a developer to look at key words in customer comments and if those key words contain certain terms, then populate the automated system to be able to suggest a smart set of aided answers. The key terms could be entered in sequence as shown in the configuration box 820. And then the designated answer set could be entered into a separate control field 821. Payment system

Some implementations of the interaction platform include a payment transaction channel that enables one or more payment transactions, for example, between an enterprise and a customer of that enterprise. The payment transactions could be needed for a variety of reasons including any of the following, and others:
During an interaction between a CSR and a customer, a transaction for payment may be required for purchasing an item or service of the enterprise.
A customer may want to pay an existing invoice or a bill, either during the course of an interaction or independently of an interaction. In this case, the customer may initiate a process to pay the existing invoice or bill. The process then leads to a payment transaction.
An enterprise may identify a set of its customers that need to pay a set of bills. In this case, the enterprise may set up a batch process that initiates a bill pay process by sending individual requests to the customers. For each customer the initiation of the bill pay process could lead to a payment transaction.

Each of these cases (and others) may begin with a particular entry step, but they all result in a financial transaction between a customer and an enterprise.

As used herein, the term “request for payment” (RFP) typically refers, for example, to a message being sent by an enterprise, for example, to a payer over an interaction channel asking or suggesting or requiring the payer to complete a payment transaction. For example, an enterprise acting as a biller may send an electronic request for payment to the payer so that the payer can take steps to authorize, complete, approve, or enter approval information, or combinations of those actions, in order to complete a payment transaction.

As used herein, the term “RFP link” refers, for example, to a URL or other type of digital link that is a reference to more content o information associated to an RFP.

As used herein, the terms “authorize” or “authorization” refer, for example, to a step of approval by a customer or other entity. For example, a biller may request a payer to authorize an invoice to be paid. Authorization by a payer can happen in a variety of ways. From within a mobile application, for example, a customer could invoke a button that says “pay now”. Here we also describe other methods of authorization. For example, the interaction platform can enable payment authorization by voice interaction in which the customer could use voice commands spoken to a mobile application two authorize payment. The spoken command can include words indicating approval or authorization of a payment such as “pay now”, or “pay that bill”. When spoken voice commands are used, the mobile application can assess a sampling of sound waves within a recording of the spoken words in the mobile device. In this way, the mobile device can create and store a current voice signature for the customer's spoken words and then compare that current voice signature against similar voice signatures to biometrically validate or authenticate the identity of the customer who is speaking the command. Other ways to use voice commands for authorization of a payment transaction are possible. For example, the biller can request through the interaction channel that a payer speak a sequence of numbers or pin to the mobile device. The correctness of the numbers could be considered together with the voice signature and assessed by the interaction platform at the mobile device before the mobile application sends the authorization.

As used herein, the term “settlement” or “settled” refers, for example, to the closing or final step of a payment transaction when funds are moved from one entity to another and the payment transaction can be considered closed. Settlement occurs after authorization and typically involves parties other than the customer or payer and the enterprise seeking payment. For example, after a payer authorizes a payment transaction, the settlement will include pushing the funds from a financial account of the payer to a financial account of the biller. This settlement can be carried out by a variety of standard methods. For example, settlement can be completed using the ISO 20022 specification for “Real Time Payments”, or the ISO 8583 specification for payment card payments. In some implementations, a more conventional ACH (Automated Clearing House) transfer could take place. In the ISO 20022 specification, settlement occurs when the payer authorizes the payment to “push” from the financial account at the payer's bank to the financial account at the biller's bank. In the ISO 8583 specification, the payer authorizes the payment to be pulled or “captured” at a later time, and when capture happens, the settlement is “pulled” from the payer bank to the biller bank. In an ACH transaction, after the payer authorizes the payment, then the settlement pulls from the payer bank to the biller bank.

As used herein, the term “customer service portal” (CS Portal) refers, for example, to a portion of the interaction platform used by, for example, customer service representatives of an enterprise to manage customer information useful for facilitating the completion of payment transactions, for example, customer account balances, addresses, and other contact information, among other attributes and functions.

As used herein, the term “biller” refers, for example, to an enterprise or other entity that bills one or more payers. As used herein, the term “payer” refers to customer or other entity that pays bills. For example, an enterprise may keep balances for customer accounts and then from time to time may send bills for the unpaid balances to customers. The customer in this case is a payer.

As used herein, the terms “invoice” or “bill” or “bill detail” refers, for example, to a document, file, notation, or other representation, or combinations of them, digital or otherwise, that represent an amount due or that will become due and includes at least a minimal description of how much for what purpose a payer is being billed by a biller. For example, an enterprise biller may send an invoice to a payer indicating that the payer purchased mobile phone minutes, and the invoice may also include the amount that the payer owes the biller.

As used herein, the term “receipt” refers, for example, to a document, file, notation, or other representation, or combinations of them, digital or otherwise, that represents a settlement or other completion of a payment transaction and a recognition by a biller to a payer that a payment transaction has happened. For example, a biller will send a payer a receipt after an invoice has been paid.

As used herein, the term “payment details” refers, for example, to customer payment information that may be used to authorize, settle, or provide a receipt for a payment transaction. For example, payment details could include a customer's payment card data such as a personal account number (PAN), an expiry date, a security code, a magnetic stripe data, secure chip data, or bank account and routing number information from the customer's depository account. Payment details could also include a mobile phone number or email address if that data gives access to authorize a payment transaction. Payment details include the information that is required to complete the authorization and settlement of a payment. A payer may submit, enter, or otherwise permit access to their payment details in order to authorize a transaction and permit it to be settled.

As used herein, the terms “payment transaction” or “financial transaction” refers, for example, to the process of transferring value from one party to another. The process could include a variety of steps and elements including the receipt, the invoice, the biller, the payer, the request for payment, and the authorization, among others. For example, the payment transaction may involve the biller sending a request for payment that includes an invoice to the payer, and second, the payer viewing the invoice received from the biller and the request for payment message, the payer authorizing a payment to be made to the biller, the interaction platform facilitating the settlement of the payment transaction, and the sending of a receipt by the biller to the payer.

As used herein, the term “CSV” refers to Comma Separated File. This is a standardized format of data that is recorded in a flat file.

As used herein, the term “push notification” or “mobile application push notification” refers, for example, to messages sent directly to a mobile application without having been requested. A push notification is a common way for platform servers to send information directly to customers that use mobile applications.

As used herein, the term “deep link” refers, for example, to a URL or other type of digital link that is associated with a specific mobile application and when activated by a user directs the user to that mobile application or a specific location within the mobile application that may display more information contextually related to the link.

As used herein, the term “wallet” or “digital wallet” refers, for example, to a system that stores a set or subset of payment details. For example, a payer may store payment details in the digital wallet of a mobile application. A wallet typically stores a set of payment details for a specific payer. A wallet is responsible for securely storing the payment details and allowing a payer to select which payment detail or details to use in participating in a payment transaction. A wallet also allows for the payer to update, remove, or add payment details, for example, to keep them current. By using a wallet, a payer does not have to enter payment details each time a payment transaction is made. In

As used herein, the term “chat thread” refers, for example, to a record of a digital conversation. For example, a chat thread captures the history of a conversation including the assets shared in that conversation and the time they were shared. Usually the chat thread displays the history chronologically and in a vertical format. Many times one party's comments within a conversation are represented by justifying them all to one side of the chat window, and the second party's comments within a conversations are represented by justifying them all to the other side of the chat window.

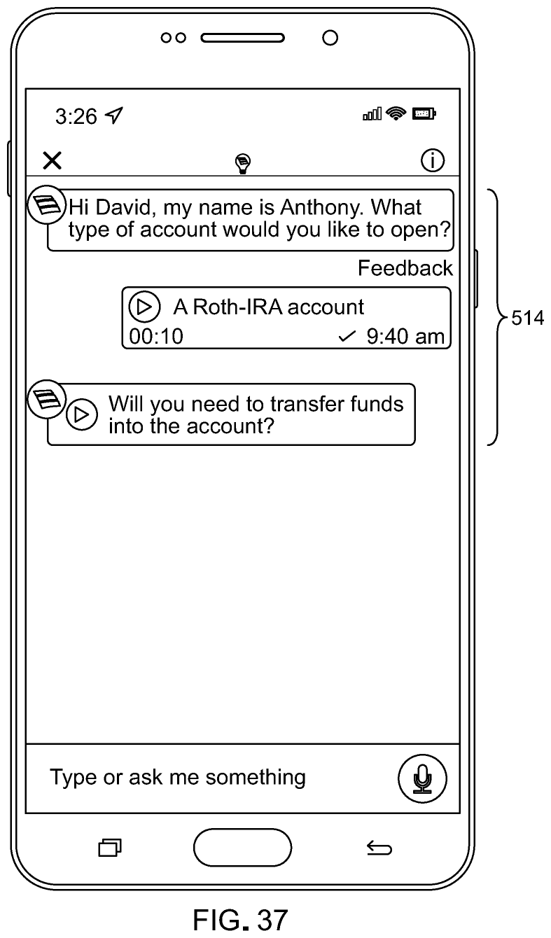

As used herein, the term “chat thread flag” refers, for example, to a mechanism used by and interaction platform to associate specific events with specific locations in a chat thread history. For example, when a payment transaction occurs as a result of an RFP that was presented within a chat thread, a chat thread flag may be recorded in the database of the interaction platform so that the payment transaction can be associated with the exact historical location where it occurred inside the chat thread. This association allows the historical information in the chat thread leading up to, including, and then after the financial transaction to be quickly found, reviewed, and referenced by one or more processes or human users of the interaction platform. This information may be important for a variety of reasons, including gathering evidence in response to a dispute about the payment transaction. FIG. 38 illustrates the flow of the completion of financial transactions in several different implementations that include use of an interaction channel.

Some implementations shown in FIG. 38 are referred to as “outbound” and involve enterprise billers sending bills to payers. In outbound implementations, the biller may choose to send bills or RFPs to payers individually or in bulk. Sending in bulk results in many RFPs being sent simultaneously to respective individual payers at one time. In some cases, when sending individually, a CSR agent for the biller initiates 600 a RFP to a particular customer from the CS Portal. In some instances, when sending in bulk, the CSR agent may choose to upload a batch of bills to be paid by payers identified in a CSV file into the CS Portal in 601. For bulk billing, the CS Portal receives the CSV file and then can parse individual payer records to create individual RFPs for each record.

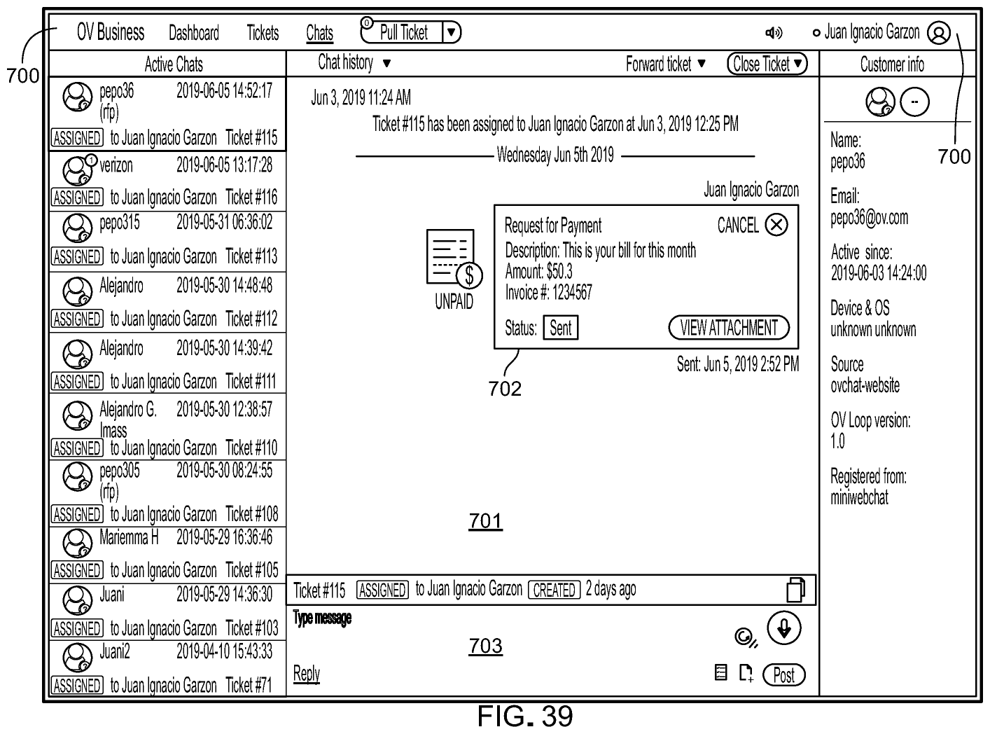

FIG. 40 illustrates a view from the CS Portal including a panel 704 interface for creating an RFP for an individual payer.

Once the individual RFPs have been set up in the CS Portal, the CS Portal sends the RFP to the platform server system 602. Some custom implementations may not use a direct type of integration 603 that uses API interfaces to connect to the platform server 602 directly.

The platform server 602 then determines which interaction channels are available to the payer. If the payer has an interaction channel associated with a mobile application available and known by the platform server, the platform server can send the RFP by push notification 604. If the payer has an email address or phone number known to the application server, the platform server can send an RFP link by email or SMS text message to the payer.

The payer then will receive the RFP link by SMS text message, email, or push notification, or a combination of them. If the payer receives the RFP link in a text message or email and invokes the link the mobile application working through the operating system of the mobile device can assess the type of link as a deep link or not a deep link. If the RFP link is a deep link, then invoking the RFP link may directly cause the opening of the invoice or bill detail associated with the RFP link in the mobile application 630. If the RFP link is not a deep link, then invoking the RFP link may open the invoice or bill detail for viewing on a web browser 620. If the payer receives the RFP link in a push notification, then the mobile application will display the invoice or bill detail in 630 when the payer activates the push notification.

Both the web browser display and continued process flow starting at 620 and the mobile application display and continued process flow starting at 630 can provide similar or identical user experiences with one difference being that 630 requires a specific mobile application running on the mobile device and 620 only requires a web browser running on the mobile device.

Both method 620 and method 630 illustrate the payer's ability not only to view payment details such as line item entries and amount, but also to authorize payment of the invoice at steps 621 and 631. The payer also may be able to engage in a live chat session and communicate with a CSR at the same time over an interaction channel 622 or 632. Interaction channels 622 and 632 may be used by the payer when there are questions regarding the invoice or bill detail. In some cases, other interaction channels may be used simultaneously with the payment transaction channel or the live chat channel, such as a live voice call.

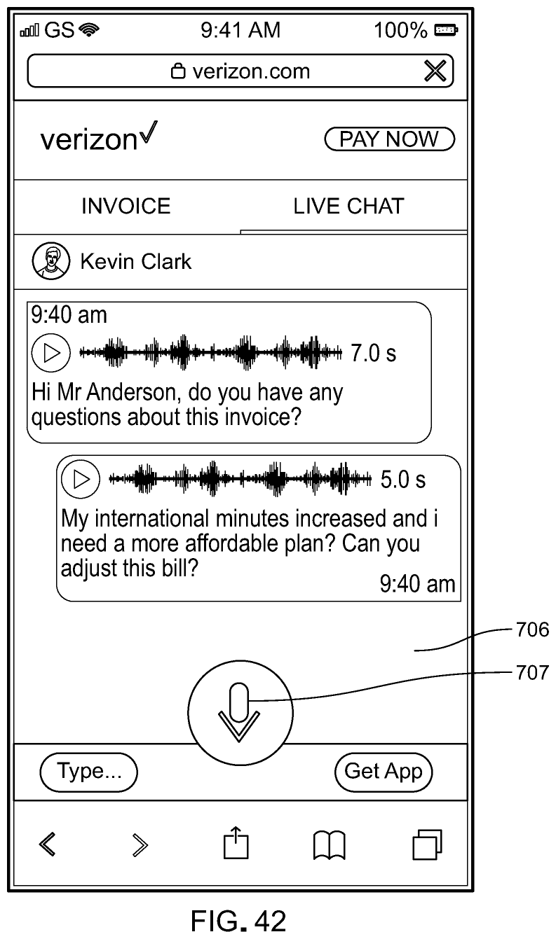

FIG. 43 illustrates an example of a display presented to the payer when viewing the bill detail 710. The same view shows other user interface controls such as “Pay Now” 708 for the payer to authorize the payment to the biller. user interface control 709 enables the payer to open a live chat interaction channel with the biller.

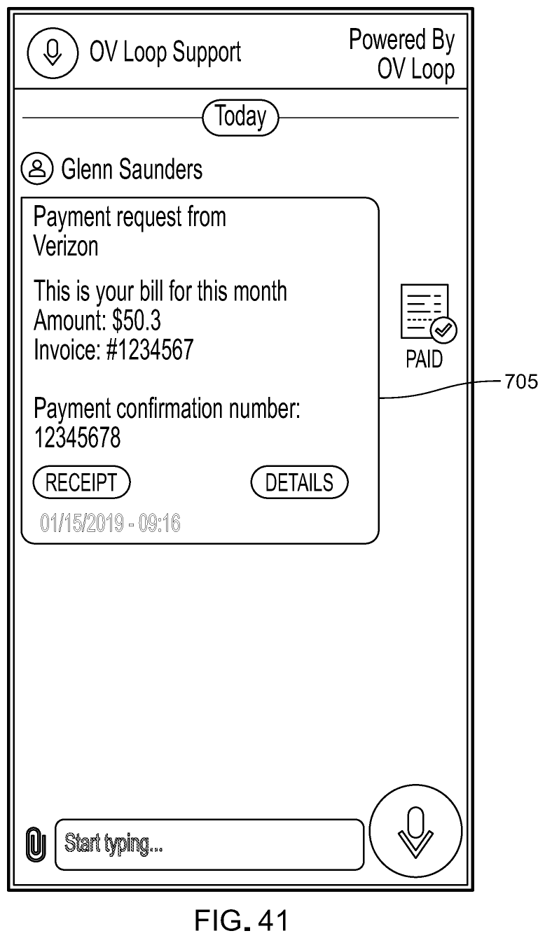

FIG. 42 illustrates an example of a display presented to the payer when initiating 709 the live chat interaction channel with the biller. A panel 706 shows the history of the live chat interaction channel chat session. A user interface control 707 can be invoked to activate a voice input feature to capture multi-mode input that includes both voice file and voice converted to text.

Once the payer has authorized 621, 631 the payment amount in FIG. 38, based on viewing the invoice 620, 630, the next step of the payment transaction process flow may be to display the receipt 623, 633.

The step of authorization would include verifying the payer's payment details. The payment details of the payer may be entered by the payer directly in fields presented through the user interface, such as fields for entering a credit card number and expiry date. Some or all of the payment details may be automatically or intentionally selected by the payer from the digital wallet. If the payer enters new payment details to be verified, there may be an option for the payer to save the payment details to the digital wallet.

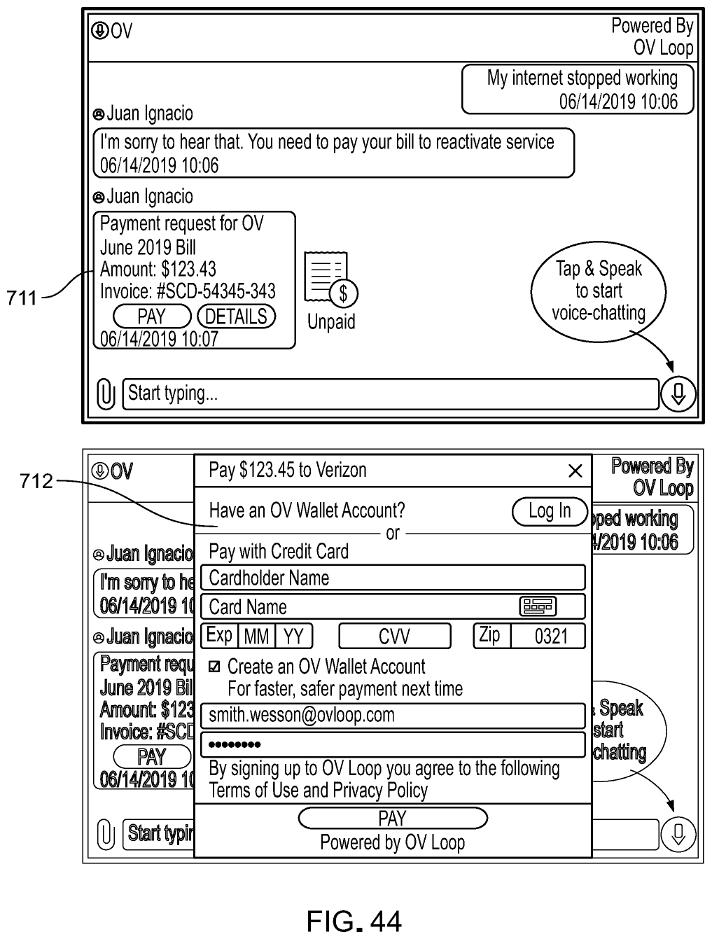

FIG. 45 illustrates an example of a digital wallet. The set of card images in 713 represent the respective payment details for each of several different cards available for use in effecting the payment transaction. The set of cards in 713 show some but not all of the information contained in payment details for each payment card representation 714. The user experience may include touching or tapping on the card representation 714 in order to remove or update any of the information of the payment details.

After the payment has been authorized by the payer, the payment transaction can be settled from the payer to the biller.

In some implementations illustrated in FIG. 38 (referred to as “in chat”)a payment transaction can be completed from within the context of an active customer interaction occurring on an interaction channel between the CSR and the customer. In some implementations, the CSR who is associated with the enterprise serves as a biller when entering into the payment transaction and the consumer is the payer.

The customer may have initiated the interaction channel by a variety of different intrigue steps. For example, in some cases, the customer entry step 605 can be through an IVR system, and the interaction channel can be converted into a web-based interaction channel 608. In some cases 606 a merchant website “captures” a customer and then converts the interaction into a web interaction channel 608. In some instances, an interaction with a customer who already has a mobile application on a mobile device and is in the enterprise's customer loop 607 can be converted into a mobile application chat interaction channel 609. In some examples, the interaction channel has already been established between the CSR and the customer.

At some point during and interaction between a CSR and a customer in an interaction channel, the CSR may want to initiate a payment transaction with the customer. The CSR can then be viewed as a “biller” and the customer can then be viewed as a “payer”. The CSR can create and send 610 an RFP to the payer.

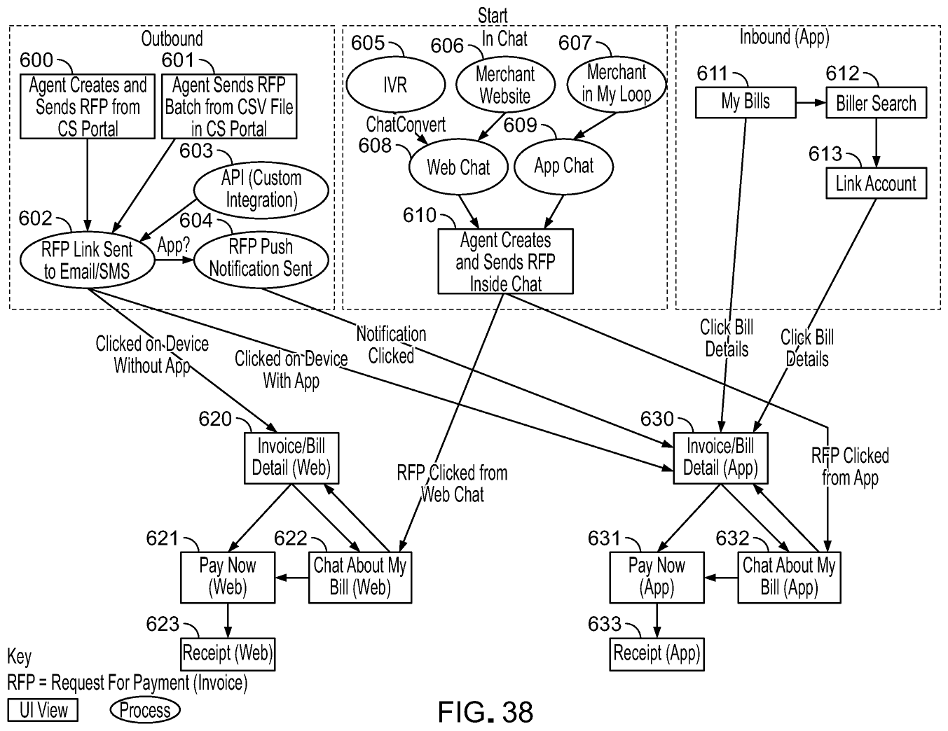

FIG. 39 illustrates an example of a display of the CS Portal to the CSR may see, including the screen view 700, the interaction channel history 701 between a CSR and a customer, the CSR input area 703 to add information or content to the customer interaction occurring on the interaction channel, and. the RFP being sent 702 from the biller to the payer. The display indicates that an attachment was sent depicting a document in the form of an invoice as well as other basic information about the RFP such as an amount, an invoice number, and a brief description.

After the RFP is sent 610 from the biller to the payer in the interaction channel in FIG. 38, it is up to the payer to interact with the RFP message the payer received. In some implementations, the payer may receive the RFP message in either an interaction channel hosted by a mobile application on the mobile device if the payer has the mobile application 632 installed. In some implementations, the payer may receive the RFP message in a web chat interaction channel 622. The user experience through channels 622, 632 can be similar or essentially identical.

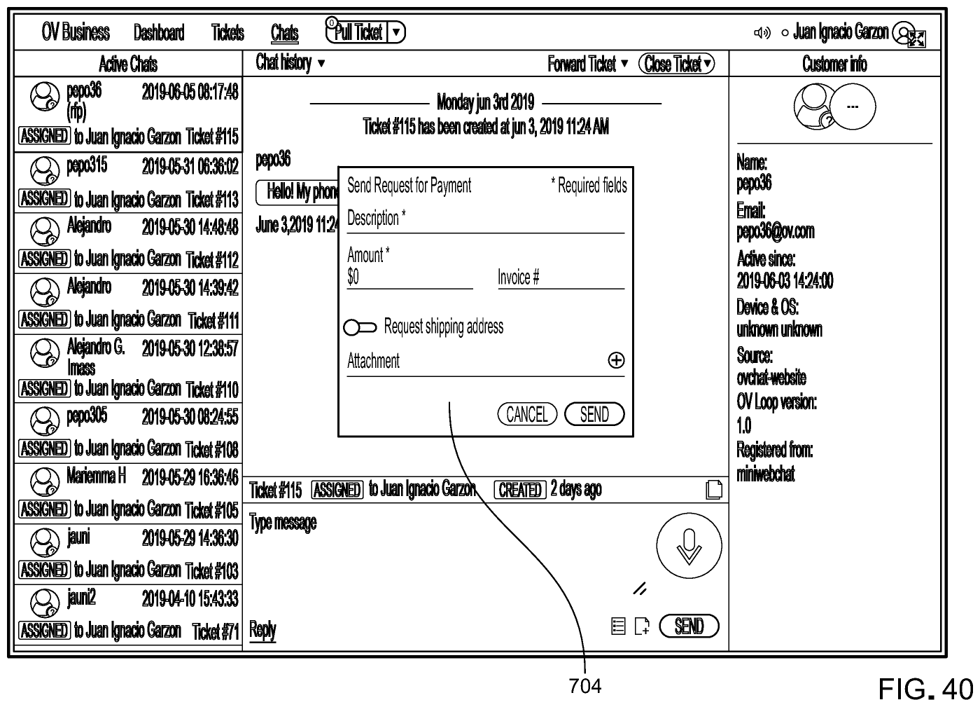

FIG. 41 illustrates an example of a display element 705 presented to the payer when the RFP message a biller. The display element 705 shows how the RFP appears directly in the chat thread history as a request to pay, in this case, Verizon and includes the basic payment transaction information such as an amount, an invoice number, and an opportunity to view details about the RFP such as bill detail.

A payer typically may review the bill detail first by activating the bill detail link which enables the payer to view the bill detail 630, 620.

In some implementations, both steps 620 and 630 enable the payer not only to view invoice details such as line item entries and an amount, but also two authorize payment 621, 631 of the invoice. I The payer also can also choose to live chat and communicate with a CSR at the same time over an interaction channel as 622, 632 shows. Interaction channels 622, 632 may be used by the payer when there are questions regarding the invoice or bill detail.

Once the payer has authorized 621, 631 the payment amount in FIG. 38, Elements based on viewing the invoice 620, 630, the payer can have the receipt displayed 623, 633.

In some implementations, the step of authorization can include verifying the payer's payment details. The payment details of the payer may be entered by the payer directly in fields presented through the user interface, such as entering a credit card number and an expiry date. In some cases, the information may be entered automatically or intentionally selected by the payer from the digital wallet. If the payer enters new payment details to the verified, there may be an option for the payer to save the payment details to the digital wallet.

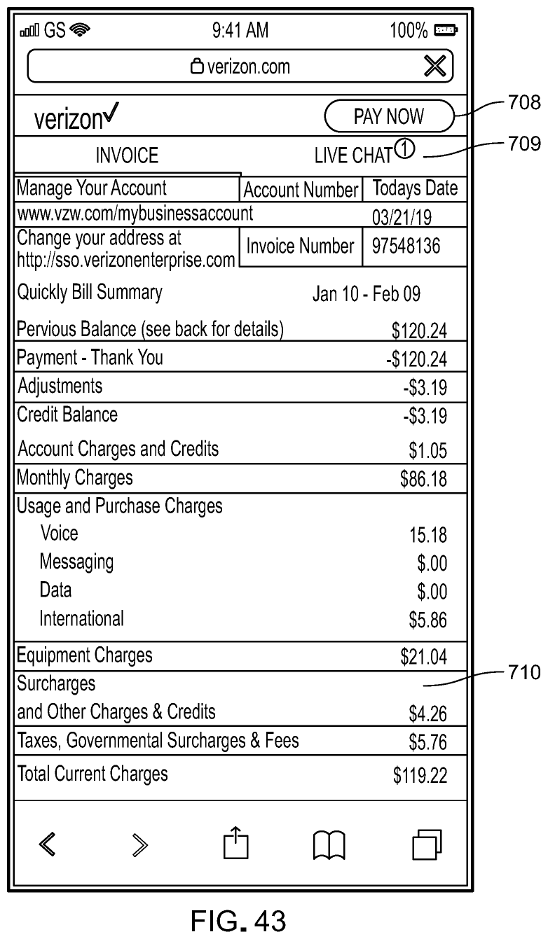

FIG. 44 illustrates an example of a method of entering secure information into a chat interaction channel. For “in chat” implementations, the RFP is displayed directly in the chat thread four viewing by the payer. The RFP message 711 not only displays relevant information but also is functional in that it has features that can be invoked by the payer such as the “Pay” button or the “Details” button. Because payment details among other details can be sensitive, incorporating payment details into a chat thread which will be recorded would be insecure. FIG. 44 illustrates display of a secure form in which, for example, the payment details are entered 712 by a payer or customer and, when submitted after entry, are stored securely in the server and associated with the RFP message 711 listed in the chat thread. The RFP message in the chat thread is not intended to include the payment details for viewing in the chat thread; rather the payment details are associated with and securely stored for the RFP message processing. FIG. 44 illustrates embodiments of a secure form used for collecting payment details; however, in some embodiments, the displayed or entered information could include sensitive personal data such as a social security number, health information, or driver' s license data, to mention just a few examples.

After the payment for the bill associated with the RFP message has been authorized by the payer, the payment transaction can be settled from the payer to the biller.

In “in chat” implementations, after authorizing the payment, the payer may be returned to the previous view shown in FIG. 41. A button 705 can be invoked by the payer to view a receipt of the completed payment transaction.

In some “in chat” implementations, the RFP and related payment transaction can be recorded within the chat thread history. This enables storing context four the portions of the chat session that led up to and followed the financial transaction in a timeline form as documented in the chat thread. The server then can build an association and store a chat thread flag that associates a payment transaction with a specific location in the chat thread history. This flag can be used to easily locate and review the contextual chat session history associated with the payment transaction that occurred in the chat interaction channel. This information is especially useful in the case of a dispute between the payer and biller after the payment transaction has occurred.

In some implementations shown in FIG. 38, referred to as “inbound”, a payer uses a mobile application containing a list of the payer's billers, which is updated from time to time to reflect current biller account balances and due dates. In some cases, the payer would like to execute a payment transaction to pay a bill.

The payer may implicitly know of billers 612 to whom the payer is indebted. in some implementations, the interaction platform enables a payer working within the mobile application to search and find the appropriate biller that the payer to whom the payer is indebted. Step 613 enables linking the payer two the account maintained by the biller. This step may include identification verification carried out by the mobile application or carried out asynchronously directly with the biller or a combination of the two. After the payer account is linked 613, the payer may see the biller and associated bill due messaging inside the mobile application in a section designated for bills that are due as indicated in 611.

Because the “inbound” implementations contemplate only actions taken within the mobile application, the step 630 is applicable, and the step 620 is not. The element 611 could show the payer an RFP link that when invoked pushes the payer to a display within the mobile application that shows the bill detail 630.

The element 630 indicates that the payer can not only view invoice details such as line item entries and amount, but also authorize payment of the invoice, and also to live chat and communicate with a CSR biller at the same time over an interaction channel 632. The interaction channel 632 may be used by the payer when there are questions regarding the invoice or bill detail.

Once the payer has authorized the payment amount in the element 631 based on viewing the invoice in the element 630, the customer can view in the element 633.

The step of authorization would include verifying the payer's payment details. The payment details of the payer may be entered by the payer directly into fields disposed through the user interface, such as by entering a credit card number and an expiry date or may be automatically or intentionally selected by the payer from the digital wallet. If the payer enters new payment details to be verified, the payer to save the new payment details to the digital wallet.

After the payment has been authorized by the payer, then the payment transaction can be settled from the payer to the biller.

Some implementations of the payment transaction flows include a conversion from an asynchronous interaction channel to a synchronous interaction channel. In some cases participants in an asynchronous interaction channel can benefit from a synchronous interaction either by voice or video in order to more quickly converse in more detail. The conversion to a voice or video call from an asynchronous interaction channel enables this faster, more detailed interaction. When the synchronous voice or video call is completed, communication can continue on the original asynchronous interaction channel. In some cases, use of the asynchronous interaction channel and the voice or video call can occur simultaneously.

In some implementations during an asynchronous communication between an enterprise CSR agent and a customer, there may be times when a synchronous voice call would be an easier or faster way to exchange information about, for example, booking seats or getting tickets to an event, among other things. However, it may be impractical in such situations to allow a customer to initiate the synchronous voice call to the CSR, the CSR typically handles many interactions with many different customers at the same time. The agent could easily get overloaded with inbound multiple voice call requests at the same time. In some implementations, therefore, the CSR would be the only party able to access and use the feature by allowing only the CSR side to initiate the synchronous voice call.

As shown in FIG. 46, in some implementations of the payment transaction processing, conversion between an asynchronous interaction channel and a synchronous channel begins with a set of parties interacting using an asynchronous interaction channel 715. During the interaction, one party would like to have a voice chat or voice phone call with another 716. A voice chat would represent a synchronous way of communicating, on either a digital channel or an analog channel. A voice chat 716 then may be initiated by pressing or tapping a “talk now” button, for example. Initiating a synchronous voice chat opens a voice call with at least one other party who is using the current asynchronous interaction channel. The voice call 717 can continue as would any typical voice call. When one of the parties decides to conclude the voice call 718, the parties can resume their asynchronous interaction on the original channel 719. Many other applications are possible for Disability of a user of an asynchronous interaction channel to convert to a synchronous interaction channel.

In some implementations, a process flow similar to the one described above for payment transactions can be used for other purposes including other financial transactions (such as refunds or split payments) and other non-financial transactions. Among other scenarios, the process flow can be useful whenever a customer is using an asynchronous communication channel, for example, on a mobile device, and an enterprise needs or the customer wishes to provide authorization for some action to be taken based on predefined parameters that are stored by and known to the enterprise. In such scenarios, the predefined parameters can be pushed into the asynchronous interaction channel communications and the customer can invoke user interface controls to authorize an action based on the parameters. As an example, a prescription fulfillment service could push a request for action on a refill of the prescription into a chat session in an asynchronous interaction channel, and the customer could invoke a “please refill” button. A very wide variety of examples are possible.

In general, the process flow described above can itself be considered an interaction channel in which the interactions include a request for action, and authorization to act, a completion of the action, and reportedly completed action.

### Provisional Application

Here we include edited portions of provisional patent application Ser. 62/695,726, as examples of the structure and operation of the interaction platform.

An improved IVR system for call centers, or for interfacing with call centers, is configured to detect if a phone number is from a mobile device and offers an option for a caller to text or text chat with the IVR system or with the CSR available through the IVR system.

In some embodiments, an IVR system is configured to detect if a phone number is from a mobile device and offers an option for a caller to text or text chat (which we sometimes simply call “chat”) with the IVR system or the CSR representative available through the IVR system. For example, in response to an initial call from a customer or other party to an IVR system, the IVR system offers an option for the caller by sending the message “To text chat with a representative now press 1, for reservations press 2, etc.” If the user presses 1 the user will hear the spoken message “please hang up and check your text message.” The IVR system, or a module associated with one or a number of IVR systems, will send an API request to an Application Program Interface (API, e.g., the OV IVR API, defined by OV Loop, Inc.) interfacing to a chat application. The API request can include a participant enterprise identifier (ID), a mobile number of user, a name of the user if the enterprise interaction platform has a name, and any optional fields of information. The OV IVR API determines if the mobile phone number received is from an existing user (e.g., an OV Loop app user). If yes, the IVR system may send a request to chat message to the user using an OV Loop app push notification. If no, the IVR system may send a text message containing a special link. The special link is designed for the enterprise endpoints to a URL of a Web chat system of the enterprise available to the specific caller. In such a case the caller would receive a text message saying something like “To Web chat with our customer service representative, click this link XXXXXXXXX.” When the link is clicked the Web chat session at that URL begins. If the caller has the OV Loop app chat application running on the caller's mobile device, the chat request from the enterprise would show up on the enterprise section of the app as a new pending chat for user to click on to start chatting with the CSR.

In addition to invoking the text chat alternative to a conventional IVR call using a link, the text chat alternative may also be invoked by other mechanisms, such as by scanning a bar code, QR code, gesturing, or others, or a combinations of them.

Both voice and text of the interaction platform may be implemented according to the disclosure in U.S. patent application Ser. No. 15/867,936, titled SYSTEM AND METHOD FOR ASYNCHRONOUS MULTI-CHANNEL MESSAGING filed Jan. 11, 2018, the contents of which are incorporated herein by reference in their entirety.

The following text describes embodiments of the Web chat IVR API. The description refers to an interface with technology, available from OV Loop, Inc., Northborough, Mass. 01532, such as available through an “OV Loop” app chat application running on a user device; however similar functionality may be implemented using other chat applications.

OV Loop's IVR to Web chat technology is designed to convert a synchronous voice call to a Web chat initiated by invoking a Web link sent to the mobile phone of the customer who originally called into the enterprise's phone number. As described above, QR codes, bar codes, or other mechanisms may also be used as entry steps to initiate a Web chat channel of customer interaction when scanned, for example using a mobile phone camera and associated app(s). Although the API provides for conversion of the customer interaction from a voice telephone call channel into a Web chat channel in an IVR system, other systems, other than IVR, such as text, email, QR, web link, app, and others) can be involved in the conversion into a Web chat channel.

When the entry step is by invocation of the Web link, once the customer clicks on the link the customer receives an SMS on their mobile device, the customer is taken to a custom Web chat where the customer can asynchronously chat with the CSR of the enterprise.

IVR API Endpoint: https://ivrapi.dev.myne.com/ivr

The Web chat API is design using the REST (https://en.wikipedia.org/wiki/Representational state transfer) methodology, including resource-oriented URLs and common HTTP response codes to indicate API errors. All requests by customer devices are authenticated using basic authentication, that is, username/password, which may be obtained directly from a chat app running on the customer's device.

IVR methods exposed by the Web chat API provide access to information and operations relating to the OV Web chat functions. For example:

SMS. Delivers an SMS message for immediate Web chat using the following parameters.

PATH. POST /sms

REQUEST PARAMETERS. From: string (required), in formData (The phone number at the mobile device of the party having an OV account. The number should be in E164 without the plus sign. Example 13055551212); to: string (required), in formData (This is the destination phone number that should be getting the SMS, obtained from the IVR system information. The CallerID or ANI should be in E164 format without the plus sign. Example 5491167778126); message: string, in formData (This variable allows testing different messages. This value is appended to the link for the Web chat); first name: string, in formData (This is the first name of the customer if available); last name: string, in formData (This is the last name of the customer if available); email: string, in formData (This is the email of the customer if available).

RESPONSES. 200 OK; 401 Unauthorized (Authentication Error), Response Content-Types: application/xml, application/j son

IVR SECURITY. Schema (BasicAuth), Scopes

As part of a logical flow of a Web chat API, a user may use basic telephony (i.e., phone capabilities) of a mobile device to dial a company the user is trying to reach through the company's phone number. An IVR system may answer the call. The IVR system may have access to the Web chat API so that the IVR system is configured to prompt the caller with an IVR option by speaking a message such as “press X to receive a Web chat.” A Web chat API may identify or authenticate or both the user based on the caller's phone number or the user name or both.

The Web chat API creates and sends a Web link using an SMS (short message service) text message, and the link to the Web chat API is included in the text message. Rather than invoking such a link, a QR code or other code may be sent as the Web chat entry step with the text message from the Web chat API working in conjunction with the IVR system. The user receives the text message with the Web chat entry step (e.g., the link created by the Web chat API). The user may click on the link (or otherwise activate the Web chat entry step) which opens or invokes a browser on the mobile phone or other mobile device browser and causes it to access the Web chat system served through the browser by the server of the interaction platform. The user may then engage the CSR using messages sent and received through the Web chat system rather than or in combination with the phone call with the CSR.

As noted earlier, rather than or in addition to a link being created by the Web chat API, the Web chat API may generate an alternative Web chat entry step. For example, the Web chat API may generate a QR code and transmit the QR code with the initial text message from the IVR system. The user may use a QR code reading app to read the QR code sent with the initial text message causing a Web chat to be opened upon reading of the QR code.

The improved IVR system for enterprises and call centers, or for interfacing with call centers, is configured to detect if a phone number is from a mobile device and to offer an option for a caller to text or text chat with the IVR system or the CSR available through the IVR system. The entry step to chat sent by text may include a Web link, or other code, such as a QR code, a bar code or other code.

In a general flow of the interaction platform receiving a message via traditional interaction channels as a voice telephone call interaction channel or an email interaction channel and converting the customer interaction from the traditional interaction channel to, for example, a chat channel, the authenticity of and use by the user and the recipient are first identified. At each step the following variables are calculated and passed along fmi(voi,emi,appi,eni,uii,rpi,tci,pki,ifi,cti). Based on the function fmi processed by the interaction platform, a chat session will be created the variables will be passed to the next engine or phase fm=function of all variables, vo=voice message, em=email message, app=mobile application, en=environmental, ui=user information, rp=recipient information, tc=traditional communications, pk=package sent by user (voice, pictures, video, email), if=infrastructure information, ct=chat. Processing by a communication channel controller according to the disclosure may be implemented as follows:

1. a communication channel controller, implemented as a specially configured processor operating as described here, is activated by a sender using a channel e.g. a telephone call, email sent, browser etc.

2. the communication channel controller gathers information on sender: senders phone number, ip address, sender's environment, senders chat, recipient, etc. (figure screen)

3. the communication channel controller sends a reciprocal message on the same channel, with a link to web browser chat session with the recipient. the sender can now asynchronously chat with the recipient (after the unique id and security engine does the authentication), discussed below.

4. the communication channel controller enables a two-sided interactive chat with text, voice, images, video and other multimedia to provide enhanced communication.

5. the communication channel controller also allows for the user to click a link in the web chat session to open an app machine that will allow an asynchronous multimedia chat session and the joining of a much larger set of recipients, users.

6. an app on the user device receives this converted chat, which then allows the communication channel controller to gather more information about the sender and gives the sender access to all other users and enterprises in the digital network.

7. the recipient (e.g. enterprise) joins the sender's “loop” for broader participation in the digital network (e.g., to provide further customer service, support, marketing communications and content that it may make available).

Other implementations are also within the scope of the following claims.

1. A machine-implemented method comprising
at a customer service system of an enterprise, receiving an inbound message from a customer device of a customer, the inbound message being part of a customer interaction and being in a first electronic interaction channel, and
in response to the inbound message, the customer service system automatically and electronically exposing to the customer an entry step invocable by the customer to continue the customer interaction using at least a second electronic interaction channel different from the first interaction channel,
in response to an invocation by the customer of the entry step, the customer service system automatically making available to the customer a system for sending and receiving messages in at least the second electronic interaction channel.

2. The method of claim 1 in which the inbound message comprises a request for service by a customer service representative of the enterprise.

3. The method of claim 1 in which the customer device comprises a mobile phone or other mobile device.

4. The method of claim 1 in which the first electronic interaction channel comprises a telephone call and the inbound message is expressed as part of the telephone call.

5. The method of claim 1 in which the customer service system of the enterprise comprises an interactive voice response system and the inbound message comprises actions by the customer in the interactive voice response system.

6. The method of claim 1 in which the exposing of the entry step to the customer comprises delivering a recorded or synthesized spoken message to the customer device informing the customer of the entry step.

7. The method of claim 6 in which the spoken message indicates to the user that the entry step will be exposed through the customer device.

8. The method of claim 1 in which the exposing of the entry step to the customer comprises delivering a text message to the customer device containing the entry step.

9. The method of claim 8 in which the entry step comprises a link to a URL.

10. The method of claim 8 in which the entry step comprises a QR code or other graphical code.

11. The method of claim 1 in which the first electronic interaction channel comprises a synchronous channel.

12. The method of claim 1 in which the second electronic interaction channel comprises a quasi-synchronous channel or an asynchronous channel.

13. The method of claim 1 in which the making available to the customer of a system for sending and receiving messages comprises invoking an application on a device of the customer or serving Web pages through a browser of a device of the customer.

14. The method of claim 13 in which the application invoked on the device comprises a chat application associated with the enterprise.

15. The method of claim 13 in which the webpages served through the browser comprises a chat application associated with the enterprise.

16. The method of claim 1 in which the second electronic interaction channel comprises a multichannel including at least a text interaction channel and a graphical interaction channel.

17. The method of claim 16 in which the graphical interaction channel comprises images or video.

18. The method of claim 16 in which the multichannel includes a voice interaction channel.

19. The method of claim 1 in which the second electronic interaction channel is served from a central server on behalf of the enterprise.

20. A machine-based method comprising
presenting to a customer of an enterprise through a user interface on a device of the customer, a chat system enabling the customer and a customer service representative of the enterprise to engage in a chat session as part of a customer interaction,
the chat system presented to the customer through the user interface including multiple interaction channels enabling the customer to send and receive messages to and from the customer service representative,
the multiple interaction channels including at least a text channel, a voice channel, and at least one other interaction channel available essentially simultaneously and from within the chat system.

21. The method of claim 20 in which presenting the chat system to the customer comprises serving a chat system associated with the enterprise through a browser running on the device of the customer.

22. The method of claim 20 in which presenting the chat system to the customer comprises running a chat application associated with the enterprise on the device of the customer.

23. The method of claim 20 in which presenting the chat system to the customer comprises presenting user interface controls that can be invoked in any order by the customer during the use of the chat system.

24. The method of claim 20 in which the other interaction channel comprises at least one of an email channel, a Web page channel, an application channel, a social network channel, an image channel, a video channel, a form completion channel, or a financial transaction channel.

25. A machine-based method comprising
presenting to a customer service representative of an enterprise through a user interface on a device of the customer service representative, a chat system enabling the customer service representative and a customer of the enterprise to engage in a chat session as part of a customer interaction,
the chat system presented to the customer service representative through the user interface including multiple interaction channels enabling the customer service representative to send and receive messages to and from the customer,
the multiple interaction channels including at least a text channel, a synchronous voice channel, and a synchronous video channel.

26. The method of claim 25 comprising enabling the customer service representative to determine whether the synchronous voice channel and the synchronous video channel are to be used for sending and receiving messages with the customer during the chat session,

27. A machine-based method comprising
presenting to a customer service representative of an enterprise through a user interface on a device of the customer service representative, a chat system enabling the customer service representative and a customer of the enterprise to engage in a chat session as part of a customer interaction,
the chat system presented to the customer service representative through the user interface including multiple interaction channels enabling the customer service representative to send and receive messages to and from the customer,
the multiple interaction channels including at least a text channel, a voice channel, and at least one other interaction channel available essentially simultaneously and from within the chat system.

28. The method of claim 27 in which presenting the chat system to the customer service representative comprises serving a chat system of the enterprise through a browser running on the device of the customer service representative.

29. The method of claim 27 in which presenting the chat system to the customer service representative comprises running a chat application of the enterprise on the device of the customer service representative.

30. The method of claim 27 in which presenting the chat system to the customer service representative comprises presenting user interface controls that can be invoked in any order by the customer service representative during the use of the chat system.

31. The method of claim 27 in which the other interaction channel comprises at least one of an email channel, a Web page channel, an application channel, a social network channel, an image channel, a video channel, or a financial transaction channel.

32. The method of claim 27 in which presenting the chat system to the customer service representative comprises presenting the chat system as part of a user interface of a customer service system.

33. The method of claim 27 comprising automatically sending messages in at least one of the multiple interaction channels based on analysis of previous messages of the chat session.

34. A machine-based method comprising
storing records of electronic customer interactions between customers and customer service representatives of one or more enterprises,
based on the stored records, forming a channel of customer interactions between customers and customer service representatives of the enterprise, the channel being predictive of effects of activities included in the stored records and occurring during electronic customer interactions on outcomes of the customer interactions,
applying the channel to a current electronic customer interaction between a customer and a customer service representative of one of the enterprises to generate a proposed action to be taken with respect to the current electronic customer interaction on behalf of the enterprise, and causing the proposed action to be taken.

35. The method of claim 34 in which storing records of the electronic customer interactions comprises storing messages of the electronic customer interactions.

36. The method of claim 34 in which storing records of the electronic customer interactions comprises storing information about activities during the electronic customer interactions.

37. The method of claim 34 in which the forming of the channel also comprises forming a channel based on demographic information about the customers.

38. The method of claim 34 in which the forming of the channel comprises forming a channel applicable to the enterprise.

39. The method of claim 34 in which the forming of the channel comprises forming a channel applicable to the customers or a particular customer of a particular enterprise.

40. The method of claim 34 in which causing the proposed action to be taken comprises automatically taking the action on behalf of the enterprise.

41. The method of claim 34 in which causing the proposed action to be taken comprises presenting to a customer service representative information about the proposed action and a control enabling the customer service representative to take the action on behalf of the enterprise.

42. A machine-based method comprising
storing records associating particular customers of an enterprise with a customer service representative of the enterprise who engages in successive customer interactions at different times with the customers,
exposing to the customer service representative through a user interface of a device, user interface controls enabling the customer service representative to select one or more customer services or customer benefits to be provided to customers and to select one or more of the particular customers to whom the customer services or customer benefits will be provided, and
in response to an action by the customer service representative, providing at least one of the selected customer services or customer benefits to the selected particular customers, and
presenting user interface controls enabling the customer service representative to use two or more different interaction channels for messages to be sent to customers and to use the two or more different interaction channels in any order from within the user interface to send messages to a customer being served,
the different interaction channels comprising at least a chat channel or a voice channel and a image channel or a video channel.

43. The method of claim 42 in which the stored records contain information about the customers related to the customer interactions.

44. The method of claim 42 in which the stored records contain demographic information about the customers.

45. The method of claim 42 comprising presenting the stored records to the customer service representative through the user interface and presenting user interface controls enabling the customer service representative to add, delete, edit, and manage information in the stored records manage stored records.

46. The method of claim 42 in which the customer benefits comprise promotional benefits.

47. The method of claim 46 in which the promotional benefits comprise marketing communications with respect to one or more products of the enterprise.

48. The method of claim 47 comprising exposing to the customer service representative user interface controls enabling generation of the marketing communications.

49. A machine-based method comprising
exposing to a customer service representative of an enterprise, user interface controls enabling the customer service representative of the enterprise to define terms of one or more marketing communications associated with products of the enterprise,
storing records representing the marketing communications,
during electronic customer interactions with customers that include chat channel messages and in response to invocations of a user interface control by the customer service representative, incorporating one or more of the marketing communications in chat channel messages sent to the customers, based on the stored records.

50. The method of claim 49 in which the user interface controls enable the customer service representative to identify customers to whom the marketing communications should be sent.

51. The method of claim 50 comprising enabling the customer service representative to identify groups of the customers.

52. The method of claim 51 in which the groups of the customers comprise customers who share a common demographic characteristic.

53. The method of claim 50 comprising sending the marketing communications to the identified customers at a time when the customers and the customer service representative are not engaged in a customer interaction that includes chat channel messages.

54. The method of claim 49 comprising receiving responses to the marketing communications in chat channel messages.

55. A machine-based method comprising
presenting a chat channel system to a customer of an enterprise through a user interface of an app or a browser running on a device of the customer, the chat channel system enabling the customer to send and receive messages to and from a customer service representative of the enterprise as part of customer interactions, the customer interactions comprising messages containing information about products available from the enterprise to the customer, and
presenting to the customer through the chat channel system user interface controls enabling the customer to pay for products available from the enterprise in the course of a chat channel customer interaction.

56. The method of claim 55 in which the user interface controls presented to the customer enable the customer to pay for the products by a single tap on a display surface of the device.

57. A machine-based method comprising
(a) at a first time, through a user interface of a customer service system of an enterprise, enabling a customer service representative to engage in a first customer interaction with a particular customer, the first customer interaction comprising sending messages to and receiving messages from the particular customer in a chat channel,
(b) through the user interface, enabling the customer service representative to store records associated with the particular customer,
(c) at a second time, through the user interface of the customer service system, enabling the customer service representative to engage in a second customer interaction with a particular customer, the second customer interaction comprising sending messages to and receiving messages from the particular customer in a chat channel, and
(d) at a third time, electronically sending to the customer of marketing communication associated with a product of the enterprise.

58. The method of claim 57 comprising enabling multichannel messages as part of the first customer interaction and the second customer interaction.

59. The method of claim 58 in which the multichannel messages comprise a voice channel, a chat channel, and a graphical channel.

60. A machine-based method comprising
presenting a chat channel system to a customer of an enterprise through a user interface of an app or a browser running on a device of the customer, the chat channel system enabling the customer to send and receive messages to and from a customer service representative of the enterprise as part of customer interactions, the customer interactions comprising messages containing information about products available from the enterprise to the customer, and
enabling the customer through the chat channel system to complete a checkout form to buy a product from the enterprise during the course of the customer interactions,
the messages of the customer interactions and the checkout form being communicated in a chat channel.

61. A machine-based method comprising
presenting to a user of a user device a message as a communication that is part of an interaction between the user and another party on an asynchronous interaction channel, the message comprising a request for confirmation of an action with respect to a proposed transaction, the request including information characterizing the transaction,
including in the message an invocable user interface control for confirming the action,
receiving an invocation of the user interface control confirming the action,
executing the action based on the confirmation, and
reporting the execution of the action to the user.

62. The method of claim 61 in which the asynchronous interaction channel comprises a chat channel.

63. The method of claim 61 which the interaction comprises a chat session.

64. The method of claim 61 in which the message comprises a request to approve transaction.

65. The method of claim 61 in which the user device comprises a mobile device.

66. The method of claim 61 in which the other party comprises a representative of an enterprise and the user comprises a customer of the enterprise.

67. The method of claim 61 which the action comprises completing a transaction.

68. The method of claim 67 in which the transaction comprises a financial transaction.

69. The method of claim 68 in which the financial transaction comprises payment of the bill.

70. The method of claim 68 in which the financial transaction comprises presenting an invoice for an offer, product, or service.

71. The method of claim 62 comprising recording metadata associated with the execution of the action.

72. The method of claim 61 in which the request for confirmation of an action comprises a request for an authorization.

73. The method of claim 61 in which presenting the message comprises displaying a panel containing the information characterizing the transaction, the panel including the invocable user interface control for confirming the action.

74. The method of claim 61 comprising preserving confidentiality of at least some of the information.

75. The method of claim 61 comprising recording the interaction between the user and the other party and associating the transaction with at least a portion of the recording in which the user interface control confirming the action was invoked.

76. The method of claim 61 comprising authenticating an identity of the user before accepting the indication of the user interface control confirming the action.

77. The method of claim 61 in which the message comprises a bill from an enterprise, the user interface control enables the user to authorize payment of the bill from an account of the user, executing the action based on the confirmation comprises transferring funds from the account of the user to an account of the enterprise, and reporting the execution of the action comprises sending the user a receipt for the payment of the bill.

78. The method of claim 61 comprising enabling the user to invoke a wallet as part of confirming the action.

79. The method of claim 61 comprising bundling messages comprising such requests for confirmation for a group of such other parties and causing by a single step the presenting of the requests for confirmation to the other parties.

80. The method of claim 79 in which the messages comprise bills or invoices and the parties comprise customers of an enterprise.
